(19) United States
(12) Patent Application Publication
(10) Pub. No.: US 2026/0055580 A1
(43) Pub. Date: Feb. 26, 2026

(54) SYSTEM FOR COUPLING AN IDENTIFICATION MODULE TO A WORK MACHINE ATTACHMENT

(71) Applicant: Great Plains Manufacturing, Inc., Salina, KS (US)

(72) Inventors: Jeff Welsh, Abilene, KS (US); Zachary Schmidt, Salina, KS (US); Yuji Fukuda, Salina, KS (US); Elizabeth Baker, Flower Mound, TX (US)

(21) Appl. No.: 19/307,866

(22) Filed: Aug. 22, 2025

Related U.S. Application Data
(60) Provisional application No. 63/686,224, filed on Aug. 23, 2024.

(51) Int. Cl. E02F 9/26; E02F 3/43; H04B 1/3822

(52) U.S. Cl. CPC E02F 9/26; H04B 1/3822; E02F 3/43

(57) ABSTRACT

A system comprising a work machine and an attachment. The work machine includes one or more machine sensors configured to obtain machine data related to one or more components of the work machine. The attachment is configured to be removably coupled to the work machine. The attachment includes an identification module configured to wirelessly transmit identification information to the work machine when the attachment is coupled to the work machine. The work machine is configured to determine one or more attachment characteristics of the attachment based on the identification information transmitted to the work machine from the identification module.

### CROSS-REFERENCE TO RELATED APPLICATION

The present non-provisional patent application claims priority to U.S. Provisional Patent Application Ser. No. 63/686,224, filed Aug. 23, 2024, and entitled “SMART ATTACHMENTS FOR A WORK MACHINE.” The entirety of the above-identified provisional patent application is hereby incorporated by reference into the present non-provisional patent application.

### FIELD OF THE INVENTION

Embodiments of the present invention are generally directed to attachments for work machines. More particularly, embodiments of the present invention are directed to attachments for work machines, with such attachments configured to communicate with the work machines so as to improve the functionality and efficiency of the attachments and the work machines.

### BACKGROUND OF THE INVENTION

There are many types of work machines on the market today. An exemplary type of work machine is a utility loader (e.g., track loader or skid steer), which is a machine commonly used as a hydraulic tool carrier configured to carry and operate a variety of hydraulically-driven tools or attachments. Common attachments include skid cutters, cold planers, augers, trenchers, grapples, etc. Other non-hydraulic attachments may also be carried and operated by utility loaders, such as blades, buckets, rakes, etc.

Generally, there is little to no communication between work machines and associated attachments. For example, with most non-hydraulically-operated attachments, the attachments are simply coupled with the work machines, and operators control the attachments, from control stations of the work machines, using actuators of the work machine. The only information or feedback being provided to the operators is visual feedback obtained by the operators' eyes viewing the attachments and the surrounding work areas. For certain hydraulically-operated attachments, the work machines or the attachments may include simple sensors configured to monitor various operating parameters of the work machines or the attachments (e.g., hydraulic pressures or flow rates). However, there is commonly little to no communication between such attachments and their associated work machines.

As a result, there is a need for smart attachments for work machines, with such smart attachments and work machines configured to communicate with each other, so as to improve functionalities and efficiencies of the attachments.

### SUMMARY

Embodiments of the present invention include a method for managing one or more attachments configured to be operably coupled with a work machine. The method comprising a step of programming, via a mobile device, an identification module into association with an attachment. During the programming step, the mobile device is configured to communicate in a short-range mode with the identification module. A further step includes communicating, via the mobile device, with the identification module after the programming step. During the communicating step, the mobile device is configured to communicate in a long-range mode with the identification module.

Embodiments of the present invention additionally include a non-transitory computer readable media with a computer program stored thereon for managing one or more attachments configured to be operably coupled with a work machine. Upon the computer program being executed by a processor, the computer program instructs the processor to perform a number of steps. One step includes programming, via a mobile device, an identification module into association with an attachment. During the programming step, the mobile device is configured to communicate in a short-range mode with the identification module. A further step includes communicating, via the mobile device, with the identification module after the programming step. During the communicating step, the mobile device is configured to communicate in a long-range mode with the identification module.

Embodiments of the present invention additionally include an identification module configured to provide an indication of an identity of an attachment to which the identification module is configured to be coupled. The identification module comprises a motion sensor and a transceiver. When the attachment is not operably coupled with a work machine, the identification module is configured to periodically transmit signals, via the transceiver, at a low transmission frequency. When the attachment is operably coupled with the work machine, the identification module is configured to periodically transmit signals, via the transceiver, at a high transmission frequency.

Embodiments of the present invention further include a method of communicating with an identification module configured to provide an indication of an identity of an attachment to which the identification module is coupled. The method includes providing the identification module comprising a motion sensor and a transceiver. An additional step includes when the attachment is not operably coupled with a work machine, periodically transmitting signals, via the transceiver, at a low transmission frequency. A further step includes when the attachment is operably coupled with the work machine, periodically transmitting the signals, via the transceiver, at a high transmission frequency.

Embodiments of the present invention additionally include an identification module configured to provide an indication of an identity of an attachment to which the identification module is configured to be coupled. The identification module comprises a motion sensor configured to determine when the identification module is motion, and a transceiver configured to transmit signals via a first messaging scheme and a second messaging scheme. When the identification module is not in motion, the identification module is configured to alternate transmitting signals between the first messaging scheme and the second messaging scheme according to a slow transition frequency. When the identification module is in motion, the identification module is configured to alternate transmitting signals between the first messaging scheme and the second messaging scheme according to a fast transition frequency.

Embodiments of the present invention additionally include a communication system to facilitate communication between a work machine and an attachment. The communication system comprises an identification module. The identification module comprises a housing, and further comprises a processor, a memory, and a wireless transceiver housed with the housing. The system further includes a bracket configured to couple the identification module to the attachment such that the transceiver of the identification module is aimed within 30° of a line of sight between the identification module and a wireless transceiver associated with the work machine.

Embodiments of the present invention additionally include a method of modifying a work machine and attachment to include a communication system. The method comprises a step of providing the communication system comprising an identification module and a bracket. The identification module comprises a housing, and further comprises a processor, a memory, and a transceiver housed with the housing. An additional step includes securing the bracket to the attachment. A further step includes securing the identification module to the bracket. Wherein upon the securing of of the identification module to the bracket, the transceiver of the identification module is aimed within 30° of a line of sight between the identification module and a wireless transceiver associated with the work machine.

Embodiments of the present invention additionally include a system for controlling an attachment coupled to a work machine. The system comprises the work machine and the attachment. The work machine comprises one or more machine sensors configured to obtain machine data related to one or more components of the work machine. The attachment is configured to be removably coupled to the work machine. The attachment includes an identification module configured to wirelessly transmit identification information to the work machine when the attachment is coupled to the work machine. The work machine is configured to determine one or more attachment characteristics of the attachment based on the identification information transmitted to the work machine from the identification module. The work machine is configured to determine a position of the attachment based on the machine data and on the one or more attachment characteristics of the attachment.

Embodiments of the present invention additionally include a method of controlling a position of an attachment coupled to a work machine. The method comprises a step of coupling the attachment to the work machine. The attachment includes an identification module with a transmitter. The work machine comprises one or more machine sensors configured to obtain machine data related to one or more components of the work machine. An additional step includes transmitting identification information from the identification module of the attachment to the work machine. An additional step includes determining one or more attachment characteristics of the attachment. The attachment characteristics are determined based on the identification information transmitted from the identification module to the work machine. An additional step includes transmitting position information from the identification module of the attachment to the work machine. A further step includes determining a position of the attachment based on the machine data and on the one or more attachment characteristics of the attachment.

Embodiments of the present invention additionally include a system for grabbing objects. The system comprises a work machine that includes one or more machine sensors configured to obtain machine data related to one or more components of the work machine. The system additionally includes an attachment configured to be removably coupled with the work machine. The attachment includes an identification module configured to wirelessly transmit identification information to the work machine when the attachment is coupled to the work machine. The attachment includes a first portion and a second portion configured to actuate, such that the first portion and the second portion are configured to cooperatively grab and hold on to an object. The work machine comprises a hydraulic system configured to provide hydraulic fluid to the attachment at a grabbing pressure to selectively cause the first portion or the second portion to actuate to cooperatively grab and hold on to the object. The work machine is configured to determine if the attachment is currently grabbing the object, and is further configured to maintain the hydraulic pressure of the hydraulic fluid provided to the attachment at the grabbing pressure if the attachment is determined to be currently grabbing the object.

Embodiments of the present invention additionally include a method of grabbing and moving objects. The method comprises a step of providing a work machine and an attachment. The work machine comprises one or more machine sensors configured to obtain machine data related to one or more components of the work machine. An additional step includes removably coupling the attachment with the work machine. The attachment includes a first portion and/or a second portion configured to selectively actuate, such that the first portion and the second portion are configured to cooperatively grab and hold onto an object. An additional step includes wirelessly transmitting, via an identification module associated with the attachment, identification information to the work machine. An additional step includes providing hydraulic power, via a hydraulic system of the work machine, to the attachment at a grabbing pressure to cause the first portion and/or the second portion to actuate to cooperatively grab and hold onto the object. A further step includes determining if the attachment is currently grabbing the object, and if the attachment is determined to be currently grabbing the object, then maintaining the hydraulic pressure of the hydraulic power provided to the attachment at the grabbing pressure.

Embodiments of the present invention additionally include a method for managing one or more work machine and one or more attachments configured to be operably coupled with the work machines. The method comprises a step of generating, on a graphic display of a computing device, a graphical user interface (GUI). An additional step includes presenting, on the GUI, information indicative of a selected work machine. An additional step includes presenting, on the GUI, information indicative of a selected attachment that is or was operably coupled with the selected work machine. An additional step includes generating a usage history for the selected attachment over a given time period. A further step includes presenting the usage history on the GUI.

Embodiments of the present invention further include a non-transitory computer readable media with a computer program stored thereon for managing one or more work machine and one or more attachments configured to be operably coupled with the work machines. Upon the computer program being executed by a processor, the computer program instructs the processor to perform a number of steps. One step includes generating, on a graphic display of a computing device, a graphical user interface (GUI). An additional step includes presenting, on the GUI, information indicative of a selected work machine. An additional step includes presenting, on the GUI, information indicative of a selected attachment that is or was operably coupled with the selected work machine. An additional step step includes generating a usage history for the selected attachment with the selected work machine over a given time period. A further step includes presenting the usage history on the GUI.

This summary is not intended to identify essential features of the present invention, and is not intended to be used to limit the scope of the claims. These and other aspects of the present invention are described below in greater detail.

### BRIEF DESCRIPTION OF THE DRAWING FIGURES

Embodiments of the present invention are described in detail below with reference to the attached drawing figures, wherein:

FIG. 1 is a perspective view of a work machine and an attachment configured to be removably coupled with the work machine;

FIG. 2 is a schematic view of an engine and a hydraulic system for the work machine of FIG. 1;

FIG. 3 is a schematic view of a control system for the work machine of FIG. 1;

FIG. 4 is a schematic view of an identification module configured to be secured to the attachment of FIG. 1;

FIG. 5 is a schematic view of a mobile device configured to communicate with the identification module of FIG. 4 and/or the control system of FIG. 3 of the work machine of FIG. 1;

FIG. 6 is a schematic view of a remote device configured to communicate with the mobile device of FIG. 5, the identification module of FIG. 4 and/or the control system of FIG. 3 of the work machine of FIG. 1;

FIG. 7 is a graphical user interface displayable on a graphic display of the work machine from FIG. 1;

FIG. 8 is another graphical user interface displayable on a graphic display of the work machine from FIG. 1;

FIG. 9 is a perspective view of an attachment in the form of a grapple;

FIG. 10 is a graph illustrating a process for supplying hydraulic pressure to the grapple of FIG. 9;

FIG. 11 is an embodiment of a bracket configured to secure the identification module to an attachment;

FIG. 12 is another embodiment of a bracket configured to secure the identification module to an attachment;

FIG. 13 is a perspective view of an attachment, with an identification module attached thereto via the bracket of FIG. 12;

FIG. 14 is a perspective view of the work machine and the attachment from FIG. 1, with the attachment secured to the work machine such that an identification module secured to the attachment is aimed for wireless communication with a wireless transceiver on the work machine;

FIG. 15 is a graphical user interface displayable on a graphic display of the mobile device from FIG. 5;

FIG. 16 is another graphical user interface displayable on a graphic display of the mobile device from FIG. 5; and

FIG. 17 is yet another graphical user interface displayable on a graphic display of the mobile device from FIG. 5.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

### General Overview

Embodiments of the present invention are directed to a smart attachment for a work machine. The work machine may comprise various types of machines configured to support and operate attachments. For example, work machines may include “compact utility loaders” or “CULs,” “compact track loaders” or “CTLs,” skid-steer loaders, or the like. However, the work machines may comprise various other types of machines configured to perform heavy-equipment or agricultural operations (e.g., excavators, wheeled loaders, dozers, tractor loader, etc.).

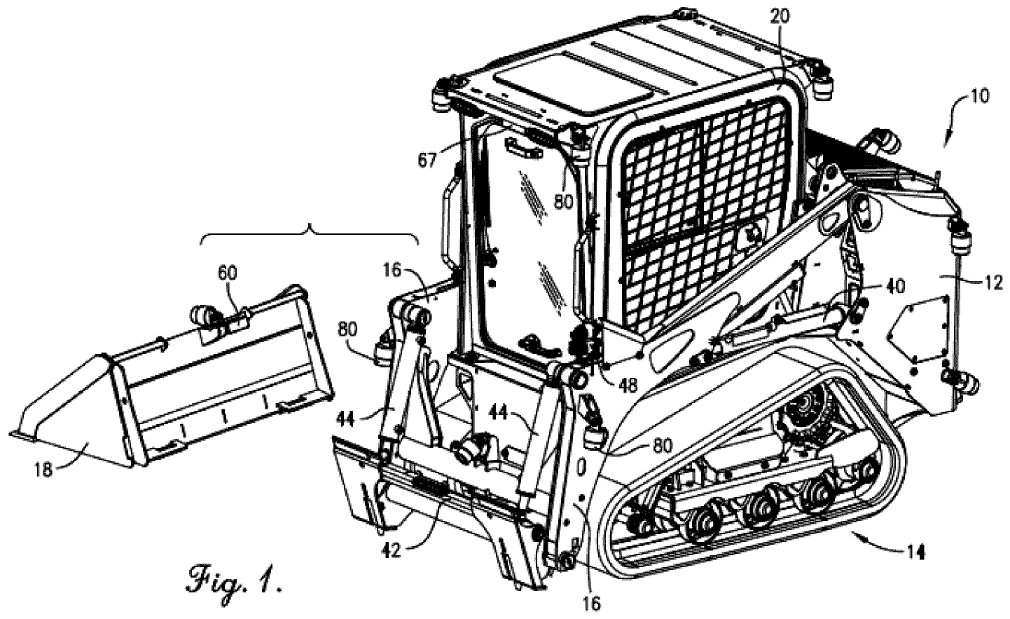

As illustrated in FIG. 1, an exemplary work machine 10 is shown, which may comprise a frame 12 that is propelled by a drive assembly 14 comprising one or more wheels and/or endless tracks. In general, the work machine 10 will be self-propelled and may include one or more vertically-shiftable arms 16 configured to support various interchangeable attachments 18. The attachments 18 may, in some embodiments, comprise work tools that have hydraulically-driven auxiliary functions. Examples of such hydraulically-operated attachments include augers, grinders, jack hammers, tillers, rollers, trenchers, digger derrick, cold planers, grapples, snow blowers, or the like. In other embodiments, however, the attachments 18 may comprise non-hydraulically-driven work tools, such as buckets, blades, plows, knives, pallet forks, forklifts, or the like. FIG. 1 illustrates an exemplary work machine 10 and attachment 18 in the form of a CTL and a bucket. Certain of the inventive concepts and other general concepts disclosed in this patent application may share certain commonalities with the concepts disclosed in U.S. Patent App. Publ. No. 2024/0117596, the entirety of which is incorporated herein by reference (and also attached to the end of this description and claims).

Turning to the work machine 10 in more detail, and remaining with FIG. 1, the work machine 10 may broadly comprise the frame 12 supported on the ground by the drive assembly 14, which is configured to propel the work machine over the ground. The work machine 10 may additionally comprise the one or more (e.g., a pair of) arms 16 supported by the frame 12 and configured to be raised and lowered. The arms 16 are further configured to support various types of attachments 18 for performing various types of work, as required by an operator of the work machine 10. The work machine 10 may include a control station 20, which may comprise a cab from which the operator can control the work machine 10 and/or associated attachments 18. The control station 20 may include a seat on which the operator sits or a platform on which the operating stands while operating the work machine. The control station 20 may also include one or more user controls (e.g., buttons, switches, levers, joysticks, touchscreen displays, etc.), which may be used to control various functions of the work machine 10 and/or the attachments 18.

As used herein, directional terms are used with respect to the perspective of an operator located within the control station 20 and facing forward towards a front end of the work machine 10. Thus, the terms “front” and “forward” mean a longitudinal direction towards the front end of the work machine 10. It is noted that the attachments 18 are generally supported at the front end of the work machine 10 via connection to front ends of the work machine's 10 arms 16. However, certain work machines 10 may be configured to connect with attachments 18 located at a back end of the work machine 10. The terms “back,” “rear,” or “rearward” mean a longitudinal direction towards the back end of the work machine 10. The term “left” or “leftward” means a left lateral direction from the perspective of the operator positioned within the control station 20 and facing forward, and the terms “right” or “rightward” means a right lateral direction from the perspective of the operator positioned within the control station 20 and facing forward. Thus, for example, the front end of the loader machine 10 of FIG. 1 is shown in the lower left corner of the figure.

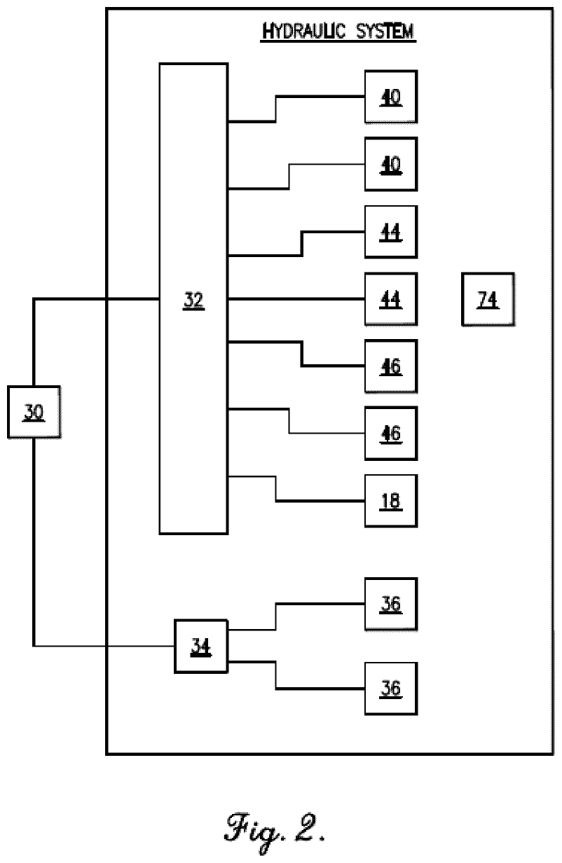

Returning to the work machine 10, the frame 12 may broadly form a housing that defines an interior compartment within which various components of the work machine (e.g., engine, hydraulic system, etc.) are housed and supported. In more detail, as illustrated schematically in FIG. 2, the work machine 10 may include (as housed within the interior compartment) a combustion engine 30, a hydraulic auxiliary pump 32, and/or one or more hydrostatic transmissions 34. The engine 30 may provide rotary power for both the auxiliary pump 32 and the hydrostatic transmissions 34. The auxiliary pump 32 may provide hydraulic power to the arms 16 that support the associated attachments 18 (e.g., to raise/lower the attachments) and/or to the attachments 18 themselves (e.g., for the case in which the attachments 18 are hydraulically operated). The hydrostatic transmissions 34 may provide hydraulic power to the work machine's 10 drive assembly 14 (e.g., one hydrostatic transmission may provide hydraulic power to one of each of the two hydraulic motors described below). In some embodiments, a flywheel (not shown) may be positioned between the engine 30 and the auxiliary pump 32 and/or the hydrostatic transmissions 34, with such flywheel being used to maintain a consistent power output from the engine during varying RPMs.

In certain embodiments, the work machine 10 may include a pair of hydraulic drive motors 36. Such drive motors 36 may be used to provide power to the drive assembly 14. Specifically, the hydrostatic transmissions 34 may be configured to provide hydraulic power to the drive motors 36, which in turn provide rotary power to the drive assembly 14 of the work machine 10. As was noted previously, the work machine 10 may include endless tracks or wheels, which form part of the drive assembly 14 and which are driven by the drive motors 36.

Turning to the arms 16 of the work machine, in some embodiments the arms 16 may comprise two arms 16 in the form of a left arm 16 (i.e., positioned on a left side of the work machine 10) and a right arm 16 (i.e., positioned on a right side of the work machine 10). Each arm 16 may each be raised and lowered via an actuator 40. The actuators 40 are shown schematically in FIG. 2, while a left side actuator 40 is shown in FIG. 1. In some embodiments, the actuators 40 may comprise linear actuators, such as hydraulic cylinders (e.g., single or double-acting cylinders), pneumatic cylinders, and/or electric linear actuators. Each of the arms 16 may extend forward to a front end that supports a hitch plate 42, as shown in FIG. 1. Such hitch plate 42 may extend between the left and right arms 16 and may generally comprise a quick-hitch connection assembly configurable to releasably secure various types of attachments 18 to the arms 16. In some embodiments, each of the arms 16 may include a pitch actuator 44 (as shown in FIGS. 1 and 2) and/or a roll actuator 46 (shown in FIG. 2 but not shown in FIG. 1) that permit tilting of the hitch plate 42 and any attachment 18 coupled with the hitch plate 42. The pitch actuators 44 may permit the hitch plate 42 (and any attachment coupled thereto) to rotate forward/rearward with respect to the arms 16 of the work machine 10 and/or with respect to the ground. The roll actuator 46 may permit the hitch plate 42 (and any attachment 18 coupled thereto) to rotate rightward/leftward with respect to the arms 16 of the work machine 10 and/or with respect to the ground. The pitch and roll actuators 44, 46 may comprise hydraulic cylinders (e.g., single or double-acting cylinders), pneumatic cylinders, and/or electric linear actuators. As such, for example, if an attachment 18 in the form of a bucket is attached to the hitch plate 42, actuation of the pitch actuators 44 will permit the bucket to be tilted forward/rearward such as for selectively collecting and dumping of material. On the other hand, if an attachment 18 in the form of a plow is attached to the hitch plate 42, actuation of the roll actuator 46 will permit the plow to be tilted rightward/leftward as may be necessary to align the plow with the ground surface.

The front of the work machine may also include a hydraulic coupling system 48, as shown in FIG. 1, configured to hydraulically link the hydraulic system of the work machine with a hydraulically-operated attachment 18. In certain other embodiments, certain attachments may have their own integral actuators, such as yaw actuators configured to provide a forward-rearward actuating of the left and right sides of the attachment with respect to the hitch plate. As such, the attachment 18 can perform yaw positional adjustments.

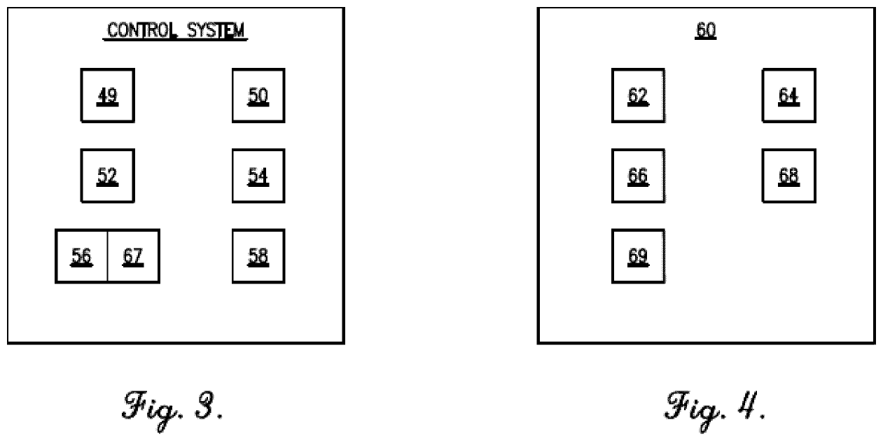

As noted previously, the work machine's 10 control station 20 (referred to hereinafter as “cab 20”) may include a plurality of user controls (illustrated schematically as user controls 49 of a control system in FIG. 3), e.g., buttons, switches, levers, joysticks, touchscreen displays, etc., that the operator can access and manipulate to control the work machine 10 and/or the arms 16 (and associated attachment 18). Specifically, an operator may manipulate such user controls 49 to perform various functions of the work machine loader, such as (i) propelling and/or turning the work machine 10, (ii) raising/lowering the arms 16 and/or associated attachments 18, and/or (iii) operating any auxiliary functions of the associated attachments 18.

In certain embodiments, the user controls 49 may include a graphic display 50, as shown schematically in FIG. 3, which comprises an electronic display, such as a cathode ray tube, liquid crystal display, plasma, or touch screen that is operable to display visual graphics, images, text, etc. In embodiments in which the graphic display 50 is a touchscreen, the operator can manipulate the graphic display 50 to control various aspects and/or functionalities of the work machine 10. The graphic display 50 may include, or may otherwise be associated with, one or more memory elements and processing elements. The memory elements may comprise non-transitory computer readable media and/or firmware, with a computer program stored thereon. The processing elements may comprise processors, CPUs, FPGAs, etc., which are configured to execute computer programs stored on the memory elements to perform various functions and features of the work machine 10. It should be understood that certain of the work machine's 10 functions and features discussed above and below may be performed by execution of the computer program by the processing elements. For example, the graphic display 50 may be configured to (by the processing elements executing the computer program stored on the memory elements) (i) obtain information from various components of the work machine 10 (e.g., via sensors, actuators, timers, clocks, etc.) so as to present such information to the operator via the graphic display 50, and (ii) receive instructions from the operator (e.g., via the graphic display 50 or other of the control elements of the user controls 49) to control various operations of the work machine 10. For example, the graphic display 50 may present various graphical elements/icons or graphical user interfaces (GUIs) that provide information to the operator and/or that facilitate interaction and control of the work machine 10 by the operator. In embodiments in which the graphic display 50 is a touchscreen, the GUIs enable the operator to interact with the work machine 10 by touching or pointing at display areas of the GUI. In some other embodiments, the operator will interact with the GUls and/or the loader by manipulating interactable graphical elements that are associated with the graphic display 50.

Alternatively, or in addition, the work machine 10 may include a control system, as shown schematically in FIG. 3, for controlling certain functionality of the work machine 10. In some embodiments, the control system may include the control elements of the user controls 49 and the graphic display 50 previously discussed. In addition, the control system may comprise one or more processing elements 52, one or more memory elements 54, and/or one or more communication elements 56. The control system of the work machine 10 may also include one or more sensors 58 configured to collect information related to the operation of the work machine 10. The processing elements 52 and/or memory elements 54 may be similar to (or the same as) the processing elements and/or memory elements discussed above with respect to the graphic display 50. Specifically, processing elements 52 may comprise one or more processors, CPUs, FPGAs, etc., which are configured to execute computer programs stored on the memory elements 54 to perform various functions and features of the work machine 10. The memory elements 54 may comprise non-transitory computer-readable media and/or firmware, with a computer program stored thereon. As such, the memory elements 54 of the control system may comprise non-transitory storage media that includes one or more computer programs for carrying out various functions described herein. In some embodiments, the graphic display 50, and/or the user controls 49 more generally, may form part of the control system of the work machine 10.

The communication elements 56 may comprise various wired or wireless communication ports, receivers, transmitters, and/or transceivers (i.e., combination of receiver and transmitter), configured to send and receive information to/from various elements of the work machine 10 and/or the attachments 18 associated with the work machine 10. As such, the control system can receive information from elements of the work machine 10 and/or the attachments 18 associated with the work machine 10 and can control such elements (or different elements) based on such information. For example, as will be described in more detail below, the control system may obtain information from the hydraulic system of the work machine 10 (e.g., via the communication elements 56) and control the attachments 18 (e.g., via instructions generated by the processing elements 52 and/or memory elements 54 and sent via the communication elements 56) in response to such information. Wired communication may be facilitated by the communication element 56 via electrical/optical wires, cables, or the like. Wireless communication may be facilitated by the communication element 56 via RF transceivers, including via Wifi, Bluetooth, Cellular, or other similar protocols.

The sensors 58 of the work machine's 10 control system may be configured to collect various information related to the operation of the work machine 10. Such sensors 58, as will be described in more detail below, may include pressure sensors, flow rate sensors, position sensors, motion sensors, angle sensors, location sensors, and the like.

### Programming Tags

In certain embodiments, as discussed above, the work machine 10 may be configured to operably couple with (and decouple from) various types of attachments 18. To facilitate proper operation of each of the various types of attachments 18, each of the attachments 18 may be associated with an Identification (ID) Module or “Tag” 60. A Tag 60, illustrated schematically in FIG. 4 and shown attached to an attachment 18 in FIG. 1, may comprise a self-contained unit in the form of a housing that encloses one or more memory elements 62, processing elements 64, and wireless transceivers 66. As will be discussed in more detail below, the Tag may be configured to communicate with a wireless transceiver 67 associated with and/or attached to the work machine 10 (see FIG. 1). Thus, the wireless transceiver 66 of the Tag 60 may comprise various wireless communication ports, receivers, transmitters, and/or transceivers (i.e., combination of receiver and transmitter), configured to send and receive information from/to the Tags 60. Wireless communication may be facilitated by the wireless transceiver 66 via WiFi, Bluetooth, Cellular, or other similar protocols.

The Tag 60 may also include a power source 68, such as a battery, which provides electrical power to various components of the Tag 60 (in some embodiments, the battery may be rechargeable). The Tag 60 may also include various other sensors 69, as discussed in more detail below, for capturing data related to the Tag 60 and/or the attachment 18 to which the Tag 60 is connected. Each Tag 60 may be physically coupled to a particular attachment 18 (e.g., via brackets, fasteners, adhesives, or the like), as shown in FIG. 1.

The memory element 62 associated with a given Tag 60 may be configured to store identification (ID) information that identifies the particular attachment 18 to which the Tag 60 is coupled. The ID information may comprise an alphanumeric code, a hexadecimal has (hex/hash) code, or the like. The memory elements 62 of the Tag 60 may be in the form of a non-transitory computer-readable storage media that includes one or more computer programs for carrying out various of the functions described herein. Generally, the Tag 60 will require programming (as discussed in more detail below) to have the ID information of the associated attachment 18 (to which the Tag 60 is associated and/or connected) stored on the memory element 62.

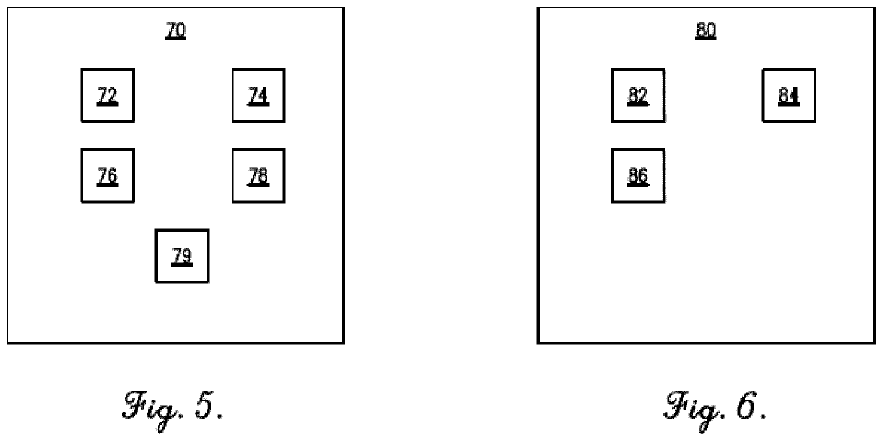

The Tag 60 may be programmed from various electronic devices 70, such as mobile devices, e.g., smartphones, tablets, laptop computers, or the like, as schematically illustrated in FIG. 5. The electronic device 70 may comprise generally any computing device with one or more processing elements 72, one or more memory elements 74, one or more communication elements 76, and/or one or more graphic displays 78. The processing elements 72 and/or memory elements 54 may be similar to (or the same as) the processing elements and/or memory elements discussed above with respect to the graphic display 50 and/or the control system of the work machine 10. Specifically, processing elements 72 may comprise one or more processors, CPUs, FPGAs, etc., which are configured to execute computer programs stored on the memory elements 74 to perform various functions and features described herein. The memory elements 74 may comprise non-transitory computer-readable media and/or firmware, with a computer program stored thereon. As such, the memory elements 74 of the electronic device 70 may comprise non-transitory storage media that includes one or more computer programs for carrying out various functions described herein.

The communication elements 76 may comprise various wired or wireless communication ports, receivers, transmitters, and/or transceivers (i.e., combination of receiver and transmitter), configured to send and receive information to/from the Tags 60 and/or the wireless transceiver 67 of the work machine 10. Wired communication may be facilitated by the communication element 76 via electrical/optical wires, cables, or the like. Wireless communication may be facilitated by the communication element 76 via RF transceivers, including via Wifi, Bluetooth, Cellular, or other similar protocols.

The graphic display 78 may be in the form of an electronic display, such as a cathode ray tube, liquid crystal display, plasma, or touch screen that is operable to display visual graphics, images, text, etc. In embodiments in which the graphic display 78 is a touchscreen, the operator can manipulate the graphic display 78 to control various aspects and/or functionalities of the electronic device 70. Furthermore, the electronic device 70 may include various types of sensors 79 for obtaining information or data, such as imaging sensors or devices (e.g., cameras), position sensors, inertial sensors, or the like.

The following description illustrates how a Tag 60 may be programmed with ID information for an associated attachment 18 (e.g., the specific attachment 18 to which the Tag 60 is coupled) using an electronic device 70 in the form of a mobile device. The electronic device 70 will hereinafter be referred to as a mobile device 70, though it is understood that the device need not necessarily be mobile.

It is initially noted that before a Tag 60 has been programmed, the memory element 62 of the Tag 60 does not store ID information for any attachment 18. As a result, such a Tag 60 may be referred to as an “empty” or “blank” Tag 60. Once a user has selected a particular attachment 18 to associate with a particular Tag 60, the user may use the mobile device 70 to obtain a serial number (or other identifier) of the particular Tag 60. The serial number of the particular Tag 60 may be obtained via wireless communication (e.g., Bluetooth) using the communication elements and/or transceivers 66, 76 associated with the particular Tag 60 and the mobile device 70. For example, in some embodiments, the Tag 60 may periodically (or upon request from the mobile device 70) transmit its serial number, such that the mobile device 70 can receive the Tag's 60 serial number. In other embodiments, the Tag 60 may be configured to transmit its serial number after being shaken or jostled (as determined by a motion sensor 69, e.g., an accelerometer or other inertial measurement unit, associated with the Tag 60). Alternatively, the serial number of the Tag 60 may be obtained using an imaging sensor of the mobile device 70 (e.g., a camera) that photographs or scans a Tag label secured to the Tag 60. The Tag label may include a barcode or QR code that identifies the serial number of the Tag 60. Alternatively, the Tag label may have the serial number listed explicitly thereon, such that the user can use the imaging sensor of the mobile device 70 to scan the serial number, which can be interpreted by the mobile device 70 using image recognition. In still further embodiments, the user may simply use the mobile device 70 to manually enter or type the Tag's 60 serial number (e.g., via the mobile device's 70 touchscreen or keyboard) that is displayed on the Tag label.

Next, the user may use the mobile device 70 to obtain a serial number (or other identifier) of the particular attachment 18 to which the Tag 60 is to be associated. It is noted that the serial number of the attachment 18 may, in some embodiments, be different than the ID information for the attachment 18 discussed in more detail below. The serial number of the attachment 18 may be obtained using the mobile device's 70 imaging sensor that scans an attachment label secured to the attachment 18. The attachment label may include a barcode or QR code that identifies the serial number of the attachment 18. Alternatively, the attachment label may have the serial number listed explicitly thereon, such that the user can use the imaging sensor of the mobile device 70 to scan the serial number, which can be interpreted by the mobile device 70 using image recognition. In still further embodiments, the user may simply use the mobile device 70 to manually enter or type the attachment's 18 serial number (e.g., via the mobile device's 70 touchscreen or keyboard) that is displayed on the attachment label.

Upon the mobile device 70 obtaining the serial numbers for each of the particular Tag 60 and the particular attachment 18, the serial numbers may be transmitted to a remote computing device 80, which is illustrated schematically in FIG. 6. The remote computing device 80 may comprise generally any computing device with one or more processing elements 82, one or more memory elements 84, one or more communication elements 86. In certain embodiments, the remote computing device 80 may be a server-type device that provides a cloud-based database that remotely stores information associated with a plurality of different Tags 60, attachments 18, and/or work machines 10. The remote device 80 may be wirelessly accessed via the communications elements 86 (e.g., via cellular or other RF networks) by the mobile device 70 using various applications, such as a mobile app, online resource (e.g., web program), and/or an application programming interface (API). Such applications may comprise computer code or programs stored on the mobile device 70 or on the remote device 80.

The remote device 80 may correlate or match the particular Tag 60 with the particular attachment 18 (as determined by comparing the serial numbers of the particular Tag 60 and the particular attachment 18) and store a pairing indication that the particular Tag 60 and the particular attachment 18 are associated together as a paired unit. The remote device 80 may also transmit such a pairing indication to the mobile device 70. In addition, or alternatively, the remote device 80 may determine the ID information for the particular attachment 18 (e.g., the alphanumeric code, hex/hash code, or other similar code that identifies the particular attachment 18 to which the particular Tag 60 is associated) and transmit the ID information of the attachment 18 to the mobile device 70. The remote device may determine the ID information of the particular attachment based on the serial number of the particular attachment received from the mobile device 70.

In some embodiments, the remote device 80 may also transmit various other information associated with the attachment 18 to the mobile device 70, such as attachment characteristics. As will be discussed in more detail below, such attachment characteristics may include, for example: attachment name, attachment type, attachment photographs, attachment dimensions/size/weight, operating hydraulic pressure(s) for the attachment, operating hydraulic flow rate(s) for the attachment, operating positions/depths/orientations/angles for the attachment, usage information (e.g., hours used) for the attachment, and preferred camera views for the attachment, etc. In certain embodiments, the ID information may be included as part of the attachment characteristic.

Once the mobile device 70 has obtained the ID information for the particular attachment 18, the mobile device 70 may transmit the ID information to the particular Tag 60 (that is being associated with the particular attachment 18) to be stored on the memory element 62 of the Tag 60. In some embodiments, the mobile device 70 may also transmit the additional attachment characteristics for the particular attachment 18 to the Tag 60 for storage on the memory element 62 of the Tag 60. Regardless, once the particular Tag 60 has been programmed with the ID information of the particular attachment 18 to which the Tag 60 is to be associated, the Tag 60 will be considered programmed.

Notably, the mobile device 70 may be configured to wirelessly communicate with multiple different Tags 60 each coupled with a separate attachment 18, particularly when all of the attachments 18 and associated Tags 60 are positioned within a given geographic area. For example, if a staging area contains several different attachments 18 (all with their own Tags 60) that can be used by a work machine 10, the mobile device 70 may be configured to communicate with all of such Tags 60 to manage such attachments 18 (e.g., to determine which attachments 18 are available for use with the work machine 10, to receive a battery status of each Tag 60, to determine a position of such attachments 18, etc.). In such cases, the communication element 76 of the mobile device 70 may be configured to wirelessly communicate (e.g., via Bluetooth) over a relatively long range (e.g., a “long-range mode” extending at least 5 yards, 10 yards, 15 yards, 20 yards, 25 yards, 50 yards, 100 yards, 150 yards, 200 yards or more, and/or from 5 to 200 yards, from 10 to 150, or from 15 to 100 yards from the mobile device 70) so that the mobile device 70 can communicate with various Tags 60 (e.g., via the wireless transceivers 66 of the Tags) that are positioned within the staging area.

In contrast, when the mobile device 70 is being used to program a particular Tag 60 (i.e., programming a blank or empty Tag 60 with ID information of an attachment 18 with which the Tag 60 is to be associated), the communication element 76 of the mobile device 70 may be configured to wirelessly communicate (e.g., via Bluetooth) over a relatively short range (e.g., a “short-range mode” extending no more than 30 feet, 25 feet, 20 feet, 15 feet, 10 feet, 5 feet, 3 feet, 1 foot, or less, and/or from 0 to 30 feet, from 0.1 to 30 feet, from 1 to 25 feet, from 1 to 20 feet, from 1 to 15 feet, from 1 to 10 feet, or from 1 to 5 feet from the mobile device 70). As such, the mobile device 70 is configured to communicate only with the particular Tag 60 (e.g., via the wireless transceiver 66 of the Tag) that is being programmed.

Pairing/Unpairing Attachments with a Work Machine

Before physically coupling an attachment 18 with a work machine 10, the programmed Tag 60 associated with the attachment 18 may periodically transmit its ID information (and perhaps other attachment characteristics or sensor data) wirelessly. Such periodic transmission may have a relatively low transmission frequency (e.g., about every 3 seconds, about every 4 seconds, about every 5 seconds, about every 6 seconds, about every 7 seconds, about every 8 seconds, about every 9 seconds, about every 10 seconds, about every 11 seconds, or about every 12 seconds), so as to preserve the battery life of the Tag 60. In certain embodiments, the low transmission frequency is once about every 4 to 6 seconds, about every 3 to 7 seconds, about every 5 to 20 seconds or about once every 5 to 10 seconds.

In addition, when a given attachment 18 is not physically connected to a work machine 10, the Tag 60 associated with the given attachment 18 may periodically broadcast the periodic transmission according to a first wireless transmission protocol or messaging scheme. Such first wireless transmission protocol may be a Bluetooth 4 transmission protocol that provides a relatively small message capacity (e.g., from 15 to 35 bytes or from 20 to 30 bytes per message) for each transmission, with a speed of such transmission being about 1 Mbps. The first wireless transmission protocol is particularly configured for communication with mobile devices, such that an operator's mobile device 70 can be used in a management mode to manage a plurality of attachments 18 (and associated Tags 60). Thus, as discussed above, when the mobile device 70 is being used to manage a plurality of attachments 18 (each with its own Tag 60) not coupled with a work machine 10 and positioned within a given area (e.g., a staging area), each of the Tags 60 of the attachments 18 may periodically transmit (using the low transmission frequency) their respective ID information (or other information associated with the Tag 60 or of the associated attachment 18) to the mobile device 70 using the first transmission protocol. Regardless, such periodic transmission may also be received by the control system of the work machine 10 so that the work machine 10 can determine which attachments 18 are in the area and are available for use.

In contrast, when the attachment 18 becomes physically connected with a work machine 10, the Tag 60 will be configured to periodically transmit its ID information (and perhaps other attachment characteristics or sensor data) wirelessly at a relatively high transmission frequency (e.g., at least once every 5 seconds, every 4 seconds, every 3 seconds, every 2 seconds, or every 1 second and/or from between every 1 second to every 5 seconds, or between every 1 second to every 3 seconds).

In addition, when a given attachment 18 is connected to a work machine 10, the Tag 60 associated with the attachment 18 may periodically broadcast the periodic transmission according to a second wireless transmission protocol or messaging scheme. The second wireless transmission protocol may be a Bluetooth 5 transmission protocol that provides a relatively large message capacity (e.g., greater than 31 bytes, from 32 to 275 bytes, from 35 to 275 bytes, from 225 to 275 bytes, or from 240 to 260 bytes per message) for each transmission, with a speed of such transmission being about 2 Mbps. The second wireless transmission protocol is particularly configured for communication with the control system of the work machine 10, such that a large amount of information may be exchanged quickly between the Tag 60 and the work machine 10 when the attachment 18 is connected with the work machine 10. Nevertheless, such a second wireless transmission protocol is also configured for communication with mobile devices.

In some specific embodiments, the Tag 60 will be configured to transmit information at the low transmission frequency and/or according to the first transmission protocol/messaging scheme when the attachment 18 and/or the Tag 60 are not moving (e.g., as determined by the motion sensor 69 of the Tag 60), whereas the Tag 60 will be configured to transmit information at the high transmission frequency and/or according to the first transmission protocol/messaging scheme when the attachment 18 and/or the Tag 60 are in motion (e.g., as determined by the motion sensor 69 of the Tag 60). The determination of when an attachment 18 is connected to a work machine will now be described in more detail.

The Tags 60 may, in certain embodiments, comprise a variety of sensors 69 such as accelerometers, gyroscope, inertial measurement units, or GPS receivers (or other position or motion sensors), as well as various other sensors 69 that may be beneficial in operating the associated work machine 10 and/or the attachment 18 with which the Tag 60 is connected. As used herein, the term motion sensors may comprise any sensor configured to measure movement and/or an orientation of the Tag 60 (and/or the associated attachment 18), including accelerometers, gyroscope, and/or inertial measurement units (IMU). It is generally understood that an IMU will generally comprise at least one accelerometer and at least one gyroscope. In some embodiments, the Tag 60 may include three accelerometers, such that the Tag 60 is configured to sense movement of the Tag 60 (and the particular attachment 18 with which the Tag 60 is coupled) in each of the three, physical space dimensions (e.g., -x, -y, and-z dimensions). In addition, the Tag 60 may include a GPS receiver for determining the geographic location of the Tag 60 (and the particular attachment 18 with which the Tag is coupled) on the earth. As such, the sensors 69 may be used to determine the orientation/angle of the Tag 60 (and associated attachment 18), the physical/geographic location of the Tag 60 (and associated attachment 18), and/or whether the attachment 18 is operably coupled with a work machine 10 or is disconnected from the work machine 10. The Tags 60 are also configured to determine, via the motion sensors 69, when the Tags 60 (and the associated attachments 18) are in motion.

In addition, or alternatively, in some embodiments, the Tag 60 coupled with a given attachment 18 may be configured to alternate transmission of the first transmission protocol/messaging scheme (e.g., Bluetooth 4) and the second transmission protocol/messaging scheme (e.g., Bluetooth 5). The rate or frequency at which the Tag 60 alternates transmitting the first and second messaging schemes may be dependent on whether the Tag 60 (and thus the associated attachment 18) is in motion. In more detail, as previously noted, each Tag 60 may include a motion sensor 69 configured to determine when the Tag 60 and/or the associated attachment 18 is motion. The Tag 60 may also include a wireless transceiver 66 configured to transmit signals via a first messaging scheme and a second messaging scheme. When the Tag 60 and/or the associated attachment 18 is not in motion, the Tag 60 may be configured to alternate transmitting signals between the first messaging scheme and the second messaging scheme according a slow transition frequency. Such a slow transition frequency may be about every 5 seconds, every 4 to 6 seconds, every 3 to 7 seconds, every 5 to 10 seconds, or every 5 to 20 seconds. In contrast, when the Tag 60 and/or the associated attachment 18 is in motion, the Tag 60 is configured to alternate transmitting signals between the first messaging scheme and the second messaging scheme according a fast transition frequency. Such a fast transition frequency may be about every 1 second, every 2 seconds, between every 0.1 and 2 seconds, and/or between every 0.5 and 1.5 seconds.

Thus, for example, when an attachment 18 is not in motion (e.g., uncoupled from a work machine 10 and resting on the ground, or coupled with a work machine 10 but in a stationary position), the Tag 60 of the attachment 18 will transmit a signal that alternates between the first messaging scheme and the second messaging scheme. The transition frequency between which the Tag 60 alternates transmission between the first messaging scheme and the second messaging scheme will be a slow transmission frequency. In contrast, when the attachment 18 is in motion (e.g., coupled with a work machine 10 or being coupled with a work machine 10 and otherwise in motion), the Tag 60 of the attachment 18 will still transmit a signal that alternates between the first messaging scheme and the second messaging scheme. However, the transition frequency between which the Tag 60 alternates transmission between the first messaging scheme and the second messaging scheme will be a fast transmission frequency.

As noted previously, each of the first messaging scheme and the second messaging scheme is a wireless Bluetooth scheme. Specifically, the first messaging scheme may be a Bluetooth 4 messaging scheme with a message capacity from 15 to 35 bytes per message and a transmission speed of about 1 Mbps. Such a messaging scheme may be preferred for communication between the Tag 60 and a mobile device 70. In contrast, the second messaging scheme may be a Bluetooth 5 messaging scheme with a message capacity from 225 to 275 bytes per message and a transmission speed of about 2 Mbps. Such a messaging scheme may be preferred for communication between the Tag 60 and a control system of a work machine 10. The determination of whether the Tag 60 and/or associated attachment 18 is in motion may be made based on data generated by the motion sensor 69 of the Tag 60. Such a motion sensor 69 may comprise an accelerometer.

To operably couple a particular attachment 18 with a work machine 10, the work machine 10 will approach the particular attachment 18 until the front ends of the work machine's 10 arms 16 (including the hitch plate 42) are adjacent to the attachment 18. Once the hitch plate 42 makes contact with the particular attachment 18, such contact will impart an impact force onto the attachment 18 causing the attachment 18 and the associated Tag 60 coupled with the attachment 18 to shake or jostle. Such jostling will be sensed by the sensors 69 (e.g., the accelerometers) of the Tag 60, which will cause the Tag's 60 wireless transceiver 66 to transmit the ID information stored in the memory elements 62. As noted above, such a transmission may be emitted at the relatively high transmission frequency and using the second wireless transmission protocol (e.g., Bluetooth 5 protocol). Regardless, the ID information included in the transmission is indicative of the particular attachment 18 to which the Tag 60 is coupled. The transmitted ID information will be received by the wireless transceiver 67 associated with the control system of the work machine 10. As such, the control system of the work machine 10 will be able to identify, based on the ID information transmitted from the Tag 60, the particular attachment 18 to which the work machine 10 is being coupled. Once the attachment 18 is physically connected with the work machine 10, the Tag 60 will be configured to wireless transmit the ID information (and perhaps other attachment characteristics or sensor data) periodically according to the high transmission frequency (e.g., about once every second). If the attachment 18 is disconnected from the work machine 10, the Tag 60 will again be configured to wireless transmit the ID information (and perhaps other attachment characteristics or sensor data) periodically according to the low transmission frequency (e.g., between every 5-10 seconds) and using the first wireless transmission protocol (e.g., Bluetooth 4 protocol).

In some embodiments, the work machine's 10 control system may store various attachment characteristics for a plurality of attachments 18 in the memory elements 54. Such attachment characteristics may include, for example: attachment type, attachment name, attachment photograph (e.g., 2D or 3D graphical image), dimensions/size (e.g., length, width, height/depth) of the attachment, weight of the attachment, operating hydraulic pressure(s) for the attachment, operating hydraulic flow rate(s) for the attachment, operating positions/depths/orientations/angles for the attachment, usage information (e.g., hours used) for the attachment, and preferred camera views for the attachment. Each ID information (which corresponds with a particular attachment 18) may be associated with a group of attachment characteristics for that particular attachment 18. Thus, the work machine 10 may store a plurality of ID information (each associated with a particular attachment 18), as well as a plurality of attachment characteristics for that particular attachment 18.

When the particular attachment 18 is being physically coupled with and communicatively paired with the work machine 10 (e.g., via linking and communication between the wireless transceivers 66, 67 of the Tag 60 associated with the particular attachment 18 and the work machine 10), the ID information for the particular attachment 18 may be transmitted to the work machine 10 from the Tag 60. As such, the work machine's 10 control system may determine the group of attachment characteristics for the particular attachment 18 based on the received ID information. In some embodiments, certain of the attachment characteristics may be presented to an operator of the work machine 10 (e.g., via the graphic display 50), such that the operator can verify/approve that the particular attachment 18 is the correct/appropriate attachment 18 being coupled with the work machine 10. In some embodiments, the attachment characteristics may be identified automatically by the work machine 10 upon the work machine's hydraulic quick-attachment mechanism of the hitch plate 42 being activated so as to initiate the coupling process with the attachment 18.

In more detail, if an operator intends to operably connect a work machine 10 with an attachment 18 in the form of a large bucket, and the operator has two buckets available (e.g., a large bucket and a small bucket), embodiments of the present invention permit the operator to verify/approve that the appropriate attachment 18 (i.e., the large bucket) is coupled with the work machine 10. Specifically, as the work machine 10 approaches a first of the two buckets and jostles the first bucket, the ID information from the Tag 60 associated with the first bucket will be transmitted to the work machine 10. The work machine's 20 control system will compare the ID information with the plurality of groups of attachment characteristics stored on the control system to identify the first bucket. In some embodiment, certain attachment characteristics associated with the ID information (and thus the first bucket) will be presented to the operator, such as on the graphic display 50 of the work machine 10. Specifically, the type, name, and/or graphical image of the first bucket can be presented on the graphic display 50, such that the operator can (via the graphic display) verify that the first bucket is the large bucket that the operator intends to operably connect with the work machine 10. Upon verification, the operator can use the work machine 10 and the large bucket coupled therewith to perform necessary operations.

In contrast, if the type, name, and/or graphical image of the first bucket presented on the graphic display 50 indicates the first bucket is the small bucket, the operator can decline to couple the first bucket with the work machine 10 and, instead, can couple the second bucket with the work machine 10. Such coupling of the second bucket can be performed in a similar manner to that discussed above. Specifically, as the work machine approaches the second bucket, the ID information from the Tag 60 associated with the second bucket will be transmitted to the work machine 10. The work machine's control system will compare the ID information with the plurality of groups of attachment characteristics stored on the control system to identify the second bucket. In some embodiment, certain attachment characteristics associated with the ID information (and thus the second bucket) will be presented to the operator. For instance, the type, name, and/or graphical image of the second bucket can be presented on the graphic display 50, such that the operator can (via the graphic display) verify that the second bucket is the large bucket that the operator intends to operably connect with the work machine 10. Upon verification, the operator can use the work machine 10 and the large bucket coupled therewith to perform necessary operations.

In some embodiments, the control system of the work machine 10 may be configured to determine if the particular attachment 18 being coupled with the work machine is not configured for use with the work machine 10. Specifically, upon the particular attachment 18 being coupled with the work machine, and the ID information associated with the particular attachment 18 being transmitted from the Tag 60 of the particular attachment to the work machine 10, the work machine 10 may be configured to compare the attachment characteristics of the attachment 18 with capabilities of the work machine 10. If one or more of the attachment characteristics of the attachment 18 do not correspond with the capabilities of the work machine 10, the work machine 10 may generate an alert that indicates to the operator of the work machine 10 that the attachment 18 is not appropriate for use with the work machine 10. As an example, if the attachment characteristics for the particular attachment 18 indicate that the preferred hydraulic flow rate for the attachment 18 is a high flow rate, but the work machine 10 is only configured to provide a lower, standard flow rate, then the work machine 10 may generate an alert indicating such a discrepancy to the operator so that the operator can couple a different attachment 18 with the work machine 10 (or the operator can use a different work machine 10 to couple with the high flow rate attachment 18). Such an alert may be audible, graphical, tactile, or the like. For example, an audible alert may be generated via a speaker associated with the control system of the work machine 10. Alternatively, a graphical alert may be generated via the graphic display 50 of the work machine 10. Alternatively still, a tactile alert may be generated on one or more the user controls 49 of the work machine 10.

Similarly, if during coupling of a particular attachment 18 with a work machine 10, the work machine 10 determines that the Tag 60 associated with the particular attachment 18 transmitted no ID information i.e., indicating that the Tag 60 is unprogrammed or blank, the work machine 10 may generate an alert. Such an alert may indicate to the operator that the Tag 60 has not yet been programmed, and the Tag 60 must be programmed before the attachment 18 can be used with the work machine 10.

### Attachment Monitoring and Control

As noted above, in some embodiments, attachment characteristics for a plurality of attachments 18 may be stored on memory element 54 associated with the control system of the work machine 10. As such, the work machine 10 can present, e.g., via a graphic display 50, the attachment characteristics of a particular attachment 18 when the attachment 18 is physically coupled with the work machine 10 and the ID information of the particular attachment 18 is transmitted from the attachment's 18 Tag 60 to the work machine 10. However, in alternate embodiments, the attachment characteristics of the particular attachment 18 may be stored on the memory elements 62 of the Tag 60 coupled with the particular attachment 18, such that the attachment characteristics may be transmitted from the Tag 60 to the work machine 10 along with the ID information once the particular attachment 18 is coupled with the work machine 10.

Nevertheless, certain embodiments of the present invention may be configured to utilize the attachment characteristics of a particular attachment 18 to allow for efficient operation of the particular attachment 18 by the work machine 10. Various sensors 58 associated with the work machine 10 may be used to determine, to control, and/or to display the operating angles and/or positions of the attachment 18 when being used by the work machine 10. In more detail, upon coupling a particular attachment 18 with a work machine 10, the Tag 60 associated with the particular attachment 18 will become communicatively paired with the work machine 10, and specifically with the control system of the work machine 10 as was described previously. Such pairing will be maintained throughout operation of the particular attachment 18 by the work machine 10, until the attachment 18 is physically uncoupled and communicatively unpaired from the work machine 10. As previously described, the attachment characteristics may include size/dimension information of the attachment 18, as well as general positioning information related to how the attachment 18 is normally positioned or oriented when physically coupled with the work machine 10.

In addition to the attachment characteristics, the control system of the work machine 10 may use various sensors 58 of the work machine to determine the real-time position, angle, and/or orientation of the attachment 18 coupled to the work machine 10. The determined position of the attachment 18 may be an angular position of the attachment, which may include a front-to-back tilt of the attachment with respect to a ground level, a side-to-side tilt of the attachment with respect to a ground level, and a side-to-side tilt of the attachment with respect to a hitch plate of the work machine. The position of the attachment 18 may be a spatial position of the attachment, which may include a height of the attachment above a ground level, and a depth of the attachment below a ground level.

Such sensors 58 of the work machine 10 that are used to determine the position of the attachment 18 may include position sensors, such as potentiometers, configured to measure the positions/angles of the loader arms 16. Similar position sensors may also be used on the hitch plate 42 of the work machine 10 to measure the position/angle of the hitch plate 42 that connects the attachment 18 with the loader arms 16. The sensors 58 may further include inertial measurement units (e.g., accelerometers and/or gyroscopes) associated with each of the work machine 10 frame 12, cab 20, loader arms 16, and the hitch plate 42. Differences between the sensed position/orientation of two of such inertial measurement units (e.g., between the frame 12 or cab 20 of the work machine 10 and the hitch plate 42) may be used to determine the position/orientation of the attachment 18 with respect to the work machine 10 frame 12 or cab 20. Position sensors in the form of stroke sensors may also be used with the various hydraulic cylinders 40,44,46 of the work machine 10 to measure the extent to which the cylinder rods of the cylinders 40,44,46 are extending from the respective barrels. As such, the position of the attachment 18 can be determined by such sensors monitoring the positions of the loader arms 16 and/or hitch plate 42.

Furthermore, the sensors 58 may include various pressure sensors associated with the hydraulic cylinders 40,44,46 used to actuate the loader arms 16 and the hitch plate 42. Such pressure sensors may be used to determine the position/orientation of the loader arms 16 and the hitch plate 42 and, thus, the attachment 18. Such pressure sensors may also be used to determine how much force the attachment 18 is experiencing, e.g., how hard is the attachment 18 pushing into the ground or whether the attachment 18 is raised in the air or is resting on the ground. Pressure sensors may also be associated with the hydraulic pumps (e.g., hydraulic auxiliary pump 32 and/or hydrostatic transmissions 34) and/or hydraulic lines of the work machine's hydraulic system. The sensors 58 may also include speed sensors (e.g., inertial measurement units or sensos associated with the drive assembly 14 or hydraulic system of the work machine 10) configured to determine the traveling speed and/or acceleration of the work machine 10.

The control system of the work machine 10 may use the sensed information/data from the sensors 58 to determine the position and/or orientation of the attachment 18 coupled to the work machine 10. In some embodiments, various attachment characteristics of the attachment 18 (as obtained based the ID information of the attachment 18 received from the Tag 60 associated with the attachment 18), such as the size/dimensions of the attachment 18, may also be used to determine the position and/or orientation of the attachment 18 coupled to the work machine 10. In still further embodiments, the Tag 60 associated with the attachment 18 may transmit positional information (e.g., as obtained from the accelerometer, IMU, or other sensor 69 within the Tag 60) to the work machine 10 to aid in determining the position and/or orientation of the attachment 18 coupled to the work machine 10. In some embodiments, the work machine 10 may be configured to display a graphical representation of the position and/or orientation of the attachment 18 via the graphic display 50 of the work machine 10. Alternatively, or in addition, the control system of the work machine 10 may be configured to automatically control operation of the attachment 18 and/or the work machine 10 based on the determined position and/or orientation of the attachment 18, as will be described in more detail below.

In more detail, data from the sensors 58 of the work machine 10 may be transmitted to the processing and/or memory elements 52, 54 of the work machine's 10 control system in real time, such that the real-time position and/or orientation of the particular attachment 18 may be monitored by the work machine 10 and/or presented to the work machine's 10 operator via the graphic display 50 in real-time. For instance, the control system of the work machine 10 may generate a graphical representation of the real-time position and/or orientation (e.g., angle with respect to the ground or to the work machine's 10 frame 12 or cab 20) of the particular attachment 18 and may present such graphical representation on the work machine's 10 graphic display 50. The graphical representation may be (i) an image/drawing of the attachment 18 oriented/positioned in the measured orientation/angle and/or position, or (ii) a numerical/textual description of the measured orientation/angle and/or position of the attachment 18. As such, the operator of the work machine 10 can accurately control the orientation/angle and/or position of the particular attachment 18 connected with the work machine 10 by monitoring the representation of the orientation/angle and/or position of the attachment 18 presented on the graphic display 50 and manipulating the user controls 49 (e.g., the joysticks) in response, to thereby control the actual orientation/angle and/or position of the attachment 18. Examples of attachments 18 for which the orientation/angle/position of such attachments 18 may be determined and displayed on the graphic display 50 of the work machine 10 includes blades (e.g., dozer blades or box blades), pallet forks, bale spears, buckets, skid cutters, cold planers, augers, grapples, etc.

For example, when an attachment 18 in the form of a blade is coupled with the work machine 10, the Tag 60 coupled with the blade will transmit the ID information associated with the blade to the work machine 10. The work machine 10 may then determine attachment characteristics of the blade by comparing the ID information transmitted from the Tag 60 with ID information stored in the work machine's 10 control system. Such attachment characteristics may include the size/dimensions of the blade. As such, the control system of the work machine 10 may, based on the attachment characteristics of the blade and the data obtained from the sensors 58 of the work machine 10, determine the real-time orientation/angle/position of the blade. Such determined orientation/angle/position of the blade may then be graphically and/or textually displayed on the graphic display 50 of the work machine 10. Typical orientation/angle/position information of the blade that may be determined and presented on the graphic display 50 include: height of blade above the ground, depth of the blade below the ground, orientation/angle of the blade with respect to the ground, orientation/angle of the blade with respect to the work machine 10 (e.g., the work machine's frame 12 or cab 20), orientation/angle of the blade with respect to a central, vertical axis, etc. Although the above description illustrates how the orientation/angle/position of a blade may be determined and displayed by the work machine 10, it is understood orientations/angles/positions of other attachments 18 (e.g., pallet forks, bale spears, buckets, skid cutters, cold planers, augers, grapples, etc.) may similarly be determined and displayed.

In certain embodiments, the operator of the work machine 10 may enter instructions (e.g., via the graphic display 50) that the attachment 18 coupled with the work machine 10 should be orientated/located at a particular, preselected orientation/angle and/or position during operation. Such a particular preselected orientation/angle and/or position may be referred to as an “intended position.” In alternative embodiments, the intended position of a given attachment 18 may be automatically determined by the control system of the work machine 10 based on the attachment characteristics for the given attachment 18. Regardless, the control system of the work machine 10 may be configured to provide real-time feedback to the operator such that the operator (through manipulate of the work machine's 10 user controls 49) can maintain the intended position of the attachment 18. For instance, the control system of the work machine 10 may generate deviation information (i.e., information indicating how much the actual orientation/angle and/or position of the attachment 18 is currently deviating from the intended position and/or the preselected orientation/angle and/or position) and may present such deviation information to the operator of the work machine 10. The deviation information may be in the form of a visual alert (e.g., graphical information) presented on the graphic display 50 of the work machine 10, an audible alert generated via one or more speakers, and/or tactile feedback generated through one or more of the user controls 49 of the work machine 10. Thus, if the operator receives an alert that the attachment 18 is not properly orientated/angled and/or positioned, the operator may make the necessary adjustments such that the attachment can be maintained in the preselected orientation/angle and/or position. Alternatively, the control system of the work machine 10 may be configured to automatically adjust an actual position of the attachment 18 to match the intended position.

In certain embodiments, the sensors 58 of the work machine 10 may also include a position sensor, e.g., a GPS receiver, for providing an indication of the terrestrial or geographic position of the work machine 10. Such position sensor may be used by the operator to guide the work machine 10 and/or the attachment 18 to an intended location on the earth where work is to be performed. Such guidance may also be performed in an automated fashion, e.g., by the work machine's 10 control system controlling the drive motors 36 of the work machine 10 to position the work machine 10 in the intended location.

The above-described procedures for orientation/angle/position monitoring and control of an attachment 18 may also be used to monitor and/or maintain the levelness of an attachment 18. For example, certain attachments, such as pallet forks, bale spears, buckets, skid cutters, cold planers etc., may need to be maintained at specific angles (or generally level/parallel with the ground) during operation. The real-time orientation/angle and/or position data received by the work machine's 10 control system (e.g., received from the sensors 58 of the work machine 10) may be used to maintain such specific orientation/angle/position and/or levelness of the attachment 18. As was described above, the control system may provide information to be displayed on the graphic display 50, such that the operator of the work machine 10 can appropriately manipulate the user controls 49 to maintain the appropriate orientation/angle/position and/or levelness of the attachment 18. For example, the current orientation/angle/position of the attachment 18 may be presented on the graphic display 50 of the work machine 10, such that the operator may adjust the orientation/angle/position and/or levelness of the attachment 18 based on the indication presented on the graphic display 50.

Alternatively, the control system of the work machine 10 may automatically maintain the appropriate orientation/angle/position and/or levelness of the attachment 18 by controlling the necessary actuators 40,44,46 of the work machine 10. Furthermore, in some embodiments, the control system may generate an alert (e.g., audible, visual, or tactile) when the attachment 18 is not in the appropriate orientation/angle/position and/or does not have the appropriate levelness.

As an example of automated control, an attachment 18 in the form of a skid cutter may pose an unsafe hazard if the skid cutter is (i) oriented at an angle greater than 45 degrees (or other orientation/angle threshold) with respect to ground level, and/or (ii) raised more than 4 feet (or other height threshold) above the ground level. As such, the control system of the work machine 10 may determine the orientation/angle/position of the skid cutter (e.g., based on the attachment characteristics of the skid cutter and the data received from the sensors 58 of the work machine 10) and generate an alert if the skid cutter angle exceeds the orientation/angle threshold or the height threshold. Alternatively, or in addition, the control system of the work machine 10 may be configured to halt operation of the blades of the skid cutter if the skid cutter angle exceeds the orientation/angle threshold or the height threshold. For example, if the control system of the work machine 10 determines that the orientation/angle/position of the skid cutter (e.g., based on the attachment characteristics of the skid cutter and the data received from the sensors 58) exceeds the orientation/angle threshold or the height threshold, the control system may halt the flow of auxiliary hydraulic power from the auxiliary pump 32 to the skid cutter, such that the blades of the skid cutter will immediately stop rotating to prevent injury or damage. As such, the control system of the work machine 10 is configured to stop providing auxiliary hydraulic power to the attachment 18 if an actual position of the attachment 18 deviates from an intended position of the attachment 18.

In some cases, it may be preferable for the attachment 18 to be oriented/angled in general alignment with the ground level (e.g., so as to be parallel to and/or level with the ground as with the case the skid cutter discussed above). Embodiments provide for such attachments 18 to be maintained in levelness or in general alignment with the ground level based on the orientation/angle/position data received from the sensors 58, as well as based on the attachment characteristics of the attachments 18. Specifically, the operator may provide an indication as to when the orientation/angle of the attachment 18 is in proper alignment with the ground level. Such an indication may “zero out” the measured orientation/angle of the attachment 18. Thus, whenever the orientation/angle of the attachment 18 (as provided by the sensors 69 of the work machine 10) deviates from the zeroed-out position, the orientation/angle of the attachment 18 will not be in alignment with the ground level. As such, the operator may manually correct such deviation and/or the control system may automatically correct such deviation.

In addition to monitoring and maintaining the orientation/angle of an attachment 18, embodiments may be configured to monitor and maintain a position of such attachment 18. In some embodiments, such control may be based on dimensions of the attachment 18. As was described above, the attachment characteristics may include size/dimension data for the attachment 18, such as length, width, height, etc. Thus, the control system of the work machine 10 may be able to determine such dimensional data based on the ID information received from the Tag 60 of the attachment. Furthermore, during operation of the attachment 18, the work machine 10 may transmit the real-time orientation/angle and/or position data of the attachment 18 from the sensors 58 of the work machine 10, as was previously described. The control system may use the combination of the size/dimension data and the real-time orientation/angle and/or position data to determine spatial positioning of the attachment 18. For example, if the attachment 18 is a blade (e.g., box blade or dozer blade), the control system may be configured to determine a height of the blade above the ground level or the depth of the bucket below the ground level as the blade is used to move ground material.

The orientation/angle and/or position of the attachment 18 (e.g., the depth of the blade within the ground) may be presented to the operator via the graphic display 50 of the work machine 10, such as via a graphical representation of the attachment 18 within the ground. Alternatively, the orientation/angle and/or position of the attachment 18 may be shown numerically (e.g., a number of feet or inches below the ground). In further alternatives, the control system may use such orientation/angle and/or position information to maintain a required operating angle and/or position of the attachment 18. As was noted above, the orientation/angle and/or position of the attachment 18 may be based, in part, on the size/dimension data associated with the attachment 18. Use of such size/dimension data may be necessary, as different-sized attachments 18 will occupy different spatial volumes. Thus, a smaller blade being held at particular orientation/angle/position by the arms 16 of the work machine 10 may not be extending at the same depth below the ground as a larger blade being held at the same particular orientation/angle/position by the work machine's 10 arms 16. Although the above description illustrations how the orientation/angle and/or position information for the attachments 18 may be determined based on the sensors 58 of the work machine 10 (e.g., sensors associates with the arms 16 and/or the hitch plate 42 of the work machine 10), it should be understood that in some embodiments, the position sensors associated with the Tag 60 may transmit rea-time data to the control system of the work machine 10 to aid in determining the attachment's 18 orientation/angle/position.

The orientation/angle/position adjustments of the attachment 18 may, in some embodiments, be performed automatically by the work machine 10 via electronic over hydraulic (E over H) controls of the work machine 10. In some other embodiments, however, orientation/angle/position adjustments of the attachment 18 may be made by via a standard hydraulic control system or electronic control system. Regardless, if the standard hydraulic control system or electronic control system of the work machine 10 is not configured to automatically adjust the orientation/angle/position of an attachment 18, information related to the orientation/angle/position may nevertheless be presented to the operator of the work machine 10 (e.g., via the graphic display 50 of the work machine 10) so that the operator may manually make adjustment to the attachment's 10 orientation/angle/position. The following description provides some illustrations of information that may be displayed to the operator of the work machine 10 and/or functions that may be performed automatically by the work machine 10 using the attachment characteristics of the attachment 18 and data obtained from the sensors 58 of the work machine 10.

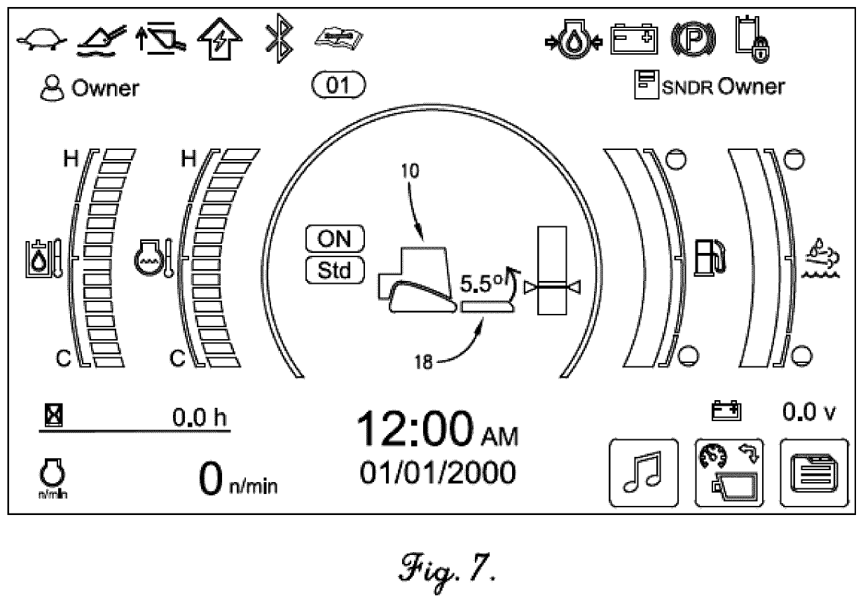

Beginning with an attachment 18 in the form of a skid cutter coupled with a work machine 10, data obtained from the sensors 58 of the work machine, as well as the attachment characteristics of the skid cutter, may be used to display a current orientation/angle/position of the skid cutter as illustrated in the graphical user interface (GUI) of FIG. 7, which may be presented on a graphic display 50 of the work machine 10. Although the below description is related to an attachment 18 in the form of a skid cutter, it should be understood that the GUI may illustrate similar information for other types of attachments 18. As shown, the GUI may present graphical representations of the work machine 10, as well as the skid cutter (see, e.g., a central portion of the GUI). The GUI may present the current orientation/angle of the skid cutter with respect to the ground. Such an indication of the orientation/angle of the skid cutter may be numerical in form or may be presented by showing a graphical representation of the skid cutter being oriented/angled at the real-time orientation/angle of the actual skid cutter. The GUI may also display a height indicator (e.g., the column-shaped, vertical fill bar) that illustrates the real-time height of the actual skid cutter above the ground.

In some embodiments, the GUI may provide an indication as to when the orientation/angle of the skid cutter is an appropriate operational orientation/angle or is not an appropriate operational orientation/angle. For example, if the real-time orientation/angle of the actual skid cutter exceeds the orientation/angle threshold described above (or is higher than the height threshold discussed above), the GUI may present an alert, such as by coloring the graphical representation of the skid cutter in a particular color (e.g., red). In contrast, if the real-time orientation/angle of the actual skid cutter is within the orientation/angle threshold described above (or is lower than the height threshold discussed above), the GUI may color the graphical representation of the skid cutter in a different color (e.g., white). Thus, the operator of the work machine 10 and the attached skid cutter can determine if the skid cutter is positioned at the appropriate operational orientation/angle or position based on the color of the graphical representation presented by the GUI. Alternatively, another type of visual, audible, or tactile alert may be generated when the real-time orientation/angle or position of the actual skid cutter exceeds the threshold angle and/or height.

In addition to presenting information via the GUI on the graphic display 50, the work machine 10 may be configured to automatically control various aspects of the work machine 10 and/or the skid cutter on data from the sensors 58 of the work machine 10 and/or the attachment characteristics of the skid cutter. For instance, the work machine 10 may automatically prevent the skid cutter from being raised above a height that exceeds the threshold height or from being positioned at an orientation/angle that exceeds the threshold angle. Alternatively, or in addition, the work machine 10 may automatically shut off the auxiliary hydraulic fluid flow to the skid cutter when the skid cutter is raised above the threshold height or is orientated/angled at an orientation/angle that exceeds the threshold angle. Similarly, if the operator attempts to provide auxiliary hydraulic fluid flow to the skid cutter when the skid cutter is raised above the threshold height or is orientated/angled at an orientation/angle that exceeds the threshold angle, the work machine 10 may automatically prevent such auxiliary hydraulic fluid flow from being provided to the skid cutter to prevent damage or injury. Alternatively, or in addition, the work machine 10 may automatically position the skid cutter at particular operating positions (e.g., horizontal or level with ground surface). The work machine 10 may also be configured to automatically change the position of the skid cutter from an operating position to a travel position, when instructed by the operator. The travel position of the skid cutter may be higher and/or at a different orientation/angle than the operating position, so as to facilitate efficient transport of the work machine 10 and the skid cutter. When in the transport position, the work machine 10 may be restricted from providing auxiliary hydraulic power to the skid cutter to prevent the blades from inadvertently spinning.

As noted above, FIG. 7 also illustrates a graphical element in the form of a vertical fill bar positioned immediately to the right of the graphical representation of the work machine 10 and the attachment 18. The fill bar can be used to provide an indication of the current position (e.g., the height) of the attachment 18, as well as a range of possible positions from least to greatest (e.g., the lifting range of the attachment 18 by the work machine 10). As such, the fill bar can simultaneously show the available position range (e.g., height range) for a given attachment 18, as well as the actual, real-time position (e.g., height) of the attachment 18. The actual, real-time position (e.g., height) of the attachment 18 can be illustrated via arrows that can travel up and down the fill bar according to the actual, real-time position (e.g., height) of the attachment 18. The available position range (e.g., height range) for a given attachment 18 may be included as part of the attachment characteristics for the given attachment 18, as has been previously described. Thus, the available position range may be stored in memory elements 54 of the control system of the work machine 10.

Such attachment characteristics may, in some embodiments, be provided to the work machine 10 by the Tag 60 via wireless signal, as previously described. The current, real-time position of the attachment 18 may be determined from signals obtained from sensors 58 of the work machine 10 (e.g., arm 16 position/angle sensor or differential between arm 16 position/angle sensor and position/angle sensor on frame 12 of the work machine 10). The control system of the work machine 10 is configured to, in some embodiments, reduce the flow of auxiliary hydraulic fluid to the attachment 18 if the actual, real-time position of the attachment 18 approaches a position bordering with a deviation position (i.e., the difference between the intended position of the attachment 18 and the actual, real-time position of the attachment 18). Alternatively, the control system of the work machine 10 is configured to reduce operation speed of the loader arms 16 if the position of the attachment 18 approaches a position bordering with a deviation position (i.e., the difference between the intended position of the attachment 18 and the actual, real-time position of the attachment 18).

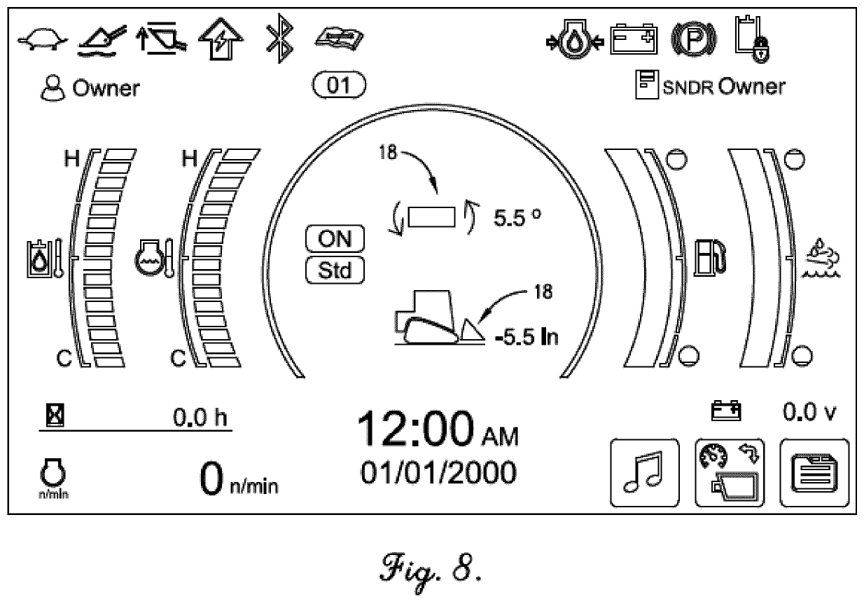

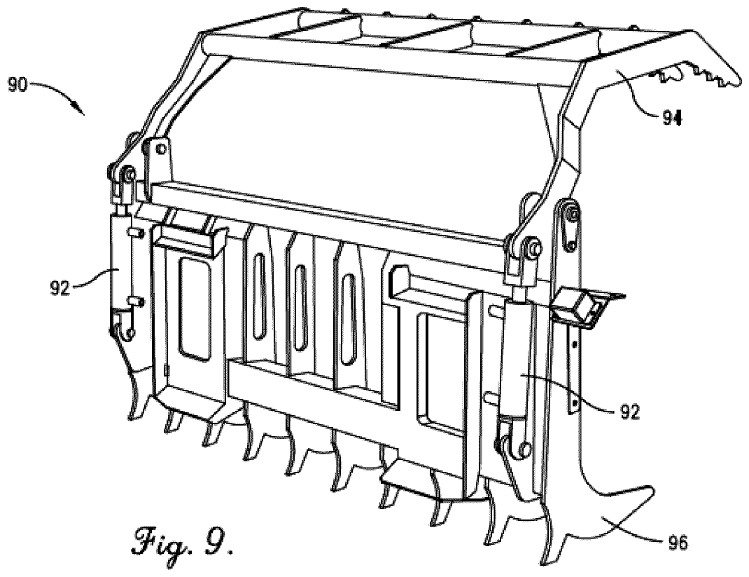

Turning to attachments 18 in the form of buckets or blades (e.g., dozer blades and box blades) and pallet forks, data obtained from the sensors 58 of the work machine 10, as well as the attachment characteristics of the attachments 18, may be used to display a current orientation/angle/position of the attachments 18 on the graphic display 50 of the work machine 10, as illustrated in GUI of FIG. 8. Although the description below is generally applicable to dozer blades, it is similarly applicable to box blades and pallet forks, as well as buckets. As shown, the GUI may present graphical representations of the work machine 10 and the blade/bucket (see, e.g., a central portion of the GUI). GUI may present the current orientation/angle of the bucket with respect to the ground. The orientation/angle may include each of the tilt angle (e.g., the forward/rearward orientation/angle of the blade/bucket with respect to the ground or the horizontal), the yaw angle (e.g., the forward/rearward orientation/angle of the blade/bucket with respect to the frame 12 of the work machine 10), and the roll angle (e.g., the leftward/rightward orientation/angle of the blade/bucket with respect to the ground or horizontal). Such orientation/angle indications may be numerical or may be presented by showing the graphical representation of the blade/bucket being oriented/angled at the current orientation/angle. In some embodiments, the GUI may also present information indicative of the real-time height of the blade/bucket above or below the ground.

In some embodiments, the GUI may provide an indication as to when the orientation/angle of the actual blade/bucket is appropriate or not. For example, if the real-time orientation/angle of the blade/bucket is different from the preferred orientation/angle, the GUI may color the graphical representation of the blade/bucket in a particular color (e.g., red). In contrast, if the real-time orientation/angle of the blade/bucket is at (or within a suitable range from) the preferred orientation/angle, the GUI may color the graphical representation of the blade in another color (e.g., white). Thus, the operator can determine if the blade/bucket is positioned at the appropriate orientation/angle or position based on the color of the graphical representation presented by GUI. Alternatively, a visual, audible, or tactile alert may be generated when the current orientation/angle or position of the blade/bucket is not consistent with the preferred orientation/angle.

In addition to presenting information via the GUI on the graphic display 50, the work machine 10 may be configured to automatically control various aspects of the work machine 10 and/or the blade/bucket based on data from the sensors 58 of the work machine 10 and/or the attachment characteristics of the blade/bucket. For instance, the work machine 10 may automatically position and maintain the blade/bucket at an intended orientation/angle, such that the blade/bucket can, for example, be used to form the ground into a flat area. In some embodiments, the work machine 10 may be configured to maintain the blade/bucket at the preferred orientation/angle even if the work machine 10 is travelling over undulating terrain.

In general, the control system of the work machine 10 may be configured to automatically control the position of an attachment 18 by controlling actuators associated with the work machine 10. Such actuators may include the hydraulic cylinders 40,44,46 associated with the loader arms 16 and/or the hitch plate 42 of the work machine 10.

### Grapple Control

In addition to the attachments 18 described above, certain embodiments of the present invention contemplate the work machine 10 being used with an attachment 18 in the form of a grapple 90 or grapple bucket, as illustrated in FIG. 9, which can be used to grab and carry large objects (e.g., tree limbs or logs). As illustrated, such grapples 90 may include one or more nail cylinders 92 that are used to actuate first portion 94 of the grapple 90 into and out of engagement with a second portion 96 of the grapple 90. Such nail cylinders 92 may comprise hydraulic cylinders with a rod extendible from and retractable into a barrel. The nail cylinders 92 being powered via auxiliary hydraulic fluid flow from the work machine's 10 auxiliary pump 32. When an operator intends to grab an object with the grapple 90, the operator will instruct the work machine 10 to send auxiliary hydraulic fluid flow (e.g., by selecting an AUX control element of the user controls 49, which may be positioned within the cab 20 of the work machine 10) at a grabbing pressure (e.g., 22 MPa) from the auxiliary pump 32 of the work machine 10 to the nail cylinders 92 of the grapple 90, such that the first portion 94 of the grapple 90 actuates toward the second portion 96 of the grapple 90 until the object is compressed between the two portions 94,96 of the grapple 90. As a result, the grapple 90 will be holding onto the object, and the work machine 10 and/or grapple 90 can carry the object to an intended location where it can be released. It should be understood that the AUX control element may be a button, switch, roller, or other element on a joystick within the cab 20. Alternatively, or in addition, the AUX control element may be a graphical icon presented on a GUI of the graphic display 50.

Unfortunately, the hydraulic pressure provided to the nail cylinders 92 by the work machine 10's auxiliary pump 32 will often decrease during operation of the grapple 90. Such a decrease in hydraulic pressure may be the result of standard pressure/flow bleed off through the hydraulic system. As a result, the pressure provided to the nail cylinders 92 may fall below the required grabbing pressure, which can result in the object being inadvertently dropped from the grapple 90. Embodiments of the present invention overcome such an issue by the control system of the work machine 10 continually monitoring the hydraulic pressure provided to the nail cylinders 92 (e.g., via sensors 58 of the work machine 10 in the form of pressure sensors associated with the hydraulic system of the work machine 10 and/or with the hydraulic components of the grapple 90). For example, the pressure sensors may be associated with the auxiliary pump 32, with the hydraulic valves or lines interconnecting the auxiliary pump 32 and the grapple 90, and/or with the nail cylinders 92 of the grapple 90. If the hydraulic pressure falls below the grabbing pressure (or falls more than a predefined amount below the grabbing pressure), the control system of the work machine 10 can automatically increase the pressure of the auxiliary hydraulic fluid flowing to the nail cylinders 92 of the grapple 90 until the grabbing pressure is again maintained. For example, if the grabbing pressure is 22 MPa, the predefined amount may be 4 MPa, such that if the actual hydraulic pressure being provided to the grapple 90 falls below 18 MPa, the control system may automatically increase the hydraulic pressure back to 22 MPa.

The work machine 10 is also particularly configured to determine whether or not the grapple 90 is being used to grab an object. If the grapple 90 is being used to grab an object, then the grabbing pressure should be maintained during the extent of the grabbing of the object. In contrast, if the grapple 90 is not being used to grab an object, then the grabbing pressure does not necessarily need to be maintained. For example, if the grapple 90 is simply being actuated to a closed position without grabbing an object, then the grabbing pressure of the nail cylinders 92 may not need to be maintained at the grabbing pressure.

To distinguish as to whether the grapple 90 is grabbing an object or simply closing (without grabbing an object), the control system of the work machine 10 may monitor the AUX control element within the cab 20 via position sensors, electronic sensor, or the like. If the operator of the work machine 10 activates the AUX control element for more than a minimum, predefined amount of time (e.g., more than 2 seconds), it is likely that the operator is using the grapple to hold onto an object, in which case the control system of the work machine 10 will automatically maintain the pressure provided to the nail cylinders 92 of the grapple 90 at the grabbing pressure. Contrastingly, if the position sensors determine that the operator of the work machine 10 is not continually activating the AUX control element, it is likely that the operator is not using the grapple 90 to hold onto an object, in which case the work machine 10 is not required to maintain the pressure provided to the nail cylinders 92 of the grapple 90 at the grabbing pressure.

Similarly, if the nail cylinders 92 of the grapple 90 are at their maximum or minimum strokes (e.g., as determined by stroke sensors or angle sensors associated with the nail cylinders 92 of the grapple 90), then the control system of the work machine 10 may determine that the grapple 90 is simply being closed on itself (with the first and second portions 94, 96 in contact with each other and not holding an object). In such case, the control system of the work machine 10 would not be required to maintain the hydraulic pressure provided to the nail cylinders 92 at the grabbing pressure. In contrast, if the nail cylinders 92 are between their maximum and minimum strokes, then the control system of the work machine 10 may determine that the grapples 90 is being closed around an object, such that the control system of the work machine 10 will maintain the hydraulic pressure provided to the nail cylinders 92 at the grabbing pressure.

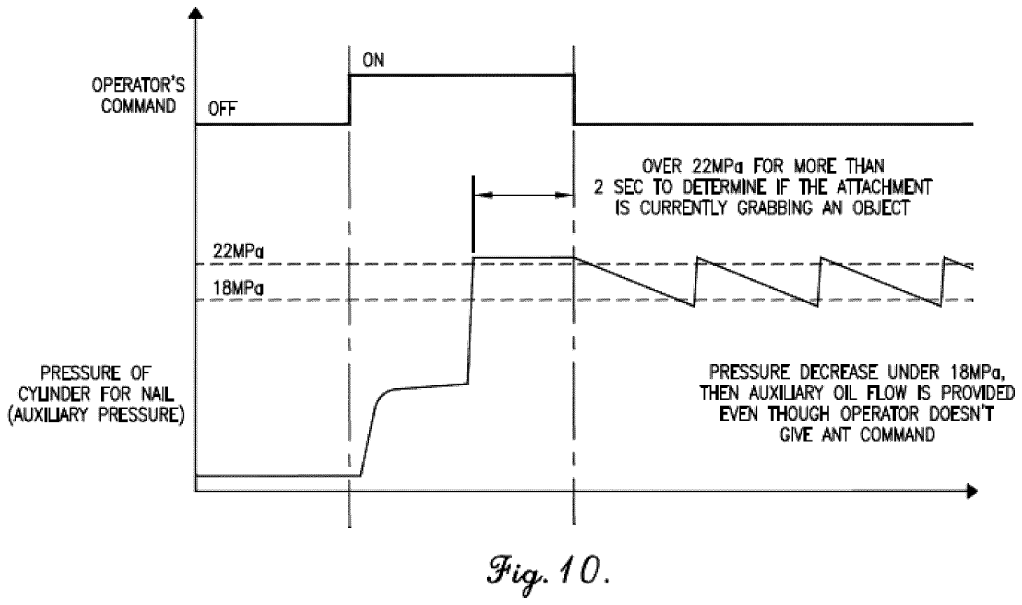

As discussed in the preceding paragraphs, the control system of the work machine 10 may monitor the AUX control element within the cab 20. If the operator of the work machine 10 activates the AUX control element for more than a minimum, predefined amount of time (e.g., more than 2 seconds), it is likely that the operator is using the grapple 90 to hold onto an object, in which case the control system work machine will automatically maintain the pressure provided to the nail cylinders 92 at the grabbing pressure. In certain embodiments, such as illustrated in FIG. 10, the control system of the work machine 10 may be configured to maintain the nail cylinders 92 at the grabbing pressure even if the operator releases or deactivates the AUX control element (after initially activating the AUX control element for the minimum amount of time). Specifically, if after the operator has activated the AUX control element for the minimum, predefined amount of time (e.g., 2 seconds), the pressure to the nail cylinder drops below 18 MPa, the control system of the work machine 10 may automatically increase the pressure to the nail cylinders 92 to back to the grabbing pressure regardless of whether the operator is currently activating the AUX control element so as to ensure that the grapple's 90 nail cylinders 92 maintain the grabbing pressure necessary to hold on to the object. As explicitly illustrated by FIG. 10, anytime the pressure to the nail cylinders 92 drops below 18 MPa, the control system of the work machine 10 may automatically increase the pressure to the nail cylinders to 22 MPa.

The control system of the work machine 10 may be configured to determine information related to the nail cylinders 92 of the grapple 90 based on the attachment characteristics of the grapple 90. As previously described, such attachment characteristics may be stored in the work machine's 10 control system and can be determined by the control system based on the ID information transmitted by the grapple's 90 Tag 60. Alternatively, such attachment characteristics may be transmitted to the work machine 10 by the Tag 60 of the grapple 90. Regardless, such attachment characteristics may include size and pressure information related to the nail cylinders 92, as well as stroke length of the cylinder rods of the nail cylinders 92.

Upon completion of the necessary operations, the operator can decouple the attachment 18 (e.g., the grapple 90) from the work machine 10. In certain embodiments, the work machine 10 may generate a confirmation request, asking the operator (e.g., via the graphic display 50) if the operator intends to decouple the attachment 18. If the operator confirms the intended decoupling, the decoupling may be completed (e.g., via an automated decoupling process performed by the hydraulic quick-attachment mechanism of the hitch plate 42). If the operator rejects the decoupling, the attachment 18 may remain coupled with the work machine 10. In some embodiments, such confirmation request may be automatically generated by the control system upon the operating activating a user control 49 indicating an intent to initiate the decoupling process.

In general, when using an attachment 18 with a cylinder (e.g., the grapple 90) and applying a pressure to the cylinder, the hydraulic system of the work machine 10 may lose pressure over time as a result of leakage in the work machine's 10 control valve. Because a pressure sensor can be added to the hydraulic system to monitor the pressure provided from the auxiliary pump 32 to the attachment 18, the control system of the work machine 10 can now determine if the attachment's 18 cylinder is losing pressure and if so, have the work machine 10 automatically increase the pressure. Currently, this has to be done by the operator, but the present inventive concept allows the control system of the work machine 10 to perform such functions automatically. Such an inventive concept can be applied to grapples, grapple buckets, dozer blades, angle brooms, tilt hitches, etc.

An additional option to prevent the loss of pressure to an attachment's 18 cylinder is to add a counterbalance valve to the attachment 18. However, the counterbalance valve is expensive and the present inventive concept can eliminate the need for such a counterbalance valve. For example, using the pressure sensor of embodiments of the present invention, the control system of the work machine 10 can calculate or otherwise recognizes a 10%, 30% or 20% loss in pressure to an attachment 18, and then automatically increase the pressure to the necessary amount.

As an additional embodiment of the present invention, oil leakage in the control valves of the work machine 10 (e.g., for the cylinders 40 of the loader arms 16 and/or for the cylinders 44,46 of the hitch plate 42) allows the cylinders 40,44,46 to change length over time. Sensors 58 in the form of position or angle sensors can be added to the arms 16 and/or the hitch plate 42 to determine the angle of each. The control system of the work machine 10 can evaluate the involuntary change in length of the cylinder 40,44,46 based on the position/angle of the arms 16 and/or hitch plate 42 (e.g., via position/angle sensor associated with the arms 16 and/or hitch plate 42) and automatically add or remove hydraulic oil from the respective cylinder 40,44,46 to maintain a desired position. This embodiment may, for example, be incorporated with any attachment 18 used for grading or maintaining a height such as a bucket, grading scraper, dozer blade, box blade, trencher, etc.

### Tag Retrofit Kit

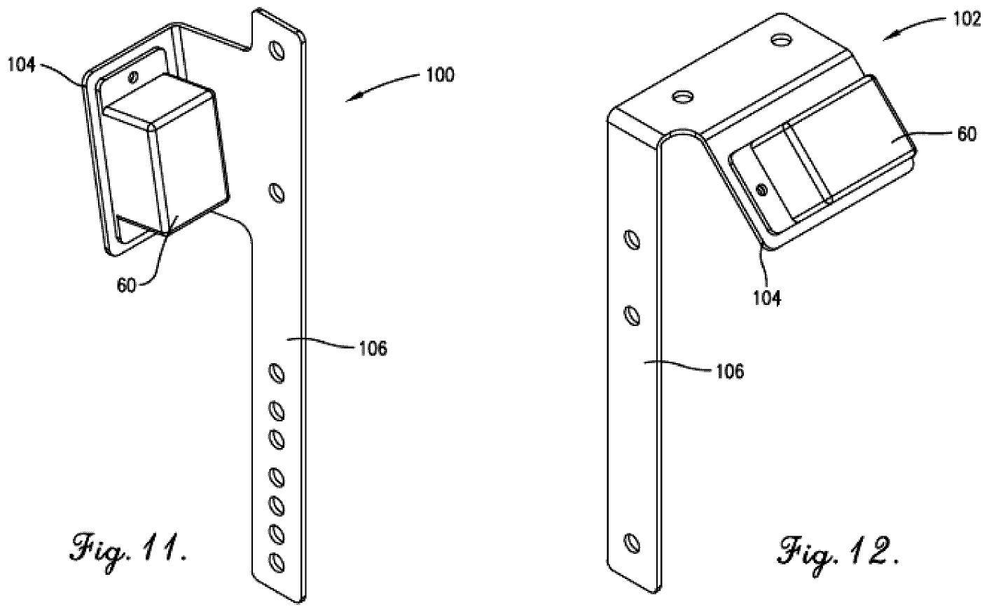

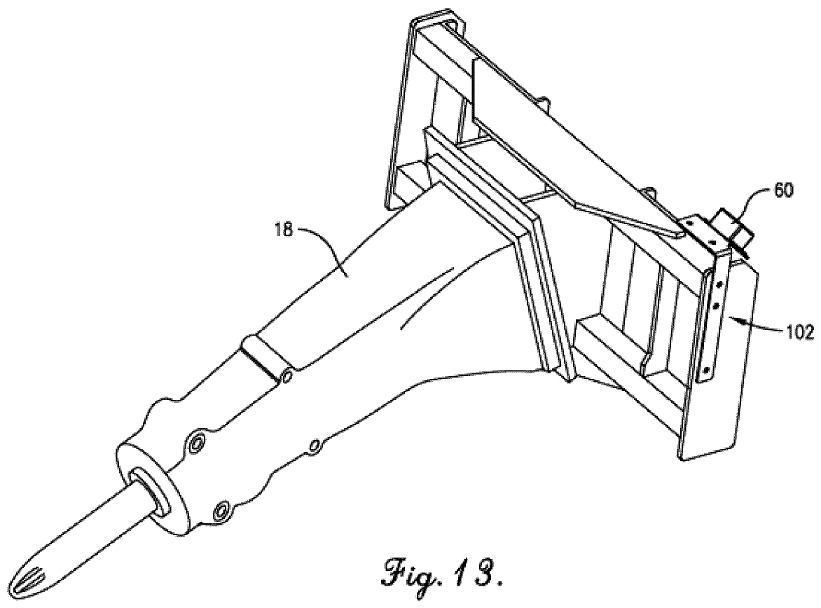

It is common that work machines 10 and attachments 18 may be initially provided by manufacturers without, respectively, wireless transceivers 67 or Tags 60. As such, certain embodiments of the present invention may include a kit or assembly of multiple components that may be used to modify work machines 10 and attachments 18 to operably include wireless transceivers 67 and Tags 60 that can provide the functionalities described herein. In some embodiments, such a kit may comprise a (i) a wireless transceiver 67 configured to be secured to a work machine 10 (see, e.g., FIG. 1), (ii) a Tag 60 configured to be secured to an attachment 18 (see, e.g., FIG. 1), and (iii) a bracket 100,102 (see, e.g., FIGS. 11 and 12) configured to secure a Tag 60 to the attachment 18 (see, e.g., FIG. 13) in a manner that facilitates efficient communication between the Tag 60 and the wireless transceiver 67 secured to the work machine 10. In some cases, a work machine 10 may already comprise a wireless transceiver 67, in which case the kit may only include the Tag 60 and associated bracket 100 for securing the Tag 60 to the particular attachment 18.

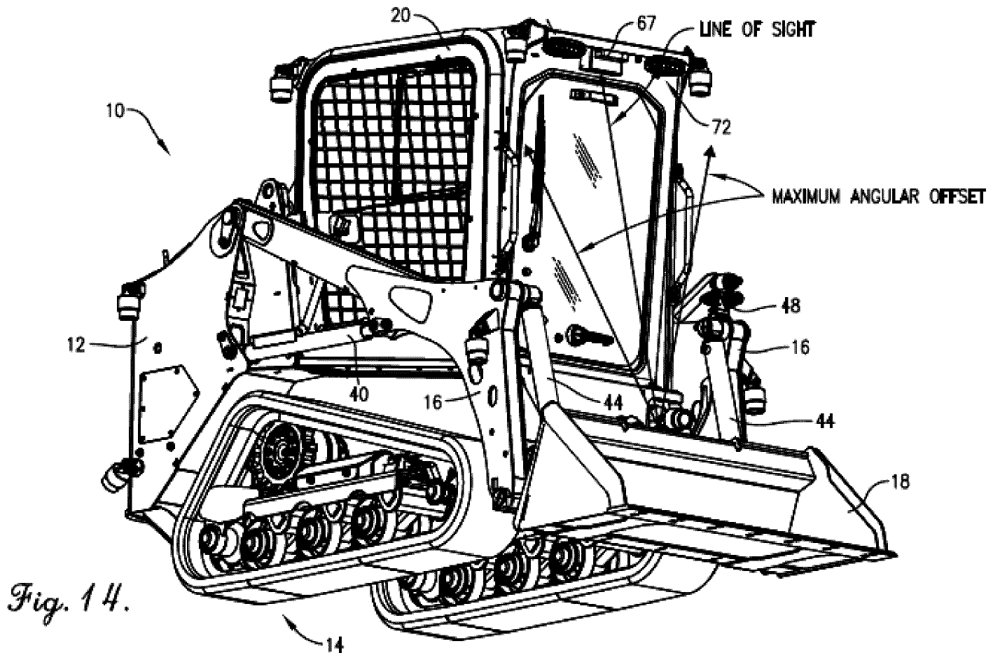

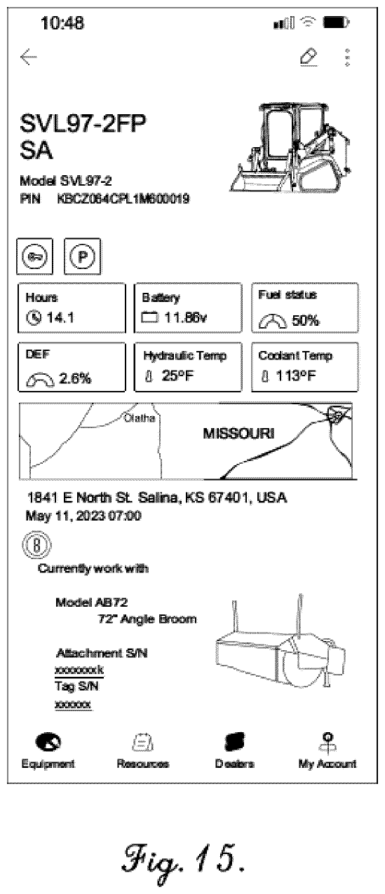

As noted above, FIG. 1 illustrates a Tag 60 coupled with an attachment 18 in the form of a bucket, and a work machine 10 in the form of a CTL with a wireless transceiver 67. The wireless transceiver 67 is positioned on the front of the cab 20, adjacent to the roof (or attached to the roof). The Tag 60 is positioned on the back side of the bucket so that when the attachment 18 is connected with the work machine 10 (e.g., FIG. 14), the wireless transceiver 66 inside the Tag 60 is directed rearward and upward, toward the wireless transceiver 67 of the work machine 10. Although FIGS. 1 and 14 illustrate the Tag 60 being directly coupled with the attachment 18, other embodiments provide for Tags 60 to be coupled with attachments 18 via the bracket 100, 102 so that the Tag 60 can be properly aligned with the wireless transceiver 67 of the work machine 10. For example, FIG. 13 illustrates a Tag 60 being indirectly coupled with an attachment 18 in the form of an impact breaker via bracket 102 via a bracket 102.

Regardless of whether the Tag 60 is directly or indirectly coupled with an attachment 18, embodiments of the present invention provide for the Tag 60 associated with the attachment 18 to be orientated such that the propagation direction of the wireless signals transmitted by the Tag's 60 wireless transceiver 66 are offset by no more than a maximum angular offset from the direct line of sight between the Tag 60 and the wireless transceiver 67 of the work machine 10 (see, e.g., FIG. 14). It is noted that the line of sight is the straight-line direction from the Tag 60 to the wireless transceiver 67 of the work machine 10. In general, when the attachment 18 is in the lowered position (i.e., the lift arms 16 of the work machine 10 have the attachment 18 lowered adjacent to the ground), the line of sight will extend upward, and rearward from the Tag 60 to the wireless transceiver 67 of the work machine, as shown in FIG. 14.

As such, the wireless propagation direction is defined as the direction in which the wireless transceiver 66 of the Tag 60 is aimed and emits wireless radio signals. In some embodiments, the maximum angular offset between the wireless propagation direction of the wireless transceiver 66 and the line of sight between the Tag 60 and the wireless transceiver 67 of the work machine 10 is no more than 30 degrees, no more than 25 degrees, no more than 20 degrees, or no more than 15 degrees and/or from 0 to 30 degrees, from 5 to 30, from 10 to 30 degrees, from 0 to 25 degrees, from 5 to 25 degrees, from 10 to 25 degrees, from 0 to 20 degrees, from 5 to 20 degrees, from 10 to 20 degrees, from 0 to 15 degrees, from 5 to 15 degrees, or from 10 to 15 degrees. Such a positioning and orientation of the Tag 60 (i.e., such that the propagation signals transmitted by the Tag's 60 wireless transceiver 66 are offset by nor more than the maximum angular offset from the line of sight) is determined when the attachment 18 is in a lowered position (i.e., with the loader arms 16 of the work machine 10 in the lowered position) and untilted (i.e., the hitch plate 42 of the work machine 10 is not tilting the attachment 18 forward or rearward).

In some embodiments, as illustrated in FIGS. 11 and 12, the brackets 100, 102 may each comprise a mounting platform 104 on which a Tag 60 may be mounted and a support arm 106 that is configured to connect with an attachment. The support arm 106 may be elongated with a first end to which the mounting platform is connected and a second end configured for connection with the attachment 18.

The Tag 60 may be held in place on the mounting platform 104 via threaded fasteners. As noted, in some embodiments, the support arm 106 may be elongated, to allow the bracket 100,102 to be positioned in configurations on the attachment 18. The support arm 106 may include a plurality of through holes along its length, with such through holes configured to receive threaded fasters to secure the bracket 100,102 (and thus the Tag 60) to the attachment 18. The length of the support arm 106 allows the mounting platform 104 to be positioned at various locations with respect to the attachment 18, such that the wireless transceiver 66 of the Tag 60 can be directed into proper alignment with the wireless transceiver 67 of the work machine 10 (as discussed above). Additionally, the mounting platform 104 may have a specific orientation so as to aim the wireless transceiver 66 of the Tag 60 into proper alignment with the wireless transceiver 67 of the work machine 10 (as discussed above). For instance, the mounting platform 104 may be oriented at an angle with respect to the support arm 106. Such an angle may be from 0 to 75 degrees, from 15 to 60 degrees, or from 20 to 45 degrees.

In view of the above, the brackets 100,102 allow Tags 60 to be secured to various types of attachments 18, yet be maintained in proper alignment for communication with the wireless transceiver 67 of the work machine 10. Such proper alignment may be facilitated by the length of the support arm 106 and the angle of the mounting platform 104 with respect to the support arm 106. Furthermore, it should be noted that the support arm 106 can be mounted to an attachment in various positions, such as upright/vertical, horizontal, or at an angle between upright and horizontal. In general, however, the brackets 100, 102 are configured to aim the wireless transceiver 66 of the Tag 60 (when the attachment 18 in in a lowered position) in an upward, rearward direction towards the wireless transceiver 67 of the work machine 10, with the wireless transceiver 67 being attached to the front of the cab 20 of the work machine 10 adjacent to the roof.

Although FIG. 13 illustrates a bracket 102 being used to secure a Tag 60 an attachment 18 in the form of an impact breaker, it should be understood that the brackets 100, 102 may be used to attach Tags 60 to generally any type of attachment 18 discussed herein, with such Tags 60 being attached in appropriate alignment with the wireless transceiver 67 of the work machines (see, e.g., FIG. 14). Stated differently, the shape of the brackets 100, 102 facilitate the ability of the brackets 100,102 to be attached to various different types of attachments 18 while maintaining the ability of the Tags 60 to be aimed towards the wireless transceiver 67 of the work machine 10 for efficient communication.

As previously described, the Tag 60 is configured to generate information and parameters via sensors 69 within the Tag 60. Such information and parameters may be recorded and transmitted to the mobile device 70 for display and analysis (e.g., via a mobile app operating on the mobile device 70) and/or to the control system of the work machine 10. The information and parameters may include acceleration data of the Tag 60, as obtained by accelerometers and/or IMUs. In certain embodiments, the mobile device 70 may be configured to set an acceleration threshold for the Tag 60. The acceleration threshold may be predetermined according to a type of attachment 18 or model of attachment 18. Such acceleration threshold may also be stored in the remote device 80 (e.g., the cloud). In some embodiments, the predetermined acceleration threshold is smaller if the Tag 60 is configured to be installed on the attachment 18, via the bracket 100,102, at a location far from a hitch pivoting center of the attachment 18 and work machine 10 (e.g., the hitch plate 42). In contrast, the predetermined acceleration threshold is larger if the Tag 60 is installed, via the bracket 100, 102, close to the hitch pivoting center. In certain embodiments, the work machine 10 and/or the mobile device 70 is configured to determine which attachment 18 is connected to the work machine 10 based on the acceleration data of the Tag 60, particularly if such acceleration data matches the predefined acceleration threshold for an attachment 18.

### Telematics and Mobile App

In addition to communicating with work machines 10, the Tags 60 associated with attachments 18 may also communicate with the cloud and/or with mobile apps. All of the data described herein, which is transmitted between the attachments 18 and the work machines 10 may also be transmitted to the cloud (e.g., a remote computing device 80) or to the mobile device 70 (or to other computing devices). Such transmission may be conducted, for example, via the mobile app, web app, or other electronic resource. For example, any data generated or collected by the Tags 60 may be provided to the cloud or mobile device 70 (or to other computing devices). Data generated by the work machines 10 may also be transmitted to the cloud and/or to the mobile device 70 (or other computing devices). As such, the mobile device 70 of a user may access various information related to attachments 18 and/or to work machines 10 that the user has permission to access. Exemplary data that may be transmitted from the Tags 60 or the work machine 10 to the cloud or mobile app 70 may be geographical position data (e.g., as generated by GPS receivers within the Tags 60) of the attachments 18 and the work machine 10 (e.g., as generated by GPS receivers within the Tags 60 and/or within the control systems of the work machines 10). As such, a user may, via the cloud or mobile device 70, may determine the real-time location, historical location information, and historical usage information of the attachments 18 and/or work machines 10 owned and/or authorized for use by the user. Exemplary GUIs that may be presented on a graphic display 78 of a user's mobile device 70, e.g., through use of a mobile app, are shown in FIGS. 15-17, with such GUIs configured to provide data related to attachments 18 and/or work machines 10 to a user.

For example, FIG. 15 illustrates a GUI presented on a graphic display 78 of a user's mobile device 70. Such a GUI may be generated by the mobile app previously discussed. The mobile app may allow the user to select any of the user's one or more work machines (e.g., the SVL97-2FP) that are registered to the user in the mobile app. Once the appropriate work machine 10 is selected, the mobile app may display various information related to the work machine 10, including: model number, PIN, total hours used, hours used since last maintenance, current battery status (e.g., voltage), current fuel level, diesel-exhaust fluid level, hydraulic fluid temperature, coolant temperature, etc. In addition, an image or drawing (or other information) indicative of the attachment 18 currently coupled with the work machine 10 may also be displayed. For example, the GUI of FIG. 15 illustrates that the work machine 10 is currently coupled with an attachment 18 in the form of an angle broom. Furthermore, in some embodiments, various work machine 10 information may also be provided. The work machine information may be obtained by sensors 58 associated with the work machine 10 and provided to the mobile device 70 (e.g., via the mobile app) in real-time. The work machine 10 may also provide such information to the remote device 80 (e.g., the cloud). As a result, the user can immediately review the status of the work machine 10 even if the work machine 10 is being operated remotely by another operator. Examples of work machine information include the number of hours the work machine has been used, the battery charge of the work machine, the fuel status of the work machine, the hydraulic temperature of the work machine, the engine coolant temperature of the work machine, and/or diesel exhaust fluid (DEF) levels of the work machine.

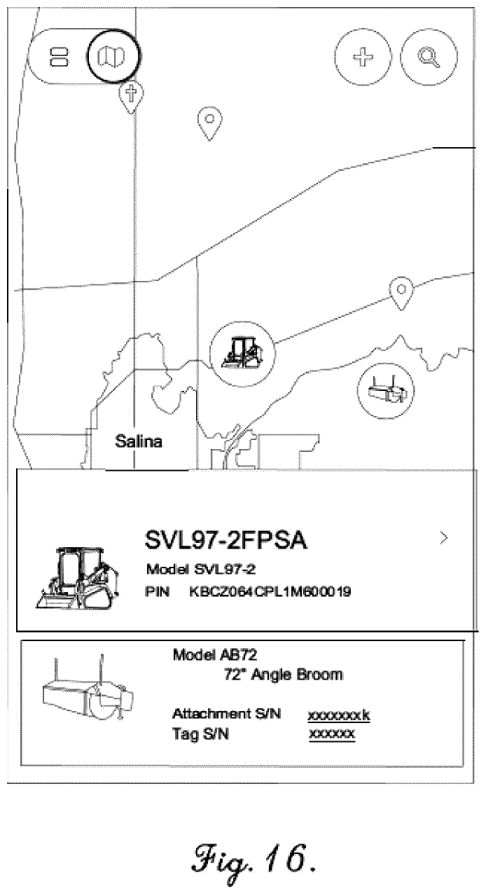

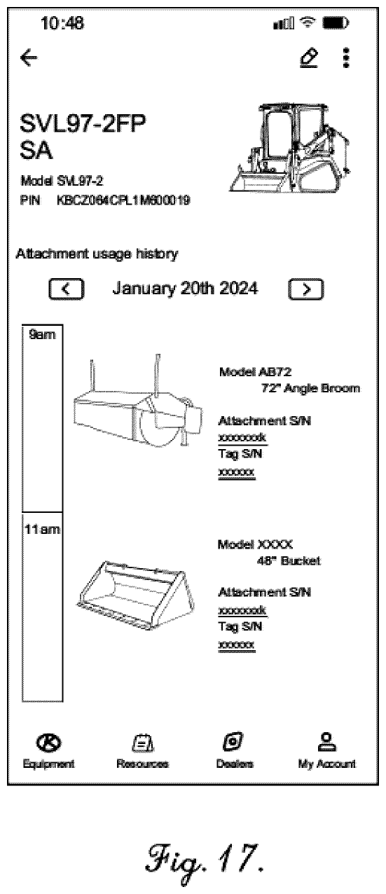

The mobile app on the mobile device 70 may also be configured to display, via the GUI, the current location of the work machine 10, as determined from position sensors of the sensors 58 of the work machine 10, as previously described. Such location information may be provided textually (e.g., via a mailing address, latitude/longitude, etc.) and/or may be shown graphically via a location icon of the work machine 10 presented on a map. Such location information may be updated in real time from the sensors 58 of the work machine 10. The work machine 10 may also provide such information directly to the mobile device 70 (via the mobile app) and/or to the remote device 80 (e.g., the cloud). Similar location information may be provided for all attachments 18 associated with the user. Thus, the location information may be provided for an attachment 18 that is currently coupled with a work machine 10, as well as attachments 18 that are not currently coupled with a work machine 10. Such location information may be obtained from the position sensors of the sensors 69 of the Tags 60, which are associated with the attachments 18. The location information may be updated in real time and presented on the GUI similar to how the location of the work machine 10 is presented in FIG. 16. The Tags 60 may provide such information directly to the mobile device 70 (via the mobile app) and/or to the remote device 80 (e.g., the cloud), or the Tags 60 may provide such information to the work machine 10 that may itself provide such information directly to the mobile device 70 (via the mobile app) and/or to the remote device 80 (e.g., the cloud).

In more detail, illustrated in FIG. 16, the mobile app of the mobile device 70 may be configured to display, via the GUI, the location of a given work machine and the current attachment 18 associated with the work machine 10. If the attachment 18 is physically coupled with the work machine 10, then the attachment 18 and work machine 10 may be illustrated in the same location on a map. If the attachment 18 is not physically coupled with the work machine 10, the current location of each of the work machine 10 and the attachment 18 may be presented on the GUI. The determination of the particular attachment 18 associated with the work machine 10 may be made once the attachment 18 has been physically coupled with the work machine 10, and the attachment's 18 Tag 60 transmits the ID information from the Tag 60 to the work machine 10. Such pairing of information (identifying the paired attachment 18 and work machine 10) may be transmitted by the Tag 60 and/or the work machine 10 to the mobile app (e.g., via the mobile device 70) or to the cloud, such that the user can review the information. The pairing of the attachment 18 and work machine 10 may be retained (even if the attachment 18 is physically de-coupled from the work machine 10) until a new attachment 18 is physically coupled with the work machine 10. Regardless, the mobile app may be configured to display, via the GUI, various specific information related to the attachment 18 that is paired with the work machine 10, such as: attachment name, attachment description, model number, serial number, ID information of the attachment, Tag serial number, etc. In addition, an image or drawing of the attachment may also be displayed.

Displaying the geographic locations of attachments 18 which are not coupled with a work machine 10 (e.g., which are in storage) may also be presented on the GUI. The locations of uncoupled attachments 18 may be determined by location information of the work machine 10 and based on location information from the Tag 60 of the attachment 18 when the attachment 18 was removed from the work machine 10. The work machine 10 may repeatedly send location signals to the mobile device 70 (e.g., via the mobile app) and/or to the remote device 80 (e.g., the cloud) regardless of whether the work machine 10 is currently coupled with an attachment 18. In some embodiments, the work machine 10 may be configured to determine whether an attachment 18 is coupled to the work machine 10 or removed from the work machine 10 based on pin position of the hitch plate 42 of the work machine 10.

In additional embodiments, as shown in FIG. 17, usage information of the work machines 10 and/or the attachments 18 may be displayed via the mobile app, such that the user can determine the amount of time various work machines 10 and/or attachments 18 have been used. Such usage information may be referred to herein as usage history. Regardless, the user may select a particular work machine 10, and the mobile app can display, via the GUI, which attachments are (or were recently) coupled with the work machine 10 over a given time period. The specific time period can be selected by the user and can be delineated by various time frames, such as by months, days, hours, minutes, etc. As such, the user can select a particular day and the mobile app will identify which attachment 18 was coupled with the work machine 10 for each portion of the day. For example, the mobile app may generate a GUI that illustrates that the work machine 10 was coupled with an attachment 18 in the form of an angle broom between 9:00 and 11:00 am on Jan. 20, 2024. Furthermore, the GUI may also illustrate that the work machine 10 was coupled with an attachment in the form of a bucket between 11:00 am and 3:00 pm on Jan. 20, 2024. Similar breakdowns of attachment usage can be shown on a minute-by-minute basis, an hourly basis, a daily basis, a monthly basis, etc.

Once the work machine 10 recognizes an attachment 18 is connected to the work machine 10, the work machine 10 sends the Tag's 60 serial number to the remote device 80 (e.g., the cloud). The remote device 80 (e.g., the cloud) then recognizes when the attachment 18 is connected to the work machine 10 and records this information (the time of attachment 18 connection) to the memory 84 of the remote device 80 (e.g., the cloud). Once the work machine 10 recognizes an attachment 18 is disconnected from the work machine 10, the work machine 10 stops sending the Tag's 60 serial number (or sends a string of zeros in place of the serial number) to the remote device 80 (e.g., the cloud). The remote device 80 (e.g., the cloud) then recognizes when the attachment 18 is disconnected from the work machine 10 and records this information (the time of attachment 18 disconnection) to the memory 84 of the remote device 80 (e.g., the cloud). This information (attachment 18 connection and/or disconnection time) can then be transmitted to a mobile device 70 from the remote device 80 (e.g., the cloud). The mobile device 70 then displays this information on the GUI, via the mobile app, as shown in FIG. 17.

Once the work machine 10 recognizes an attachment 18 is connected to the work machine 10, the work machine 10 sends a notification that the attachment 18 is connected to the work machine to the remote device 80 (e.g., the cloud) and the time of connection is recorded by the remote device 80 (e.g., the cloud) and stored in the remote device 80 (e.g., the cloud). Additionally, when the work machine 10 recognizes that the attachment 18 is disconnected from the work machine 10, the work machine 10 sends a notification that the attachment 18 is disconnected from the work machine 10 to the remote device 80 (e.g., the cloud) and the time of disconnection is recorded by the remote device 80 (e.g., the cloud) and stored in the remote device 80 (e.g., the cloud). This information (attachment connection and/or disconnection time) can then be transmitted to a mobile device 70 from the remote device 80 (e.g., the cloud). The mobile device 70 then displays this information on the GUI, via the mobile app, as shown in FIG. 17.

Such usage information may be presented to indicate to the operator as to when maintenance or servicing should be performed on the attachment 18. Such usage information may be generated by the remote device 80 (i.e., the cloud). This usage information can also be transmitted to remote user (e.g., via the mobile app on various mobile devices 70, such that remote users can determine when maintenance or servicing should be performed. In some embodiments, service reminders may be generated by the remote device 80 (i.e., the cloud) and sent to the remote users (e.g., via the mobile app on various mobile devices 70).

In addition to the above, various other usage information may be tracked by the Tags 60 of the attachments 18 and/or the control system of the work machines 10 and transmitted to the remote device 80 (e.g., the cloud) or the mobile device 70. For example, the number of times an attachment 18 has been physically coupled/decoupled from a work machine 10, the types of work machines 10 to which the attachment 18 has been coupled, and generally any other trackable information that is captured by the Tags 60 and/or the work machine 10 can be transmitted to the remote device 80 (e.g., the cloud) or mobile device 70 for future review and analysis (e.g., via mobile app, web app, or the like).

The following description illustrates how the mobile app installed on a user's mobile device 70 can be used to (i) program a Tag 60 with a particular attachment 18, (ii) associate the attachment 18 with a particular work machine 10, and and/or (iii) store information on the mobile device 70 and/or the remote device 80 (e.g., the cloud). First, the mobile device 70 may acquire the ID information of a particular Tag 60 (e.g., after the Tag 60 has been jostled). The operator of the mobile device 70 may also enter the serial number of the attachment 18 with which the particular Tag 60 is to be associated (e.g., manually via the touchscreen or keyboard of the mobile device 70 or as captured by the mobile device 70 via scanning a QR code on the attachment 18 using the mobile device's 70 imaging sensor/camera). The mobile device 70 may communicate with the cloud to provide the ID information of the Tag 60, as well as the serial number of the attachment 18. The remote device 80 (e.g., the cloud) may provide various attachment characteristics of the attachment 18 (based on the serial number of the attachment 18 entered by the user) back to the mobile device 70 (e.g., attachment 18 model name, Tag 60 serial number, attachment 18 use hours, Tag 60 battery status, work machine 10 serial number, etc.). Regardless, the remote device 80 (e.g., the cloud) will store information indicative of the particular Tag 60 being associated with the particular attachment 18. Such information may also be transmitted to and stored on the Tag 60 itself.

Thereafter, various operational information related to the work machine 10 and/or the attachment 18 may be periodically transmitted to the remote device 80 (e.g., the cloud) for storage and/or analysis. Such information may be transmitted to the remote device 80 (e.g., the cloud) by the mobile device 70 (e.g., via the mobile app) or by a transceiver associated with the work machine 10. For example, the Tag 60 may periodically transmit to the wireless transceiver 67 of the work machine 10 various information related to the Tag 60 and/or the attachment 18, such as attachment 18 model name, attachment 18 category number, Tag 60 serial number, attachment 18 use hours, parameters for work machine 10 control, Tag 60 battery status, etc. Such information may be periodically transferred by the work machine 10 to the remote device 80 (i.e., cloud) and/or to the mobile device 70 (e.g., via the mobile app). The work machine 10 may also transmit information associated with the work machine 10 to the remote device 80 (i.e., cloud) and/or to the mobile device 70 (e.g., via the mobile app), such as the work machine 10 serial number, work machine 10 use hours, the amount of time (e.g., number of hours) the attachment 18 and/or the work machine 10 have been used, the battery status of the work machine 10, and the like. All of such information (i.e., information associated with the attachment 18 and information associated with the work machine 10) may also be periodically transmitted from the remote device 80 (e.g., the cloud) to the mobile device 70, such that remote users may analyze the information related to attachments 18 and work machines 10 using the mobile app of the mobile device 70.

As such, embodiments of the present invention include a method for managing one or more work machines 10 and one or more attachments 18 configured to be operably coupled with the work machines 10. The method comprising use of a mobile app on a mobile device 70 configured to display the current attachment 18 coupled with the work machine 10. A remote device 80 (e.g., the cloud) is configured to receive and store a link between the Tag 60 serial number and the attachment 18 serial number. The work machine 10 receives the Tag 60 ID information (as well as perhaps the serial number from the Tag 60), then the work machine 10 sends the Tag 60 ID information (as well as perhaps the serial number from the Tag 60) to the remote device 80 (e.g., the cloud). The remote device 80 (e.g., the cloud) sends Tag 60 ID information (as well as perhaps the serial number from the Tag 60) and attachment 18 serial number to the mobile device 70. The remote device 80 (e.g., the cloud) is configured to create and store a link between Tag 60 ID information (as well as perhaps the serial number from the Tag 60) and attachment 18 serial number when wireless identification module 18 is setup with mobile device 70.

### Additional Attachment and Work Machine Features

It is noted that in some of the following descriptions of embodiments of the present invention, certain elements are referred to in different terms or phrases. An attachment management system according to one aspect of the present invention comprises at least one working vehicle, a plurality of attachments, each of the plurality of attachments being detachably coupled to the at least one working vehicle, a mobile terminal (e.g., a mobile device) having a terminal interface (e.g., a graphic display), and a plurality of communication tags, each of which is fixed to one of the plurality of attachments, and communicates with the mobile terminal through a wireless signal that is compliant with a near field communication standard, each of the plurality of communication tags including a tag memory to store a tag identifier unique to each of the plurality of communication tags, and a tag transceiver capable of transmitting the wireless signal containing the tag identifier to the mobile terminal, and receiving from the mobile terminal, attachment information unique to one of the plurality of attachments, on which each of the plurality of communication tags is fixed. The mobile terminal is switchable between a first mode where the mobile terminal receives the wireless signals from the plurality of communication tags and does not transmitting attachment information to the plurality of communication tags, and a second mode where the mobile terminal receives the wireless signals from the plurality of communication tags and is capable of transmitting attachment information to at least one of the plurality of communication tags. The mobile terminal is configured or programmed to display on the terminal interface, in the first mode, the tag identifiers and a plurality of pieces of attachment information stored in the tag memories of the plurality of communication tags which transmit the wireless signals, and in the second mode, the tag identifiers and the plurality of pieces of attachment information stored in the tag memories of the plurality of communication tags which transmit the wireless signals each having RSSIs (Received Signal Strength Indicator) equal to or greater than a predetermined threshold.

The mobile terminal may be configured or programmed to, in the first and second modes, sort and display on the terminal interface, the tag identifiers and the plurality of pieces of attachment information stored in the tag memories of the plurality of communication tags, based on the RSSIs of the wireless signals from the plurality of communication tags.

The mobile terminal may be configured or programmed to, in the second mode, allow an operator to select one of the tag identifiers displayed on the terminal interface, and obtain one of the plurality of pieces of attachment information corresponding to one of the tag identifiers selected by the operator through the terminal interface, and transmit the wireless signal containing the obtained one of the plurality of pieces of attachment information, from the terminal transceiver to the tag transceiver of one of the plurality of communication tags, to cause the tag memory thereof to store the obtained one of the plurality of pieces of attachment information.

The mobile terminal may be configured or programmed to, in the second mode, obtain one of the plurality of pieces of attachment information corresponding to the selected one of the tag identifiers through input operation of the operator on the terminal interface.

The mobile terminal may include a camera, and at least one of the plurality of attachments may include an image code recording one of the plurality of pieces of attachment information. The mobile terminal may be configured or programmed to, in the second mode, obtain the one of the plurality of pieces of attachment information corresponding to the selected one of the tag identifiers by scanning the image code with the camera.

The attachment management system may further comprise a server configured or programmed to store the plurality of pieces of attachment information containing attachment identifiers unique to each one of the plurality of attachments, and to communicate with a terminal communicator of the mobile terminal. The mobile terminal may be configured or programmed to, in the second mode, obtain one of the attachment identifiers corresponding to the selected one of the tag identifiers, obtain one of the plurality of pieces of attachment information containing the selected one of the tag identifiers by communicating with the server through the terminal communicator based on the obtained one of the attachment identifiers, and transmit the wireless signal containing the selected one of the tag identifiers and the obtained one of the plurality of pieces of attachment information, from the terminal transceiver to the tag transceiver of one of the plurality of communication tags, to cause the tag memory thereof to store the obtained one of the plurality of pieces of attachment information.

The mobile terminal may be configured or programmed to, in the second mode, obtain one of the plurality of pieces of attachment information corresponding to the selected one of the tag identifiers through input operation of the operator on the terminal interface.

The mobile terminal may include a camera, and at least one of the plurality of attachments may include an image code recording one of the plurality of pieces of attachment information The mobile terminal may be configured or programmed to, in the second mode, obtain one of the plurality of pieces of attachment information corresponding to the selected one of the tag identifiers by scanning the image code with the camera.

The attachment management system may further comprise a server including a server storage to store the plurality of pieces of attachment information containing a plurality of attachment identifiers unique to each one of the plurality of attachments, the server communicating with a terminal communicator of the mobile terminal. The mobile terminal may include a terminal communicator and a terminal transceiver, and may be configured or programmed to obtain the plurality of pieces of attachment information stored in the server storage by communicating with the server through the terminal communicator. The mobile terminal is configured or programmed to, in the second mode, allow an operator to select one of the tag identifiers displayed on the terminal interface, obtain one of the plurality of pieces of attachment information from the sever storage, corresponding to one of the tag identifiers selected by the operator through the terminal interface, and transmit the wireless signal containing obtained one of the plurality of pieces of attachment information, from the terminal transceiver to the tag transceiver of one of the plurality of communication tags, to cause the tag memory thereof to store the obtained one of the plurality of pieces of attachment information.

The attachment management system may further comprise a server to communicate with a terminal communicator of the mobile terminal. The at least one working vehicle may include a vehicle communicator to communicate with the server, and a vehicle storage to store a plurality of pieces of attachment information containing a plurality of attachment identifiers unique to each one of the plurality of attachments. The mobile terminal may include a terminal transceiver, and may be configured or programmed to obtain the plurality of pieces of attachment information stored in the vehicle storage by communicating with the vehicle storage via the terminal communicator, the server, and the vehicle communicator. The mobile terminal may be configured or programmed to, in the second mode, allow an operator to select one of the tag identifiers displayed on the terminal interface, obtain one of the plurality of pieces of attachment information from the vehicle storage corresponding to one of the tag identifiers selected by the operator through the terminal interface, and transmit the wireless signal containing obtained attachment information, from the terminal transceiver to the tag transceiver of one of the plurality of communication tags, to cause the tag memory thereof to store the obtained one of the plurality of pieces of attachment information.

The attachment management system may further comprise a server to communicate with a terminal communicator of the mobile terminal. The mobile terminal includes a terminal transceiver. The at least one working vehicle may include a positioning device providing a position information indicating a vehicle position thereof, a vehicle storage to store a plurality of pieces of attachment information of the plurality of attachments, and a vehicle communicator to communicate with the server, and transmits to the server, the plurality of pieces of attachment information linked with position information of the at least one working vehicle. The server may store the plurality of pieces of attachment information linked with position information of the at least one working vehicle, which are received from the vehicle communicator of the at least one working vehicle. The mobile terminal is configured or programmed to, in the second mode, allow an operator to select one of the plurality of pieces of attachment information displayed on the terminal interface, and transmit the selected one of the plurality of pieces of attachment information, from the terminal transceiver to the tag transceiver of one of the plurality of communication tags, to cause the tag memory thereof to store the selected one of the plurality of pieces of attachment information.

The attachment management system may further comprise a server to communicate with a terminal communicator of the mobile terminal. The mobile terminal may include a terminal transceiver. The at least one working vehicle may include a positioning device providing a position information indicating a vehicle position thereof, a vehicle storage to store a plurality of pieces of attachment information of the plurality of attachments, and a vehicle communicator to communicate with the server, and transmits to the server, the plurality of pieces of attachment information linked with position information of the at least one working vehicle. The server may store the plurality of pieces of attachment information linked with position information of the at least one working vehicle, which are received from the vehicle communicator of the at least one working vehicle. The mobile terminal may be configured or programmed, in the first mode, to obtain from the server, and display on the terminal interface, the plurality of pieces of attachment information and position information linked with each one of the plurality of pieces of attachment information, which are stored in the vehicle storage of the at least one working vehicle.

The mobile terminal may be configured or programmed, in the first mode, to display on the terminal interface, the plurality of pieces of attachment information and position information linked with each one of the plurality of pieces of attachment information, which are stored in the vehicle storage of the at least one working vehicle, and the plurality of pieces of attachment information, which are stored in the tag memories of the plurality of communication tags which transmit the wireless signals.

The mobile terminal may be configured or programmed to allow an operator to set a position area of the at least one working vehicle, extract at least one of the plurality of pieces of attachment information from the server, based on the set position area and position information of the at least one working vehicle, and display at least one of the plurality of pieces of attachment information on the terminal interface.

The mobile terminal may be configured or programmed to display a map and at least one mark indicating the vehicle position of the at least one working vehicle on the map based on position information thereof, and allow the operator to set the position area of the at least one working vehicle on the map.

The attachment management system may further comprises a server to communicate with a terminal communicator of the mobile terminal, the server including a server storage to store a plurality of pieces of attachment information of the plurality of attachments. The at least one working vehicle may include a plurality of working vehicles, the mobile terminal includes a terminal transceiver, each of the plurality of working vehicles includes a positioning device providing a position information indicating a vehicle position thereof, a vehicle storage to store the plurality of pieces of attachment information of the plurality of attachments, and a vehicle communicator to communicate with the server, and transmits to the server, the plurality of pieces of attachment information linked with position information of each of the plurality of working vehicles. The server storage may store the plurality of pieces of attachment information linked with position information of each of the plurality of working vehicles, which are received from each of the vehicle communicators of the plurality of working vehicles. The mobile terminal may display the plurality of pieces of attachment information linked with position information of each of the plurality of working vehicles, which are stored in the server storage. The mobile terminal may be configured or programmed to, in the second mode, allow an operator to select one of the plurality of pieces of attachment information displayed on the terminal interface, and transmit one of the plurality of pieces of attachment information selected by the operator, from the terminal transceiver to the tag transceiver of one of the plurality of communication tags, to cause the tag memory thereof to store the selected one of the plurality of pieces of attachment information.

The mobile terminal may be configured or programmed to allow an operator to set a position area of the plurality of working vehicles, extract at least one of the plurality of pieces of attachment information from the server storage, based on the set position area and position information of the plurality of working vehicles, and display the plurality of pieces of attachment information on the terminal interface.

The mobile terminal may be configured or programmed to display a map and marks indicating the vehicle positions of the plurality of working vehicles on the map based on position information thereof, and allow the operator to set the position area of the plurality of working vehicles on the map.

The mobile terminal may have a switch to allow the operator to select either one of the first mode and the second mode.

The mobile terminal may be configured or programmed to, in the first mode, display on the terminal interface, the tag identifiers and attachment information stored in each of the tag memories of the plurality of communication tags which transmit the wireless signals, and in the second mode, display on the terminal interface, the tag identifiers stored in each of the tag memories of the plurality of communication tags which transmit the wireless signals having the RSSIs equal to or greater than a predetermined threshold.

An attachment management system according to further aspect of the present invention comprises a server including a server storage, at least one working vehicle including a vehicle communicator to communicate with the server, a plurality of attachments detachably coupled to the at least one working vehicle, a mobile terminal including a terminal communicator to communicate with the server, a terminal transceiver, and a terminal interface, and a plurality of communication tags, each of which is fixed to one of the plurality of attachments, and communicates with the mobile terminal through a wireless signal that is compliant with a near field communication standard. The server storage stores a plurality of pieces of attachment information of the plurality of attachments. Each of the plurality of communication tags includes a tag memory to store a tag identifier unique to each of the plurality of communication tags, and a tag transceiver capable of transmitting the wireless signal containing the tag identifier to the mobile terminal, and receiving from the mobile terminal, attachment information unique to one of the plurality of attachments, on which each of the plurality of communication tags is fixed. The mobile terminal is configured or programmed to obtain and display on the terminal interface, the plurality of pieces of attachment information of the plurality of attachments, by communicating with the server through the terminal communicator, allow an operator to select one of the plurality of pieces of attachment information displayed on the terminal interface, and transmit one of the plurality of pieces of attachment information displayed on the terminal interface and selected by the operator, from the terminal transceiver to the tag transceiver of one of the plurality of communication tags, to cause the tag memory thereof to store the selected one of the plurality of pieces of attachment information.

The at least one working vehicle may include a positioning device providing position information indicating a vehicle position thereof, and a vehicle storage to store the plurality of pieces of attachment information of the plurality of attachments, the vehicle communicator transmits to the server, the plurality of pieces of attachment information of the plurality of attachments, which are linked with position information of the at least one working vehicle, the vehicle communicator transmits to the server, the plurality of pieces of attachment information of the plurality of attachments, which are linked with position information of the at least one working vehicle. The sever storage may store the plurality of pieces of attachment information of the plurality of attachments, which are linked with position information of the at least one working vehicle. The mobile terminal may be configured or programmed to, obtain and display on the terminal interface, the plurality of pieces of attachment information of the plurality of attachments stored in the sever storage, which are linked with position information of the at least one working vehicle, by communicating with the server through the terminal communicator, allow an operator to select one of the plurality of pieces of attachment information displayed on the terminal interface, based on position information of the at least one working vehicle, and transmit the selected one of the plurality of pieces of attachment information, from the terminal transceiver to one of the plurality of communication tags, to cause the tag memory thereof to store the selected one of the plurality of pieces of attachment information.

The at least one working vehicle may include a plurality of working vehicles, and one of the plurality of working vehicles may be located away from another of the plurality of working vehicles.

The mobile terminal may be configured or programmed to, allow the operator to set a position area of the at least one working vehicle, extract at least one of the plurality of pieces of attachment information from the server storage, based on the set position area and position information of the at least one working vehicle, and display the at least one of the plurality of pieces of attachment information on the terminal interface.

An attachment management system according to even further aspect of the present invention comprising a server including a server storage, at least one working vehicle including a vehicle communicator to communicate with the server, a plurality of attachments each detachably coupled to the at least one working vehicle, a mobile terminal including a terminal communicator to communicate with the server, a terminal transceiver, and a terminal interface, and a plurality of communication tags, each of which is fixed to one of the plurality of attachments, and communicates with the mobile terminal through a wireless signal that is compliant with a near field communication standard. The server storage stores a plurality of pieces of attachment information containing a plurality of attachment identifiers unique to each one of the plurality of attachments. Each of the plurality of communication tags includes a tag memory to store a tag identifier unique to each of the plurality of communication tags, and a tag transceiver capable of transmitting the wireless signal containing the tag identifier to the mobile terminal, and receiving from the mobile terminal, attachment information unique to one of the plurality of attachments, on which each of the plurality of communication tags is fixed. The mobile terminal is configured or programmed to, obtain one of the plurality of attachment identifiers of the plurality of pieces of attachment information through operation of an operator, obtain one of the plurality of pieces of attachment information linked with the obtained one of the plurality of attachment identifiers, based on the obtained one of the plurality of attachment identifiers, from the server storage by communicating with the server through the terminal communicator, and transmit the wireless signal containing the obtained one of the plurality of pieces of attachment information, from the terminal transceiver to the tag transceiver of one of the plurality of communication tags, to cause the tag memory thereof to store the obtained one of the plurality of pieces of attachment information.

The mobile terminal may be configured or programmed to, display on the terminal interface, at least one of the plurality of pieces of attachment information stored in the tag memory of at least one of the plurality of communication tags from which the mobile terminal receives the wireless signals having the RSSIs (Received Signal Strength Indicator) equal to or greater than a predetermined threshold, allow the operator to select one of the plurality of attachment identifiers displayed on the terminal interface, and obtain one of the plurality of pieces of attachment information linked with the selected one of the plurality of attachment identifiers, based on the selected one of the plurality of attachment identifiers, from the server storage, by communicating with the server through the terminal communicator.

The mobile terminal may be configured or programmed to obtain one of the plurality of attachment identifiers through input operation of the operator.

The mobile terminal includes a camera. At least one of the plurality of attachments may include an image code recording attachment information. The mobile terminal may be configured or programmed to obtain one of the plurality of attachment identifiers by scanning the image code with the camera.

The at least one working vehicle may include a positioning device providing position information indicating a vehicle position thereof, and a vehicle storage to store the plurality of pieces of attachment information of the plurality of attachments, the vehicle communicator transmits to the server, the plurality of pieces of attachment information of the plurality of attachments, which are linked with position information of the at least one working vehicle, the sever storage stores the plurality of pieces of attachment information of the plurality of attachments, which are linked with position information of the at least one working vehicle. The mobile terminal may be configured or programmed to, obtain and display on the terminal interface, the plurality of pieces of attachment information of the plurality of attachments, which are linked with position information of the at least one working vehicle, by communicating with the server through the terminal communicator, allow an operator to select one of the plurality of pieces of attachment information displayed on the terminal interface, based on position information of the at least one working vehicle, and transmit the selected one of the plurality of pieces of attachment information, from the terminal transceiver to the tag transceiver of one of the plurality of communication tags, to cause the tag memory thereof to store the selected one of the plurality of pieces of attachment information.

The at least one working vehicle may include a plurality of working vehicles, and one of the plurality of working vehicles may be located away from another of the plurality of working vehicles.

The mobile terminal maybe configured or programmed to, allow the operator to set a position area of the at least one working vehicle, extract at least one of the plurality of pieces of attachment information from the server storage, based on the position area and position information of the at least one working vehicle, and display the at least one of the plurality of pieces of attachment information on the terminal interface.

Attachment management system according to an example embodiment of the present invention generally includes a working vehicle, a plurality of attachments, a mobile terminal, and a server. Each of the plurality of attachments is configured to be detachably coupled to the working vehicle.

The working vehicle may be in the form of a compact track. However, the working vehicle according to the example embodiment of the present invention is not limited to a compact track loader, and may be, for example, some other construction machine such as a skid-steer loader and a backhoe (or an excavator), or an agricultural machine such as a tractor. The working vehicle includes a machine body, a cabin, a working device (including an attachment), and traveling devices. The cabin is provided on the machine body. The attachment may be a bucket. The cabin includes an operator's seat, operation members (manual operators) to be operated by an operator seated on the operator's seat, and/or the like. The operation members include a travel operation member to operate the traveling devices and a work operation member to operate the working device.

The traveling devices are provided on the left and right sides of the machine body and support the machine body such that the machine body is allowed to travel. The traveling devices are crawler-based traveling devices. The operator operates the travel operation member to cause both the left and right traveling devices to rotate in a forward direction, both the left and right traveling devices to rotate in a reverse direction, only one of the left and right traveling devices to rotate in the forward direction, or one of the left and right traveling devices to rotate in the forward direction and the other to rotate in the reverse direction to cause the machine body (working vehicle) to travel forward, rearward, or turn left or right. Note that the traveling devices may be tire-based traveling devices.

The working device is attached to the machine body. The working device includes an attachment, a coupling device, and a position changing device. The attachment is a working tool such as a bucket, which can be attached to or detached from the coupling device. The attachment may be any other working tools, including, for example, earth augers, angle blooms, crushers, grapples, cold planers, sweepers, skid cutters, skid graders, stamp grinders, snow blowers, snow pushers, spreaders, and dozer blades, trenchers, breakers, pallet forks, hopper blooms, mowers, rippers, loader booms, and rotary tillers. Those attachments include various different specifications such as operations to be performed, structures, sizes, and shapes.

The coupling device is a device provided on the position changing device, such that the attachment can be attached to or detached from the machine body. Thus, the position changing device is a device configured to change a position of the coupling device relative to the machine body. The position changing device has one end or rear end connected to the machine body, and the other end or front end provided with the coupling device. The position changing device moves up and down the coupling device to change a position of the coupling device relative to the machine body, which in turn moves up and down the attachment relative to the machine body.

In the present embodiment, the position changing device includes booms, lift links, control links, boom cylinders, front cylinders, which are provided left and right sides of the cabin. The left and right booms are connected to each other by a connector at an intermediate portion of the booms. The left boom has, at the front portion thereof, a hydraulic fluid outlet port (power output port) and a hydraulic fluid inlet port.

The lift links and the control links support proximal portions (rear portions) of the booms via shafts such that the booms are swingable up and down. The boom cylinders each have one end thereof pivotally connected to a corresponding one of the booms via a shaft and the other end thereof pivotally connected to a lower rear portion of the machine body via a shaft. Upon operation of the work operation member along a first direction by the operator of the working vehicle, the boom cylinders extend or retract and the booms ascend or descend (swing upward or downward).

Note, however, that the above structure of the position changing device is not limited thereto, and may include arms and booms and/or the like when the working vehicle is a backhoe, and may be an elevator such as a three-point linkage mechanism, when the working vehicle is a tractor.

The coupling device may be a quick hitch capable of coupling the attachment to the machine body, or decoupling the attachment from the machine body. The booms are provided with the quick hitch at the distal ends thereof. The quick hitch is a linkage configured to easily attach and detach any of various attachments (hydraulic driven working tools) such as the bucket. The operator of the working vehicle can easily change attachments using the quick hitch. The quick hitch is therefore also called “quick changer”. The bucket, which is an example of the attachment, is attached to a front portion of the quick hitch.

The quick hitch has, connected to a rear portion thereof, the distal ends of the booms and ends of the front cylinders via respective shafts such that the booms and the front cylinders are pivotable. The opposite ends of the front cylinders are pivotally connected to the connector via shafts. Upon operation of the work operation member, the front cylinders extend or retract and the quick hitch swings upward or rearward. With this, the bucket attached to the quick hitch, swinging upward or downward, performs shoveling or dumping.

Each of the attachments includes a communication tag or beacon fixed thereon. Specifically, the tag is fixed on the back portion of the attachment by means of any appropriate fixing members such as bolts and nuts. Thus, the tags are interchangeably fixed on each of the attachments. For example, in cases where the tag fails or malfunctions, and the battery inside the tag is exhausted and need to be exchanged, a new tag can be fixed on the attachment instead of old one. One tag which has been fixed on one attachment can be replaced and fixed on another attachment. Note that International Application Publication WO 2024/081645 A1, entitled “Work Machine with Wireless Transceiver,” discloses a communication tag fixed on the back portion of the attachment. The entire disclosure of WO 2024/081645 is incorporated herein by reference.

Each of the tags, actually fixed on or to be fixed on the attachment, includes a tag transceiver which is configured to periodically transmit and receive a wireless signal (referred to as a “beacon signal” herein) compliant with a near field communication standard such as RFID (Radio Frequency Identification) and BLE (Bluetooth (registered trademark) Low Energy). Each of the tags also includes a tag memory to store a tag identifier unique thereto (referred to simply as a “tag ID” herein), and a microcomputer to control the tag transceiver and the tag memory, and a battery to supply power to those components of the beacon tag.

Exemplary data contained in a beacon signal which is transmitted from and received by a beacon tag may include a header, a tag ID (or ID information), and attachment information. In some embodiments, the attachment information may include the ID information. The attachment information may also include a name, a type, a model number, a specification of the attachment, and/or the like. Since the beacon signal transmitted from the tag is a signal containing its own tag ID but no data to identify the receiver, the beacon signal is called as a broadcasting signal. Note that a newly purchased tag can be interchangeably fixed to one of the attachments so that the beacon signal transmitted therefrom contains its tag ID only and no other attachment information associated with the attachment.

Therefore, after the beacon tag is newly purchased, the operator is required through the mobile terminal, to set or store attachment information unique to the attachment, to which the tag is to be fixed, in the tag memory as an initial setting. Attachment information may contain various information about a name, a type (Att. Type), a model number (Att. Model), a size and/or shape, a specification (Att. Spec.) such as the maximum permissible flow rate of hydraulic fluid to be supplied, a state of charge (SOC) of the battery, a cumulative operating time (e.g., hour meter), and/or the like of the attachment.

The tag transmits the beacon signal containing the tag ID unique to the tag which is stored in the tag memory. The mobile terminal obtains attachment information containing the attachment ID unique to the attachment. Then, the mobile terminal transmits the beacon signal containing the particular tag ID and the attachment ID. Thus, the beacon signal transmitted from the mobile terminal contains the header, the tag ID, and attachment information obtained based on the attachment ID. The tag stores attachment information in the beacon signal, when receiving the beacon signal containing its own tag ID. In other words, the mobile terminal has a function performing as a reader/writer on the tag memory.

On the other hand, the tag, of which tag memory has already stored attachment information (when it is ready to be used), transmits (or broadcasts) the beacon signal containing the tag ID and attachment information. A beacon scanner of the working vehicle receives and reads the beacon signal containing the tag ID and attachment information, so that a vehicle controller of the working vehicle recognizes when and which attachment is coupled with the coupling device.

The vehicle controller is configured to control the attachment based on recognized attachment information in the received beacon signal. For example, the vehicle controller may be configured to control output of hydraulic fluid (power) to the attachment coupled with the coupling device, based on recognized attachment information. In this case, the vehicle controller controls at least either one of input of hydraulic fluid from the attachment, and output amount and output pressure of hydraulic fluid supplied to the attachment. In addition, the vehicle controller may be configured to control a vehicle interface to provide or display information that the attachment is coupled with the coupling device (or the working vehicle).

While the above description discusses the case where the initial setting is required for the newly purchased tag, attachment information may have already been stored in the tag memory of the beacon tag in a case where the beacon tag is sold with attachment information of the attachment linked with the beacon ID of the beacon tag.

In particular, the microcomputer of the tag is configured to control the tag transceiver to transmit the beacon signal containing the tag ID and attachment information stored in the tag memory, in a predetermined time period of one to three seconds, for example. When receiving the beacon signal, the microcomputer of the beacon tag is configured to determine whether the beacon signal contains its own tag ID, and if it does, the microcomputer is configured to cause the tag memory to store attachment information in the beacon signal or overwrite attachment information with one in the beacon signal.

The mobile terminal typically includes a terminal device such as a smartphone and a tablet computer, and may be a mobile laptop PC (Personal Computer), and even a standalone terminal device, which is not limited thereto. The mobile terminal includes a terminal communicator capable of communicating with a server (including a cloud server) via the Internet and wireless LAN (Local Area Network). The mobile terminal includes a terminal interface (which may be referred to simply as a “touch panel” herein) to allow the operator to input/output information (displaying or providing information). The mobile terminal also includes a terminal transceiver to receive the beacon signals from a plurality of tags and transmit the beacon signal having selected one of tag IDs to the tag.

The terminal interface is embodied by the touch panel of the smartphone. The mobile terminal may include a camera implemented by CCD (Charge Coupled Devices) or CMOS (Complementary Metal Oxide Semiconductor) image sensors. The mobile terminal includes a terminal controller configured to control the terminal communicator, the terminal transceiver, and the camera.

The mobile terminal includes a terminal controller which is processing circuitry having one or more processors such as CPU (Central Processing Unit), DPU (Digital Signal Processor), FPGA (Field Programmable Gate Array) and ASIC (Application Specific Integrated Circuit).

As described above, the attachment management system includes a working vehicle, a plurality of attachments each detachably coupled to the working vehicle, a mobile terminal having a terminal interface (touch panel), and a plurality of tags, each of which is interchangeably fixed to one of the plurality of attachments, and communicates with the mobile terminal through the beacon signal that is compliant with a near field communication standard.

The working vehicle includes a beacon scanner (e.g., wireless transceiver) to receive the beacon signals from the plurality of tags, and a vehicle communicator to communicate with the server (cloud server) via the Internet and wireless LAN. The working vehicle also includes a vehicle storage, a vehicle interface to allow the operator to input/output information (displaying or providing information), and a vehicle controller to control the above-described components. Furthermore, the working vehicle may include a positioning device to identify its own position of the working vehicle.

In particular, the vehicle controller is processing circuitry having one or more processors. The vehicle controller is configured to communicate with the vehicle communicator, the beacon scanner, the vehicle storage, the vehicle interface, the positioning device, other various on-board devices on the working vehicle, via an in-vehicle network such as CAN, ISOBUS, LIN and, FlexRay, and control those devices to achieve various controls of the working vehicle.

The vehicle controller includes one or more memories, and a variety of analog and digital circuits. The one or more memories store (memorize) software programs and various data to cause the one or more processors to perform functions. In particular, the one or more memories of the vehicle controller includes an internal memory which is formed of a volatile or non-volatile memory. The vehicle controller uses a predetermined memory region of the non-volatile memory, as a buffer memory for temporarily memorizing information.

The vehicle controller is connected to the vehicle storage (non-volatile memory) for communication therebetween, which is provided outside the vehicle controller. The internal memory and the vehicle storage store several software programs and various control data for controlling operation of each of the devices of the working vehicle. The vehicle storage stores a plurality of pieces of attachment information corresponding to the plurality of attachments.

The vehicle controller is connected to read software programs and control data using one or more processors, enabling it to perform various operations based on these inputs. Additionally, the vehicle controller can execute operations based on predetermined logic circuitry implemented within the processors.

Similar to the terminal controller of the mobile terminal, the processors implementing the vehicle controller include CPU (Central Processing Unit), DPU (Digital Signal Processor), FPGA (Field Programmable Gate Array), and ASIC (Application Specific Integrated Circuit).

The vehicle controller is capable of performing various operations in coordination with multiple physically separate processors. Moreover, the structure of the vehicle controller is not limited to these components. For example, these processors could be mounted on physically separate computers and interconnected via networks such as an in-vehicle network, LAN, WAN, Internet, and/or the like.

The positioning device is equipped with a GNSS (Global Navigation Satellite System) receiver. The GNSS receiver includes processing circuitry that determine the position of the work vehicle 1 based on signals from GNSS satellites. The positioning device determines its own current position (e.g., latitude and longitude) based on GNSS signals transmitted from GNSS satellites. GNSS refers to a collective term for satellite positioning devices such as GPS (e.g., Michibiki), QZSS, GLONASS, Galileo, and BeiDou. Additionally, while the positioning device determines the position (current position) of the working vehicle using a GNSS receiver, it may also detect the current position by other means. For example, sensing devices such as LiDAR may be provided on the vehicle body, and the positioning device may estimate (determine) the current position based on the results sensed by the sensing devices and map information (environmental map information) stored in the vehicle storage.

The server includes a server storage, which can store a plurality of pieces of attachment information of various attachments as well as the vehicle storage.

The terminal transceiver of the mobile terminal and the beacon scanner of the working vehicle can detect the received signal strength (which may be referred to simply as “RSSI”, Received Signal Strength Indicator) of the beacon signal. The terminal interface of the mobile terminal and the vehicle interface can both display the RSSI of the received beacon signal. While the beacon scanner is described herein as a device to receive the beacon signal from the beacon tag, it should be noted that the device may also transmit the beacon signal such that it may be structured as a vehicle transceiver.

Next, an example embodiment and variations of a process or a series of steps performed the attachment management system will be described. When the operator activates an app of the attachment management system on an initial screen of the mobile terminal, the mobile terminal displays a mode selection screen on the touch panel (terminal interface). Hereinafter, the owner of the mobile terminal, the operator (driver) of the working vehicle, the manager of the company that owns the working vehicle and/or the attachments, and the manager of the barn (garage) or rental company for the attachments will collectively be referred to as the “operator”.

The operator can select either one of a tag detection mode (which is also referred to as a “first mode” herein) and a tag setting mode (which is also referred to as a “second mode” herein) on the mode selection screen. Hence, the mobile terminal has the switches (including GUI switches) on the mode selection screen. It should be noted that these switches are not limited to GUI switches, and they may be physical switches on the mobile terminal.

With a plurality of attachments arranged around the mobile terminal, the mobile controller is configured to control the touch panel to display a tag detection screen, when the operator taps an area indicating the “tag detection mode” on the touch panel to select the “tag detection mode”. Hereinafter, selecting a particular position/area on the touch panel is referred to as “tapping” on the ouch panel.

The mobile transceiver of the mobile terminal receives a plurality of beacon signals from a plurality of tag transceivers of the tags fixed on respective one of the plurality of attachments around the mobile terminal. Each of the beacon signals from the tags contains a tag identifier (tag ID) different from one another. The mobile transceiver of the mobile terminal also receives the beacon signals each containing different tag identifies when one or more of the tags around the mobile terminal regardless of whether they have not yet used or fixed on a respective one of the attachments. The mobile transceiver detects RSSIs (Received Signal Strength Indicators) of each of the received beacon signals.

The tag detection screen lists a plurality of tag IDs and RSSIs, and the plurality of pieces of attachment information each including attachment ID (Att. ID), attachment type (Att. type), and attachment model (Att. model), which are contained in each of the beacon signals having a relative value of the RSSIs equal to or greater than a first threshold (e.g., 3). In the tag detection mode, the touch panel displays one or more of tag IDs and pieces of attachment information in the beacon signals only with the RSSIs equal to or greater than the first threshold. As the relative value of the RSSIs is greater, the beacon signal has greater signal strength. It should be noted that attachment information other than the attachment ID is not limited to attachment type and attachment model.

More preferably, both in the tag detection mode and the tag setting mode, the mobile terminal sorts and display the plurality of pieces of attachment information on the terminal interface (touch panel) based on the RSSIs of the beacon signals received from the plurality of tags. In particular, the mobile controller is configured to control the touch panel to display the plurality of pieces of attachment information sorted in a descending order based on the relative values of the RSSIs of the beacon signals. That is, the mobile controller is configured to control the touch panel so that the plurality of pieces of attachment information in the beacon signals having greater RSSI is displayed at higher positions on the touch panel.

In the tag detection mode (first mode), while the plurality of pieces of attachment information in the beacon signals having the RSSIs in a range between 0-10 are displayed on the tag detection screen, the RSSIs may be varied in the other range (e.g., 0-100). A number of lines of attachment information displayed on the touch panel are dependent on the number of the tags around the mobile terminal, which is ten of lines in the tag detection screen, and may be greater or less than 10. The first threshold of the RSSIs of the beacon signals is not limited to 3, and any threshold of the RSSIs can be adapted to display, on the touch panel, the plurality of pieces of attachment information in the beacon signals.

In addition, the first threshold of the RSSIs of the beacon signals may be set as zero. That is, the mobile terminal in the tag detection mode may display on the touch panel, the plurality of tag IDs and the RSSIs, and the plurality of pieces of attachment information including attachment ID (Att. ID), attachment type (Att. type), and attachment model (Att. model), in the beacon signals received from all tags around the mobile terminal.

If the beacon signal includes no attachment information, for example, in a case where the tag is newly purchased and no attachment information has been input so that the tag memory stores no attachment information, then attachment information is not displayed, or a denotation of “N/A” (Not Applicable) is displayed in the tag detection screen. In the tag detection screen, the mobile terminal is configured to display no attachment information including attachment ID (Att. ID), attachment type (Att. type), and attachment model (Att. model) for the tags of the third row (e.g., Tag ID: T #4051), the fourth row (e.g., Tag ID: T #8397), and the nineth row (e.g., Tag ID: T #8603) from the top.

In the tag detection mode (first mode), the mobile terminal receives the beacon signals from the plurality of tags (e.g., tags 1, 2, . . . , N), but transmit no beacon signal to any one of the tags. In other words, in the tag detection mode, the mobile transceiver of the mobile terminal receives the beacon signals but transmits no beacon signal. The operator can easily recognize location of the tags, which have been fixed and not yet fixed on one of the attachments, around the mobile terminal, simply by looking at the tag detection screen. Thus, the operator can easily realize location of the tags fixed on one of the attachments arranged in the garage and around the mobile terminal, and location of the unused tags around the mobile terminal.

As described above, as the beacon signal is the wireless signal compliant with a near field communication standard, the RSSIs of the beacon signal changes in accordance with a distance between the mobile terminal and the tag. The operator having the mobile terminal walks around the attachments on which the tags is fixed and/or the unused tags, which causes the RSSIs of the beacon signals received by the mobile terminal to substantially be changed. That is, the RSSIs of the beacon signals received by the mobile terminal changes with movement of the mobile terminal (the operator). Therefore, the operator easily and reliably recognize which one of attachments or which one of tags is closest to the mobile terminal (the operator) simply by looking at the list of the beacon IDs and attachment IDs, if any, sorted in the descending order on the tag detection screen.

A tag setting screen may also be displayed on the touch panel when the mobile transceiver receives the plurality of beacon signals in the tag setting mode. The mobile controller is configured to control the touch panel to display the tag setting screen when operator selects the tag setting mode by tapping the “tag setting mode” on the touch panel.

In the tag setting mode, the touch panel displays one or more of tag IDs in the beacon signals only with the RSSIs equal to or greater than the second threshold (e.g., 6 or greater) that is greater than the first threshold (e.g., 3), as shown in the tag setting screen. The mobile transceiver of the mobile terminal controls the touch panel to display one or more of tag IDs in the beacon signals with the RSSIs not less than the second threshold as shown in the tag setting screen.

In the tag setting mode, the touch panel displays one or more of tag IDs in the beacon signals only with no attachment information in the tag memory. While the touch panel displays one or more of tag IDs in the beacon signals and “N/A” for no attachment information in the tag detection screen, the touch panel displays one or more of tag IDs in the beacon signals only with no attachment information in the tag memory in the tag setting screen. Preferably, the mobile controller is configured to control the touch panel to sort and display one or more of the beacon IDs in the beacon signals in a descending order based on the RSSIs thereof, so that one or more of the beacon IDs in the beacon signals having greater RSSIs are displayed at higher positions on the touch panel, similar to the tag detection screen.

The mobile terminal is configured to not only receive one or more beacon signals from one or more tags but also transmit to at least one tag, the beacon signal containing attachment information. That is, in the tag setting mode of the tag setting screen, the mobile terminal can receive beacon signals from a plurality of tags and transmit the beacon signal containing the tag ID and attachment information to at least one (or a particular one) tag, unlike in the tag detection mode of the tag detection screen. With this, the operator can easily recognize location of the tags transmitting the beacon signals having RSSIs greater than a predetermined threshold (the second threshold), which have been fixed and not yet fixed on one of the attachments, around the mobile terminal, simply by looking at the tag setting screen.

In addition, the operator can select one of the tag IDs by tapping its portion displayed on the tag setting screen and change (and store/overwrite) attachment information of the selected or corresponding tag ID with another attachment information. Specifically, when the operator taps a portion indicating the tag ID to be selected on the tag setting screen, the portion of the touch panel is displayed in black and white inversion, or in a different color to indicate that the tag ID is selected. The operator may use another typing or popup screen to directly input or write any character strings for attachment information (through input operation of the operator) corresponding to the selected tag ID.

For example, when the operator taps a portion indicating the tag ID (T #8636), the terminal controller controls the touch panel to display “T #8636” of the selected tag ID in black and white inversion as shown in the attachment information input screen. The terminal controller further controls the touch panel to display another typing or pop-up screen to allow the operator to input any numbers or characteristics. With this, the mobile terminal can obtain one of the plurality of pieces of attachment information corresponding to the selected tag ID (T #8636) through the touch panel or manual input operation of the operator.

The terminal controller of the mobile terminal is configured to control the terminal transceiver to transmit the beacon signal containing the selected tag ID (T #8636) and obtained attachment information corresponding thereto. On the other hand, while the tag memory of the tag stores its own tag ID, the microcomputer of the tag is configured to control the store obtained attachment information in the tag memory in the beacon signal when the microcomputer determines that the beacon signal contains its own tag ID (T #8636). This allows the operator to input or rewrite appropriate attachment information with the selected tag ID, in the tag memory of the tag as shown in the input completion screen. When the tag has an internal circuitry failed or an internal battery completely exhausted, the operator can remove it from the attachment, fix a new tag on the attachment, and surely input appropriate attachment information in the tag memory of the tag. The order of the operator's steps is flexible, such that the operator may input appropriate attachment information in the tag memory of the new tag, and then fix a new tag on the attachment.

As described above, the mobile terminal including the terminal transceiver is configured to allow the operator to select one of the tag IDs displayed on the terminal interface, obtain one of the plurality of pieces of attachment information that the operator inputs through the terminal interface, and transmit the beacon signal containing the selected tag ID and obtained attachment information, from the terminal transceiver to the tag transceiver, to cause the tag memory of the selected tag ID to store obtained attachment information.

It should be noted that even single piece of attachment information includes various information, for example, attachment type, attachment model number, specification and/or the like, the operator's task to input attachment information would be cumbersome especially in writing or storing attachment information in the tag memory of a new tag. Therefore, some variations will be discussed herein, which allow the mobile terminal to obtain attachment information in more readily manners.

[Variation 1] At least one attachment may include an image code (a QR code (Quick Response code, registered trademark) or a bar code) affixed thereon, recording attachment information thereof. After selecting one of tag IDs, the operator may use the camera of the mobile terminal to obtain appropriate attachment information of the attachment by scanning the image code on the attachment, instead of manually inputting attachment information on the character input screen. Thus, in the tag setting mode, the mobile terminal can obtain attachment information corresponding to one of the tag IDs selected by the operator, by scanning the image code affixed on the attachments or even the tags with the camera.

Then, the mobile terminal transmits the beacon signal containing the beacon signal containing the selected tag ID and attachment information corresponding thereto. When the microcomputer of the tag recognizes that the beacon signal received from the terminal transceiver includes its own tag ID, the microcomputer is configured to cause the tag memory of the tag to store attachment information. With this, the mobile terminal can eliminate the manual input task of the operator through the touch panel to obtain attachment information, simply by scanning the image code with the camera.

[Variation 2] As discussed above, the server includes a server storage, the vehicle communicator of the working vehicle is capable of communicating with the mobile terminal via the server, the Internet and wireless LAN, and/or the like. A plurality of pieces of attachment information (including attachment IDs) stored in the vehicle storage are transferred to the server in a regular basis and stored in the server storage. Therefore, the mobile terminal can obtain one of the plurality of pieces of attachment information desired by the operator, among the plurality of pieces of attachment information stored in the server storage, as will be discussed in detail hereinafter.

In the tag setting mode, the operator taps the tag ID (T #8636) on the touch panel, manually inputs a particular attachment ID (e.g., A #3864) through the character input screen, and taps a button of “Obtain Attachment Information”.

This activates the mobile terminal to communicates with the server to extract one of the plurality of pieces of attachment information having the attachment ID consistent with the attachment ID (A #3864) input by the operator, among the plurality of pieces of attachment information stored in the server storage. More specifically, the mobile terminal transmits a request signal containing the attachment ID (A #3864) input by the operator, from the terminal communicator to the server. Upon receipt of the request signal from the mobile terminal, the server extracts one of the plurality of pieces of attachment information having the selected or designated attachment ID (A #3864) from the server storage, and transmits a response signal containing one of the plurality of pieces of attachment information with the designated or requested attachment ID (A #3864) to the mobile terminal. As above, the mobile terminal can readily obtain the attachment ID corresponding to the selected tag ID, and obtain one of the plurality of pieces of attachment information among the plurality of pieces of attachment information stored in the server storage, based on the attachment ID, by communicating with the server via the terminal communicator.

Furthermore, the mobile terminal transmits the beacon signal containing the tag ID (T #8636) selected by the operator and one of the plurality of pieces of attachment information linked with the attachment ID (A #3864) input or designated by the operator, among the plurality of pieces of attachment information stored in the server storage. When the microcomputer of the tag finds its own tag ID (T #8636) in the beacon signal transmitted from the mobile terminal, the microcomputer is configured to control the tag memory of the tag to store one of the plurality of pieces of attachment information with the attachment ID (A #3864). With this, the tag can easily obtain from the server storage, appropriate attachment information with the attachment ID of the attachment, on which the beacon tag is fixed.

As discussed above, the server is capable of communicating with the mobile terminal, and includes the server storage to store the plurality of pieces of attachment information having attachment IDs each unique to the attachments. On the other hand, the mobile terminal includes the terminal transceiver and the terminal communicator, and obtains one of the plurality of piece of attachment information stored in the server storage, by communicating with the server via the terminal communicator. In the tag setting mode, the mobile terminal is configured to allow the operator to select one of tag IDs among one or more tag IDs displayed on the touch panel. The mobile terminal is also configured to obtain one of the plurality of pieces of attachment information, from the server storage, which corresponds to the attachment ID input through the touch panel, and to transmit the beacon signal containing the selected tag ID and the obtained one of the plurality of pieces of attachment information, from the terminal transceiver to the tag transceiver of the tag, to cause tag memory to store the obtained one of the plurality of piece of attachment information.

It should be noted that, as discussed above, the attachment ID (e.g., A #3864) corresponding to the selected tag ID may be obtained by the manual input operation of the operator through the touch panel, or by scanning the image code affixed on the attachment with the camera of the mobile terminal.

Alternatively, the mobile terminal may be configured to obtain one of the plurality of pieces of attachment information, from the vehicle storage of a local working vehicle positioned away from the mobile terminal, instead of the server storage, which corresponds to the tag ID selected through the touch panel. The working vehicle includes the vehicle communicator capable of communicating with the server via Internet, wireless LAN and/or the like, and the vehicle storage to store the plurality of pieces of attachment information having attachment IDs each unique to respective one of the plurality of attachments.

The mobile terminal includes the terminal transceiver and obtains the plurality of pieces of attachment information stored in the vehicle storage of the local working vehicle via the terminal communicator, the server, and the vehicle communicator. In the setting mode, the mobile terminal is configured to allow the operator to select one (e.g., T #8636) of the tag IDs displayed on the touch panel. The mobile terminal is configured to obtain one of the plurality of pieces of attachment information corresponding to the one of the tag IDs selected by the operator through the touch panel, from the vehicle storage. The obtained one of the plurality of pieces of attachment information may contain the attachment ID, for example, A #3864. Furthermore, the mobile terminal is configured to transmit the beacon signal containing the selected one of the tag IDs and the obtained one of the plurality of pieces of attachment information, from the terminal transceiver to the tag transceiver of the tag, to cause tag memory to store the obtained one of the plurality of piece of attachment information. This eliminates complicated or cumbersome operator's input operation of the plurality of piece of attachment information, and surely causes the tag memory to store appropriate attachment information.

The vehicle storage stores the plurality of pieces of attachment information of the attachments that have been attached to the working vehicle in the past. In particular, each of the plurality of pieces of attachment information of the attachments, which has been attached to the working vehicle and controlled by the vehicle controller, has been obtained from the beacon signal received by the beacon scanner from the tag, and has been stored in the vehicle storage. Each of the plurality of pieces of attachment information of the attachments may be uploaded to the server as appropriate. That is, data of the server storage may be accumulated by updating the plurality of pieces of attachment information to the server, in processes while a variety of the attachments have been coupled and used with the working vehicle. Preferably, the server storage may also store log data indicating the time when each of the plurality of pieces of attachment information was stored, as attribute information thereof. Similarly, the server storage may store log data indicating the time when each of the plurality of pieces of attachment information was uploaded to the server.

When an old tag is removed from the attachment and new tag is fixed onto the same attachment, attachment information including usage history data such as hour meter, which has been stored in the vehicle storage, may be useful, since the new tag fixed on the attachment has no usage history data. As described in the above embodiment, the mobile terminal can obtain the plurality of pieces of attachment information including usage history data from the server storage or the vehicle storage and store one of attachment information in the tag memory of the new tag.

More specifically, after the operator selects one of the tag IDs through the touch panel, the mobile terminal may obtain one of the plurality of pieces of attachment information, based on the selected one of the tag IDs, from the server storage or the vehicle storage, and display on the touch panel, the plurality of pieces of attachment information including usage history data and log data. For example, only in a case where the operator confirms that log data in attachment information indicates that attachment information was stored within a predetermined time period before the current time, the operator may tap the button of “Obtain Attachment Information” shown in the attachment information input screen, to transmit the beacon signal containing the selected one of attachment information including recent usage history data, from the mobile terminal to the new tag.

Alternatively, the mobile terminal may display the button of “Obtain Attachment Information” on the touch panel, only in a case where log data in attachment information indicates that attachment information was stored within a predetermined time period before the current time, and allow the operator to tap the displayed button of “Obtain Attachment Information” to transmit the beacon signal containing the selected attachment information with recent usage history data. In other words, the terminal controller controls the touch panel not to display the button of “Obtain Attachment Information”, in a case where log data in attachment information indicates that attachment information was old and stored before the predetermined time period from the current time. With this, the terminal controller may prohibit transmitting the beacon signal containing the selected attachment information with old usage history data.

[Variation 3] The server according to Variation 3 stores the plurality of pieces of attachment information each linked with position information indicating position or location of each of the working vehicles. The server stores the plurality of pieces of attachment information of the attachments which can be attached to each of the working vehicles, and position information indicating position or location of each of the working vehicles. As described above, each of the working vehicles includes a positioning device to provide position information indicating its own current position. One of the working vehicles may be away from another, or may be in the same area with another.

Each of the working vehicles includes a vehicle ID unique thereto. The server can store the plurality of pieces of attachment information uploaded from the vehicle storages, which are each linked with respective one of vehicle IDs of the working vehicles. This allows the server to store the vehicle IDs of a plurality of working vehicles, the plurality of pieces of position information, and the plurality of pieces of attachment information with attachment IDs of the attachments which have been attached or are to be attached to the working vehicles, all of which are linked to one another.

It should be noted that the server storage of the server and the vehicle storage of the working vehicles according to Variation 3 may store the plurality of pieces of attachment information including log data indicating the stored and uploaded time as attribute information thereof, similar to ones according to Variation 2.

A list screen displayable on the touch panel of the mobile terminal, indicates a plurality of pieces of attachment information (such as attachment type and model number) with attachment IDs, linked with the vehicle IDs and a plurality of pieces of position information of the working vehicles. The screen may include a map, e.g., of the United States, including multiple marks (star marks) each indicating the positions of the working vehicles based on position information thereof, together with multiple vehicle IDs. The marks may be icons unique to the working vehicle instead of the star marks. Each of the plurality of pieces of position information may be expressed in latitude and longitude, but may be expressed with plus codes of Google Map (registered trademark) or map codes. For convenience, the plus codes of Google Map are used herein for indicating the plurality of pieces of position information of the working vehicles. The plus code includes simple character strings and name of city (and state or prefecture) for indicating exact point of the position on Google Map, such as “RCX7+M3, Salina, KS” and “RW2P+G9, Alexandria, VA”, which are open source to freely be available. App of Google Map is used with the plus code entered, the mark corresponding to the plus code is indicated on the map. The mobile terminal may be configured to indicate on the touch panel, the marks indicating positions of one or more working vehicles on the map based on position information thereof, and allow the operator to set a position area for one or more working vehicles.

When the operator taps a particular position information (or a portion indicating the plus code) on the list screen, the terminal controller may extract some pieces of attachment information (and vehicle IDs) linked with a particular piece of position information, among all pieces of attachment information stored in the server storage, and may control the touch panel to display the position-limited list screen. In addition, the operator may input or set a particular city (and state or prefecture) on another character input screen on the touch panel. With this, terminal controller may set a position area of the working vehicle, and control the touch panel to display the list.

Alternatively, since Google Map on the touch panel can freely zoom in or out the displayed area with two fingers of the operator, the operator can set the position area of the working vehicles on the map in any desired scaling factors. In other words, the mobile terminal is configured to allow the operator to set the position area of one or more working vehicles through the touch panel, and to extract one or more pieces of attachment information based on the set position area and position information of the working vehicles to display them on the position-limited list screen.

When the operator taps a particular attachment type on the position-limited list screen, the terminal controller may extracts (or narrow down) one or more pieces of attachment information listed in the position-limited list screen with a particular attachment type to display on the touch panel, the type-limited list screen. When the operator taps or select “rotary cutter” on the position-limited list screen, the terminal controller may extract one or more pieces of attachment information containing “rotary cutter” as the attachment type and displays the type-limited list screen. Then, the operator further taps the attachment model number (RC5020) of the attachment ID (A #1836), for example, and taps the button of “Obtain attachment information” on the type-limited list screen, the terminal controller can obtain the selected one of pieces of attachment information containing the selected attachment model number from the server storage. Similarly, the terminal controller can obtain the selected one of pieces of attachment information containing the selected attachment model number from the vehicle storage of one or more working vehicles arranged in the set position area.

As described above, in a case where the server stores the plurality of pieces of attachment information of attachments which have been attached to one or more working vehicles linked with position information of one or more working vehicles, upon operator's selection of the tag ID of the tag, the mobile terminal can obtain one of the plurality of pieces of attachment information from the server storage based on position information of the working vehicle selected through the lists or the map and to cause the tag memory of the tag to store the obtained one of attachment information. In this case, it is not essential for the operator to input the attachment ID of attachment information.

[Variation 4] Although the mobile terminal may be positioned away from one or more attachments, it may be close to one or more attachments. That is, the mobile terminal may receive the beacon signals from the tags fixed on one or more attachments around the mobile terminal, simultaneously obtaining the plurality of pieces of attachment information from the server storage which are selected based on position information of one or more working vehicles positioned in the same area. In particular, the mobile terminal may receive from the tags around the mobile terminal, the beacon signals having the RSSIs equal to or greater than the first threshold, to obtain the tag IDs and the plurality of pieces of attachment information (with attachment IDs) contained in the beacon signals. In addition, the mobile terminal may obtain the tag IDs and the plurality of pieces of attachment information (with attachment IDs) from the vehicle storages of one or more working vehicles positioned around the mobile terminal. The plurality of pieces of attachment information may be displayed on the touch panel in a form of a list. A hybrid tag detection screen on the touch panel may show a listing the tag IDs and the plurality of pieces of attachment information which are stored the vehicle storages of one or more working vehicles, and the tag IDs and the plurality of pieces of attachment information which are contained in the beacon signals from the tags.

Furthermore, the mobile terminal may obtain the plurality of pieces of attachment information (with attachment IDs) stored in the vehicle storages of one or more working vehicles positioned in different positions away from the mobile terminal, via the sever,

Listed on the hybrid tag detection screen are seven tag IDs and seven pieces of attachment information stored in the vehicle storages of the particular working vehicles (vehicle ID: V #3135) around the mobile terminal, and six tag IDs and six pieces of attachment information in the beacon signals received from the tags around the mobile terminal (vehicle ID: N/A). Two or more working vehicles may be positioned around the mobile terminal.

For example, the mobile terminal does not receive the beacon signals containing two pieces of attachment information with attachment IDs of A #5097 and A #4783, among seven pieces of attachment information stored in the vehicle storages of the working vehicles (vehicle ID: V #3135). With this, the operator recognizes that two of the attachments corresponding to attachment information having the attachment IDs of A #5097 and A #4783 have been moved to another place or area. The terminal controller may be configured to control the touch panel to display two of the attachment information having the attachment IDs of A #5097 and A #4783 with different color or with blinking, to clearly indicate the operator that two of the attachments have been moved to another place or area.

As another example, the mobile terminal receives around the mobile terminal, the tag (vehicle ID: N/A) containing the attachment ID (A #2678) of the attachment (flail mower), which is not listed in pieces of attachment information stored in the vehicle storages of the working vehicles (vehicle ID: V #3135). With this, the operator recognizes that the attachment (flail mower) has newly been brought to the same area. The terminal controller may be configured to control the touch panel to display the attachment information having the attachment ID of A #2678 of the attachment (flail mower) with different color or with blinking, to clearly indicate the operator that the attachment (flail mower) has newly been brought to the same area.

As further another example, the mobile terminal receives the beacon signals from the tag around the mobile terminal, which contains the tag ID (T #8636) and attachment information including the attachment ID (A #3864), of which tag ID only is inconsistent with corresponding one (T #2035) in attachment information (attachment ID: A #3864) for the same attachment (hole digger) stored in the vehicle storage of the working vehicle. With this, the operator recognizes that the tag fixed on the attachment (attachment ID: A #3864) has been replaced with another or new one. The terminal controller may be configured to control the touch panel to display the tag IDs of T #8636 and T #2035 for the same attachment ID (A #3864) of the attachment (hole digger) with different color or with blinking, to clearly indicate the operator that the tag has been replaced with another or new one.

Preferably, the vehicle storage and the server storage according to Variation 4 store the plurality of pieces of attachment information each containing log data indicating the stored and uploaded time as attribute information thereof, similar to ones according to Variation 2. When the tag has been replaced with new one and fixed to the same attachment, the mobile terminal may obtain old attachment information including the usage history data such as the hour meter, from the vehicle storage via the server, and may store it in the tag memory of the new tag. In particular, the operator switches the mobile terminal to the tag setting mode, and selects a particular one of position information in the list screen through the touch panel. The operator selects a particular one of attachment types listed in the position-limited list screen, and taps or selects a particular one of pieces of attachment information and taps the button of “Obtain attachment information” on the type-limited list screen, to obtain a particular piece of attachment information from the server storage.

The terminal controller of the mobile terminal is configured to control the terminal transceiver to transmit the beacon signal containing the particular or selected tag ID and the obtained or updated one of pieces of attachment information. The microcomputer of the tag is configured to control the tag memory to store the obtained or updated one of pieces of attachment information in the beacon signal from the terminal transceiver, when recognizing that the beacon signal contains its own tag ID. With this, the mobile terminal can overwrite the tag memory with the updated one of pieces of attachment information (with usage history data) obtained from the vehicle storage.

It should be noted that as the working vehicle is capable of moving, each of pieces of attachment information stored in the vehicle storage of the working vehicle may be linked with real-time position information of the working vehicle (vehicle ID).

The manufacturer and/or the dealers of the working vehicles may store in advance a plurality of pieces of default attachment information for each of the attachments that can be attached to genuine or default working vehicles in the server storage of the server in a form of a list, which are linked with position information indicating the position of the geographic address of the manufacturer and/or the dealers who manufactures and/or deals the working vehicles. With this, the operator can select one of position information indicating, i.e., the geographic address of the manufacturer and/or the dealers in the list, to obtain each one of pieces of the plurality of attachment information which are linked with position information of the working vehicles for each of the attachments that can be attached to default working vehicles.

The manufacturer and/or the dealers of the working vehicles may provide an accessible URL (Uniform Resource Locator) on its own website so that the operator may refer to the website to obtain the desired piece of attachment information.

Similarly as described above for the embodiment, the mobile terminal transmits the beacon signal containing the tag ID of the tag and attachment information, when the mobile terminal receives the beacon signal from the tag, which has no attachment information or has attachment information to be updated. The microcomputer of the tag controls the tag memory to store attachment information in the beacon signal, when the tag transceiver of the tag receives the beacon signal containing its own tag ID.

The example embodiment of the present invention provides an attachment management system, as described in the following items.

(Item 1) An attachment management system comprising at least one working vehicle, a plurality of attachments (1, 2, . . . , N), each of the plurality of attachments being detachably coupled to the at least one working vehicle, a mobile terminal having a touch panel, and a plurality of tags, each of which is fixed to one of the plurality of attachments, and communicates with the mobile terminal through a beacon signal that is compliant with a near field communication standard, each of the plurality of tags including a tag memory to store a tag ID unique to each of the plurality of tags, and a tag transceiver capable of transmitting the beacon signal containing the tag ID to the mobile terminal, and receiving from the mobile terminal, attachment information unique to one of the plurality of attachments, on which each of the plurality of tags is fixed, wherein the mobile terminal is switchable between a tag detection mode where the mobile terminal receives the beacon signals from the plurality of tags and does not transmitting attachment information to the plurality of tags, and a tag setting mode where the mobile terminal receives the beacon signals from the plurality of tags and is capable of transmitting attachment information to at least one of the plurality of tags, the mobile terminal is configured or programmed to display on the touch panel, in the tag detection mode, the tag IDs and a plurality of pieces of attachment information stored in the tag memories of the plurality of tags which transmit the beacon signals, and in the tag setting mode, the tag IDs and the plurality of pieces of attachment information stored in the tag memories of the plurality of tags which transmit the beacon signals each having a RSSI (Received Signal Strength Indicator) equal to or greater than a predetermined threshold.

According to the attachment management system recited in Item 1, when a plurality of attachments are positioned around the mobile terminal, the mobile terminal displays on the touch panel, in the tag detection mode, the plurality of pieces of attachment information in the beacon signals transmitted from the plurality of the tags, so that the operator easily recognize location of the plurality of attachments around the mobile terminal. Also, the mobile terminal displays on the touch panel, in the tag setting mode, the plurality of pieces of attachment information in the beacon signals having the RSSIs equal to or greater than a predetermined threshold so that the operator easily recognize location of the plurality of attachments closer to the mobile terminal and surely store or overwrite attachment information of the attachment in the tag memory of tag fixed to the attachment.

(Item 2) The attachment management system according to Item 1, wherein the mobile terminal is configured or programmed to, in the first and tag setting modes, sort and display on the touch panel, the tag IDs and the plurality of pieces of attachment information stored in the tag memories of the plurality of tags, based on the RSSIs of the beacon signals from the plurality of tags. According to the attachment management system recited in Item 2, the mobile terminal sorts and displays the plurality of pieces of attachment information in a descending or ascending order so that the operator easily recognize location of the plurality of attachments closer to the mobile terminal.

(Item 3) The attachment management system according to Item 1 or Item 2, wherein the mobile terminal is configured or programmed to, in the tag setting mode, allow an operator to select one of the tag IDs displayed on the touch panel, and obtain one of the plurality of pieces of attachment information corresponding to one of the tag IDs selected by the operator through the touch panel, and transmit the beacon signal containing the obtained one of the plurality of pieces of attachment information, from the terminal transceiver to the tag transceiver of one of the plurality of tags, to cause the tag memory thereof to store the obtained one of the plurality of pieces of attachment information. According to the attachment management system recited in Item 3, the operator can select one of the plurality of tag IDs displayed on the touch panel, and the mobile terminal can obtain, in the setting mode, attachment information corresponding to the selected one of the tag IDs to cause the tag memory to store obtained attachment information.

(Item 4) The attachment management system according to any one of Items 1 to 3, wherein the mobile terminal is configured or programmed to, in the tag setting mode, obtain one of the plurality of pieces of attachment information corresponding to the selected one of the tag IDs through input operation of the operator on the touch panel. According to the attachment management system recited in Item 4, the mobile terminal can obtain attachment information through input operation of the operator on the touch panel.

(Item 5) The attachment management system according to any one of Items 1 to 4, wherein the mobile terminal includes a camera, at least one of the plurality of attachments includes an image code recording one of the plurality of pieces of attachment information, and the mobile terminal is configured or programmed to, in the tag setting mode, obtain the one of the plurality of pieces of attachment information corresponding to the selected one of the tag IDs by scanning the image code with the camera. According to the attachment management system recited in Item 5, the mobile terminal can readily obtain attachment information by scanning the image code with the camera.

(Item 6) The attachment management system according to Item 3, further comprising a server configured or programmed to store the plurality of pieces of attachment information containing attachment IDs unique to each one of the plurality of attachments, and to communicate with a terminal communicator of the mobile terminal, wherein the mobile terminal is configured or programmed to, in the tag setting mode, obtain one of the attachment IDs corresponding to the selected one of the tag IDs, obtain one of the plurality of pieces of attachment information containing the selected one of the tag IDs by communicating with the server through the terminal communicator based on the obtained one of the attachment IDs, and transmit the beacon signal containing the selected one of the tag IDs and the obtained one of the plurality of pieces of attachment information, from the terminal transceiver to the tag transceiver of one of the plurality of tags, to cause the tag memory thereof to store the obtained one of the plurality of pieces of attachment information. According to the attachment management system recited in Item 6, the mobile terminal can readily obtain attachment information based on the obtained attachment ID from the server.

(Item 7) The attachment management system according to Item 6, wherein the mobile terminal is configured or programmed to, in the tag setting mode, obtain one of the plurality of pieces of attachment information corresponding to the selected one of the tag IDs through input operation of the operator on the touch panel. According to the attachment management system recited in Item 7, the mobile terminal can readily obtain attachment corresponding to the tag ID selected through input operation of the operator.

(Item 8) The attachment management system according to Item 6, wherein the mobile terminal includes a camera, at least one of the plurality of attachments includes an image code recording one of the plurality of pieces of attachment information, and the mobile terminal is configured or programmed to, in the tag setting mode, obtain one of the plurality of pieces of attachment information corresponding to the selected one of the tag IDs by scanning the image code with the camera. According to the attachment management system recited in Item 8, the mobile terminal can readily obtain attachment ID by scanning the image code with the camera.

(Item 9) The attachment management system according to any one of Items 1 to 3, further comprising a server including a sever storage to store the plurality of pieces of attachment information containing a plurality of attachment IDs unique to each one of the plurality of attachments, the server communicating with a terminal communicator of the mobile terminal, wherein the mobile terminal includes a terminal communicator and a terminal transceiver, and is configured or programmed to obtain the plurality of pieces of attachment information stored in the sever storage by communicating with the server through the terminal communicator, and the mobile terminal is configured or programmed to, in the tag setting mode, allow an operator to select one of the tag IDs displayed on the touch panel, obtain one of the plurality of pieces of attachment information from the sever storage, corresponding to one of the tag IDs selected by the operator through the touch panel, and transmit the beacon signal containing obtained one of the plurality of pieces of attachment information, from the terminal transceiver to the tag transceiver of one of the plurality of tags, to cause the tag memory thereof to store the obtained one of the plurality of pieces of attachment information.

According to the attachment management system recited in Item 9, the mobile terminal can readily obtain attachment information from the server storage, to cause the tag memory to store obtained attachment information.

(Item 10) The attachment management system according to any one of Items 1 to 9, further comprising a server to communicate with a terminal communicator of the mobile terminal, wherein the at least one working vehicle includes a vehicle communicator to communicate with the server, and a vehicle storage to store a plurality of pieces of attachment information containing a plurality of attachment IDs unique to each one of the plurality of attachments, the mobile terminal includes a terminal transceiver, and is configured or programmed to obtain the plurality of pieces of attachment information stored in the vehicle storage by communicating with the vehicle storage via the terminal communicator, the server, and the vehicle communicator, and the mobile terminal is configured or programmed to, in the tag setting mode, allow an operator to select one of the tag IDs displayed on the touch panel, obtain one of the plurality of pieces of attachment information from the vehicle storage corresponding to one of the tag IDs selected by the operator through the touch panel, and transmit the beacon signal containing obtained attachment information, from the terminal transceiver to the tag transceiver of one of the plurality of tags, to cause the tag memory thereof to store the obtained one of the plurality of pieces of attachment information. According to the attachment management system recited in Item 10, the mobile terminal can obtain attachment information linked to position information of the working vehicle, to cause the tag memory to store obtained attachment information.

(Item 11) The attachment management system according to any one of Items 1 to 10, further comprising a server to communicate with a terminal communicator of the mobile terminal, wherein the mobile terminal includes a terminal transceiver, the at least one working vehicle includes a positioning device providing a position information indicating a vehicle position thereof, a vehicle storage to store a plurality of pieces of attachment information of the plurality of attachments, and a vehicle communicator to communicate with the server, and transmits to the server, the plurality of pieces of attachment information linked with position information of the at least one working vehicle, the server stores the plurality of pieces of attachment information linked with position information of the at least one working vehicle, which are received from the vehicle communicator of the at least one working vehicle, and the mobile terminal is configured or programmed to, in the tag setting mode, allow an operator to select one of the plurality of pieces of attachment information displayed on the touch panel, and transmit the selected one of the plurality of pieces of attachment information, from the terminal transceiver to the tag transceiver of one of the plurality of tags, to cause the tag memory thereof to store the selected one of the plurality of pieces of attachment information. According to the attachment management system recited in Item 11, the mobile terminal can obtain attachment information linked to position information of the working vehicle from the vehicle storage via the server, to cause the tag memory to store obtained attachment information.

(Item 12) The attachment management system according to any one of Items 1 to 11, further comprising a server to communicate with a terminal communicator of the mobile terminal, wherein the mobile terminal includes a terminal transceiver, the at least one working vehicle includes a positioning device providing a position information indicating a vehicle position thereof, a vehicle storage to store a plurality of pieces of attachment information of the plurality of attachments, and a vehicle communicator to communicate with the server, and transmits to the server, the plurality of pieces of attachment information linked with position information of the at least one working vehicle, the server stores the plurality of pieces of attachment information linked with position information of the at least one working vehicle, which are received from the vehicle communicator of the at least one working vehicle, and the mobile terminal is configured or programmed, in the tag detection mode, to obtain from the server, and display on the touch panel, the plurality of pieces of attachment information and position information linked with each one of the plurality of pieces of attachment information, which are stored in the vehicle storage of the at least one working vehicle. According to the attachment management system recited in Item 12, the mobile terminal can display on the touch panel, in the tag detection mode, the plurality of pieces of attachment information linked to position information of the plurality of working vehicles from the vehicle storage via the server, to cause the tag memory to store obtained attachment information.

(Item 13) The attachment management system according to Item 12, wherein the mobile terminal is configured or programmed, in the tag detection mode, to display on the touch panel, the plurality of pieces of attachment information and position information linked with each one of the plurality of pieces of attachment information, which are stored in the vehicle storage of the at least one working vehicle, and the plurality of pieces of attachment information, which are stored in the tag memories of the plurality of tags which transmit the beacon signals. According to the attachment management system recited in Item 13, the mobile terminal can display on the touch panel, in the tag detection mode, the plurality of pieces of attachment information linked to position information of the plurality of working vehicles stored in the vehicle storage, and the plurality of pieces of attachment information in the beacon signals received from the tags.

(Item 14) The attachment management system according to any one of Items 11 to 13, wherein the mobile terminal is configured or programmed to allow an operator to set a position area of the at least one working vehicle, extract at least one of the plurality of pieces of attachment information from the server, based on the set position area and position information of the at least one working vehicle, and display at least one of the plurality of pieces of attachment information on the touch panel. According to the attachment management system recited in Item 14, the mobile terminal can extract and display on the touch panel, at least one attachment information based on the position area set by the operator and position information of the working vehicle.

(Item 15) The attachment management system according to Item 14, wherein the mobile terminal is configured or programmed to display a map and at least one mark indicating the vehicle position of the at least one working vehicle on the map based on position information thereof, and allow the operator to set the position area of the at least one working vehicle on the map. According to the attachment management system recited in Item 15, the mobile terminal can allow the operator to set the position area of the at least one working vehicle on the map.

(Item 16) The attachment management system according to any one of Items 1 to 15, further comprising a server to communicate with a terminal communicator of the mobile terminal, the server including a server storage to store a plurality of pieces of attachment information of the plurality of attachments, wherein the at least one working vehicle includes a plurality of working vehicles, the mobile terminal includes a terminal transceiver, each of the plurality of working vehicles includes a positioning device providing a position information indicating a vehicle position thereof, a vehicle storage to store the plurality of pieces of attachment information of the plurality of attachments, and a vehicle communicator to communicate with the server, and transmits to the server, the plurality of pieces of attachment information linked with position information of each of the plurality of working vehicles, the server storage stores the plurality of pieces of attachment information linked with position information of each of the plurality of working vehicles, which are received from each of the vehicle communicators of the plurality of working vehicles, the mobile terminal displays the plurality of pieces of attachment information linked with position information of each of the plurality of working vehicles, which are stored in the server storage, the mobile terminal is configured or programmed to, in the tag setting mode, allow an operator to select one of the plurality of pieces of attachment information displayed on the touch panel, and transmit one of the plurality of pieces of attachment information selected by the operator, from the terminal transceiver to the tag transceiver of one of the plurality of tags, to cause the tag memory thereof to store the selected one of the plurality of pieces of attachment information. According to the attachment management system recited in Item 16, the mobile terminal can obtain attachment information linked to position information of the working vehicle from the server.

(Item 17) The attachment management system according to Item 16, wherein the mobile terminal is configured or programmed to allow an operator to set a position area of the plurality of working vehicles, extract at least one of the plurality of pieces of attachment information from the server storage, based on the set position area and position information of the plurality of working vehicles, and display the plurality of pieces of attachment information on the touch panel. According to the attachment management system recited in Item 17, the mobile terminal can extract at least one attachment information based on the position area set by the operator and position information of the plurality of working vehicles from the server storage.

(Item 18) The attachment management system according to Item 17, wherein the mobile terminal is configured or programmed to display a map and marks indicating the vehicle positions of the plurality of working vehicles on the map based on position information thereof, and allow the operator to set the position area of the plurality of working vehicles on the map. According to the attachment management system recited in Item 18, the operator can set the position area of the working vehicles on the map.

(Item 19) The attachment management system according to any one of Items 1 to 18, wherein the mobile terminal has a switch to allow the operator to select either one of the tag detection mode and the tag setting mode. According to the attachment management system recited in Item 19, the operator can select the tag detection mode or the tag setting mode.

(Item 20) The attachment management system according to any one of Items 1 to 18, wherein the mobile terminal is configured or programmed to, in the tag detection mode, display on the touch panel, the tag IDs and attachment information stored in each of the tag memories of the plurality of tags which transmit the beacon signals, and in the tag setting mode, display on the touch panel, the tag IDs stored in each of the tag memories of the plurality of tags which transmit the beacon signals having the RSSIs equal to or greater than a predetermined threshold. According to the attachment management system recited in Item 20, the mobile terminal can change the RSSIs of the beacon signals displayed on the touch panel depending on the tag detection mode or tag setting mode.

(Item 21) An attachment management system comprising a server including a server storage, at least one working vehicle including a vehicle communicator to communicate with the server, a plurality of attachments detachably coupled to the at least one working vehicle, a mobile terminal including a terminal communicator to communicate with the server, a terminal transceiver, and a touch panel, and a plurality of tags, each of which is fixed to one of the plurality of attachments, and communicates with the mobile terminal through a beacon signal that is compliant with a near field communication standard, the server storage storing a plurality of pieces of attachment information of the plurality of attachments, each of the plurality of tags including a tag memory to store a tag ID unique to each of the plurality of tags, and a tag transceiver capable of transmitting the beacon signal containing the tag ID to the mobile terminal, and receiving from the mobile terminal, attachment information unique to one of the plurality of attachments, on which each of the plurality of tags is fixed, wherein the mobile terminal is configured or programmed to, obtain and display on the touch panel, the plurality of pieces of attachment information of the plurality of attachments, by communicating with the server through the terminal communicator, allow an operator to select one of the plurality of pieces of attachment information displayed on the touch panel, and transmit one of the plurality of pieces of attachment information displayed on the touch panel and selected by the operator, from the terminal transceiver to the tag transceiver of one of the plurality of tags, to cause the tag memory thereof to store the selected one of the plurality of pieces of attachment information. According to the attachment management system recited in Item 21, the mobile terminal can obtain attachments, to cause the tag memory to store attachment information.

(Item 22) The attachment management system according to Item 21, wherein the at least one working vehicle includes a positioning device providing position information indicating a vehicle position thereof, and a vehicle storage to store the plurality of pieces of attachment information of the plurality of attachments, the vehicle communicator transmits to the server, the plurality of pieces of attachment information of the plurality of attachments, which are linked with position information of the at least one working vehicle, the vehicle communicator transmits to the server, the plurality of pieces of attachment information of the plurality of attachments, which are linked with position information of the at least one working vehicle, the sever storage stores the plurality of pieces of attachment information of the plurality of attachments, which are linked with position information of the at least one working vehicle, and the mobile terminal is configured or programmed to, obtain and display on the touch panel, the plurality of pieces of attachment information of the plurality of attachments stored in the sever storage, which are linked with position information of the at least one working vehicle, by communicating with the server through the terminal communicator, allow an operator to select one of the plurality of pieces of attachment information displayed on the touch panel, based on position information of the at least one working vehicle, and transmit the selected one of the plurality of pieces of attachment information, from the terminal transceiver to one of the plurality of tags, to cause the tag memory thereof to store the selected one of the plurality of pieces of attachment information. According to the attachment management system recited in Item 22, the mobile terminal can obtain attachment information linked with position information of the working vehicle from the vehicle storage, to cause the tag memory to store attachment information.

(Item 23) The attachment management system according to Item 21 or 23, wherein the at least one working vehicle includes a plurality of working vehicles, and one of the plurality of working vehicles is located away from another of the plurality of working vehicles. According to the attachment management system recited in Item 23, the mobile terminal can obtain attachment information from the vehicle storages of the working vehicles located away from each other.

(Item 24) The attachment management system according to any one of Items 21 to 23, wherein the mobile terminal is configured or programmed to, allow the operator to set a position area of the at least one working vehicle, extract at least one of the plurality of pieces of attachment information from the server storage, based on the set position area and position information of the at least one working vehicle, and display the at least one of the plurality of pieces of attachment information on the touch panel. According to the attachment management system recited in Item 24, the mobile terminal can extract at least one attachment information from the server storage, based on the position area set by the operator and position information of the at least one working vehicle.

(Item 25) An attachment management system comprising a server including a server storage, at least one working vehicle including a vehicle communicator to communicate with the server, a plurality of attachments each detachably coupled to the at least one working vehicle, a mobile terminal including a terminal communicator to communicate with the server, a terminal transceiver, and a touch panel, and a plurality of tags, each of which is fixed to one of the plurality of attachments, and communicates with the mobile terminal through a beacon signal that is compliant with a near field communication standard, wherein the server storage stores a plurality of pieces of attachment information containing a plurality of attachment IDs unique to each one of the plurality of attachments, each of the plurality of tags includes a tag memory to store a tag ID unique to each of the plurality of tags, and a tag transceiver capable of transmitting the beacon signal containing the tag ID to the mobile terminal, and receiving from the mobile terminal, attachment information unique to one of the plurality of attachments, on which each of the plurality of tags is fixed, wherein the mobile terminal is configured or programmed to, obtain one of the plurality of attachment IDs of the plurality of pieces of attachment information through operation of an operator, obtain one of the plurality of pieces of attachment information linked with the obtained one of the plurality of attachment IDs, based on the obtained one of the plurality of attachment IDs, from the server storage by communicating with the server through the terminal communicator, and transmit the beacon signal containing the obtained one of the plurality of pieces of attachment information, from the terminal transceiver to the tag transceiver of one of the plurality of tags, to cause the tag memory thereof to store the obtained one of the plurality of pieces of attachment information. According to the attachment management system recited in Item 25, the mobile terminal can obtain attachment information from the server storage, to cause the tag memory to store obtained attachment information.

(Item 26) The attachment management system according to Item 25, wherein the mobile terminal is configured or programmed to, display on the touch panel, at least one of the plurality of pieces of attachment information stored in the tag memory of at least one of the plurality of tags from which the mobile terminal receives the beacon signals having the RSSIs (Received Signal Strength Indicator) equal to or greater than a predetermined threshold, allow the operator to select one of the plurality of attachment IDs displayed on the touch panel, and obtain one of the plurality of pieces of attachment information linked with the selected one of the plurality of attachment IDs, based on the selected one of the plurality of attachment IDs, from the server storage, by communicating with the server through the terminal communicator. According to the attachment management system recited in Item 26, the operator can select one of the tag IDs displayed on the touch panel, and the mobile terminal can obtain the attachment ID of attachment information.

(Item 27) The attachment management system according to Item 25, wherein the mobile terminal is configured or programmed to obtain one of the plurality of attachment IDs through input operation of the operator. According to the attachment management system recited in Item 27, the mobile terminal can obtain one attachment ID through input operation of the operator.

(Item 28) The attachment management system according to Item 25 or 26, wherein the mobile terminal includes a camera, at least one of the plurality of attachments includes an image code recording attachment information, and the mobile terminal is configured or programmed to obtain one of the plurality of attachment IDs by scanning the image code with the camera. According to the attachment management system recited in Item 28, the mobile terminal can readily obtain attachment information by scanning the image code with the camera.

(Item 29) The attachment management system according to any one of Items 25 to 28, wherein the at least one working vehicle includes a positioning device providing position information indicating a vehicle position thereof, and a vehicle storage to store the plurality of pieces of attachment information of the plurality of attachments, the vehicle communicator transmits to the server, the plurality of pieces of attachment information of the plurality of attachments, which are linked with position information of the at least one working vehicle, the sever storage stores the plurality of pieces of attachment information of the plurality of attachments, which are linked with position information of the at least one working vehicle, and the mobile terminal is configured or programmed to, obtain and display on the touch panel, the plurality of pieces of attachment information of the plurality of attachments, which are linked with position information of the at least one working vehicle, by communicating with the server through the terminal communicator, allow an operator to select one of the plurality of pieces of attachment information displayed on the touch panel, based on position information of the at least one working vehicle, and transmit the selected one of the plurality of pieces of attachment information, from the terminal transceiver to the tag transceiver of one of the plurality of tags, to cause the tag memory thereof to store the selected one of the plurality of pieces of attachment information. According to the attachment management system recited in Item 29, the mobile terminal can obtain attachment information linked with position information of the working vehicle, from the server storage, to cause the tag memory to store obtained attachment information.

(Item 30) The attachment management system according to any one of Items 25 to 29, wherein the at least one working vehicle includes a plurality of working vehicles, and one of the plurality of working vehicles is located away from another of the plurality of working vehicles. According to the attachment management system recited in Item 30, the mobile terminal can obtain attachment information from the vehicle storages of the working vehicles located away from each other, to cause the tag memory to store obtained attachment information.

(Item 31) The attachment management system according to any one of Items 25 to 30, wherein the mobile terminal is configured or programmed to, allow the operator to set a position area of the at least one working vehicle, extract at least one of the plurality of pieces of attachment information from the server storage, based on the position area and position information of the at least one working vehicle, and display the at least one of the plurality of pieces of attachment information on the touch panel. According to the attachment management system recited in Item 31, the mobile terminal can extract at least one attachment information from the server storage, based on the position area set by the operator and position information of the at least one working vehicle.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A communication system to facilitate communication between a work machine and an attachment, the communication system comprising:
an identification module,
wherein the identification module comprises a housing, and further comprises a processor, a memory, and a wireless transceiver housed with the housing,
a bracket configured to couple the identification module to the attachment such that the transceiver of the identification module is aimed within 30° of a line of sight between the identification module and a wireless transceiver associated with the work machine.

2. The communication system of claim 1, wherein the wireless transceiver of the identification module is aimed within 15° of the line of sight between the identification module and the wireless transceiver associated with the work machine.

3. The communication system of claim 1, wherein the work machine comprises a cab with a roof, and wherein the wireless transceiver of the work machine is positioned on a front side of the cab, adjacent to the roof.

4. The communication system of claim 3, wherein the wireless transceiver of the identification module is aimed within 30° of the line of sight between the identification module and the wireless transceiver associated with the work machine when the attachment is in a lowered position.

5. The communication system of claim 4, wherein the line of line of sight extends rearward and upward from the identification module to the wireless transceiver of the work machine.

6. The communication system of claim 1, wherein the communication system includes the wireless transceiver of the work machine.

7. The communication system of claim 1, wherein the bracket comprises a support arm and a mounting platform, wherein the mounting platform is configured to support the housing of the identification module.

8. The communication system of claim 7, wherein a first end of the support arm is configured to be secured to the attachment, and wherein a second end of the support arm is connected to the mounting platform.

9. The communication system of claim 7, wherein the mounting platform is oriented at an angle with respect to the support arm, wherein the angle is from 15 to 60°.

10. The communication system of claim 1, wherein the identification module is configured to transmit to the wireless transceiver of the work machine, identification information related to the attachment to which the identification module is configured to be coupled via the bracket.

11. The communication system of claim 10, wherein the identification module comprises one or more sensors, and wherein the identification module is configured to transmit to the wireless transceiver of the work machine, data obtained from the one or more sensors.

12. A method of modifying a work machine and attachment to include a communication system, the method comprising the steps of:
(a) providing the communication system comprising an identification module and a bracket,
wherein the identification module comprises a housing, and further comprises a processor, a memory, and a transceiver housed with the housing;
(b) securing the bracket to the attachment; and
(c) securing the identification module to the bracket,
wherein upon the securing of step (c), the transceiver of the identification module is aimed within 30° of a line of sight between the identification module and a wireless transceiver associated with the work machine.

13. The method of claim 12, wherein the wireless transceiver of the identification module is aimed within 15° of the line of sight between the identification module and the wireless transceiver associated with the work machine.

14. The method of claim 12, wherein the work machine comprises a cab with a roof, and wherein the wireless transceiver of the work machine is positioned on a front side of the cab, adjacent to the roof.

15. The method of claim 12, wherein the wireless transceiver of the identification module is aimed within 30° of the line of sight between the identification module and the wireless transceiver associated with the work machine when the attachment is in a lowered position, and wherein the line of line of sight extends rearward and upward from the identification module to the wireless transceiver of the work machine.

16. The method of claim 12, wherein the bracket comprises a support arm and a mounting platform, wherein the mounting platform is configured to support the housing of the identification module.

17. The method of claim 16, wherein a first end of the support arm is secured to the attachment, and wherein a second end of the support arm is connected to the mounting platform.

18. The method of claim 12, wherein the mounting platform is oriented at an angle with respect to the support arm, wherein the angle is from 15 to 60°.

19. The method of claim 12, wherein the identification module is configured to transmit to the wireless transceiver of the work machine, identification information related to the attachment to which the identification module is configured to be coupled via the bracket.

20. The method of claim 19, wherein the identification module comprises one or more sensors, and wherein the identification module is configured to transmit to the wireless transceiver of the work machine, data obtained from the one or more sensors.
